(19) United States
(12) Patent Application Publication
(10) Pub. No.: US 2008/0062841 A1
(43) Pub. Date: Mar. 13, 2008

(54) Recording/Reproduction Method for Optical Recording Medium, Recording Condition Determining Method, Recording Method Optical Disk Apparatus, Program, and Recording Medium Thereof

(76) Inventors: Noboru Sasa, Kanagawa (JP); Yoshitaka Hayashi, Kanagawa (JP); Toshishige Fujii, Kanagawa (JP)

Correspondence Address: DICKSTEIN SHAPIRO LLP, 1825 EYE STREET NW, Washington, DC, 20006-5403, US

(21) Appl. No.: 10/591,078

(22) PCT Filed: Apr. 18, 2005
(86) PCT No.: PCT/JP05/07741

§ 371 Date: Aug. 30, 2006

(30) Foreign Application Priority Data
Apr. 19, 2004 (JP) 2004-123492
May 27, 2004 (JP) 2004-157066
May 27, 2004 (JP) 2004-157068

(51) Int. Cl. G11B 7/0045; G11B 7/125

(52) U.S. Cl. 369/59.11

(57) ABSTRACT

A recording/reproduction method for recording/reproducing data to/from an optical recording medium including a guiding groove and a recording layer is disclosed. The recording/reproduction method includes a step of irradiating a laser beam onto the optical recording medium by modulating at least one of a laser irradiation time and a laser irradiation intensity to two or more values, wherein a Pbi/Pr ratio of a reproduction power (Pr) and a bias power (Pbi) is set to a value that is no less than 0.5, wherein the data are recorded by constantly providing the laser beam with a power level including the reproduction power (Pr) added to the bias power (Pbi).

### TECHNICAL FIELD

The present invention relates to a recording/reproduction method for an optical recording medium for recording binary data of two levels or multilevel data of three or more levels by irradiating a laser light onto the optical recording medium such as optical discs. The present invention also relates to a recording condition determining method for determining recording conditions for recording multilevel data of three or more levels in an optical disk, a recording method, an optical disk apparatus, a program, and a recording medium for recording the multilevel data, respectively. The present invention also relates to a recording method and an optical disk apparatus for recording data in a recording layer of an optical disk by irradiating a laser light by using pulse light emission.

### BACKGROUND ART

Conventionally, desired data are recorded in an optical recording medium by sequentially forming a mark(s) and a pit(s) thereto on the basis of a predetermined standard cycle (reference cycle) T. The method of recording data in the optical recording medium, typically, employs binarized data (binary data) that depend on whether record marks exist (written) on a predetermined area(s) of the optical recording medium. However, in order to achieve the recording of information with greater transfer speed and in higher density, multilevel data (multileveled data), which records a plurality of pieces of information in a single recording unit, employed.

For example, Japanese Laid-Open Patent Application No. 61-94244 discloses a method of switching the quantity of light (light volume) of the laser beam irradiated onto the optical disc in accordance with a data value (data level) by changing the number of beams. With this method, the depth of the pit(s) formed in the optical disc can be changed in multiple levels in accordance with the data value. Furthermore, Japanese Laid-Open Patent Application No. 2-31329 discloses a method of irradiating a laser beam, which has its quantity of light switched in accordance with a data value, onto a phase change recording medium. With this method, the phase change recording medium can be phase changed in multiple levels in accordance with the data value. Furthermore, Japanese Laid-Open Patent Application No. 4-238088 discloses a method of recording multilevel information in correspondence with the variation of orientation of a metal complex. For example, in a case where 8 face orientation is used, multilevel data of a maximum of 6 levels (values) can be recorded by using a maximum variation of 6 variations.

However, the above mentioned multilevel recording methods commonly have a problem in which change of the direct current level in a reproduction signal and intersymbol interference cause error rate to deteriorate considerably in a case where high-density recording is performed.

Furthermore, Japanese Laid-Open Patent Application Nos. 8-287468 and 11-25456 disclose a method of changing the area and shape/structure of a recording pit or a method of defining various combinations of recording mark position and recording mark arrangements so as to provide multiple levels of average reflectivity (reflectance).

In order to increase the recording density by multilevel recording, it is desired to reduce the size of a unit for recording. Furthermore, with such a sized-reduced unit, it is desired to enlarge the dynamic range of reflectivity change. Furthermore, it is preferable to avoid employing complicated recording pulse strategies from the aspects of recording speed and drive cost.

Considering such points, in the conventional methods of multilevel recording shown in Japanese Laid-Open Patent Application Nos. 8-287468 and 11-25456, there is a problem such that the strategy of the record pulse is complicated. Moreover, these multilevel recording methods are recording methods for a rewritable type optical recording medium having a recording layer including phase change materials, in which no satisfactory multilevel recording method for a recordable type optical recording medium (e.g. write-once-record-many type optical recording medium) has been obtained yet. Especially, in the recordable optical recording medium having the recording layer including an organic coloring material that is recordable with a short wavelength laser, only an organic coloring material which has a large refractive index and a comparatively small absorption coefficient (approximately 0.05-0.07) at 405 nm near the center of the oscillation wavelength of a blue semiconductor laser can be used. Accordingly, the recordable optical recording medium has a problem of unstable action with respect to change of recording/reproduction wavelength. Thus, the recordable type optical recording medium having satisfactory characteristic has not been obtained yet.

Furthermore, in the invention disclosed in Japanese Laid-Open Patent Application No. 60-150240,

a recording pulse is irradiated while irradiating a laser beam (reproduction laser) of low intensity, to thereby stop laser irradiation for a predetermined time immediately after a pit(s) is formed. Although the waveform of Japanese Laid-Open Patent Application No. 60-150240 seems to be similar to the waveform of FIGS. 1-3 (especially, FIG. 2) of the present invention, it is a completely different waveform. That is, if the recording waveform of the invention of Japanese Laid-Open Patent Application No. 60-150240 is rewritten and is expressed in the same manner as the waveforms of the present invention shown in FIGS. 1-3, the difference between the inventions is apparent (see FIG. 36).

Japanese Laid-Open Patent Application No. 63-113938 discloses a method for recording in the recording layer (phase change recording layer) that changes reversibly, and a strategy for rewrite type medium. This method applies a recording power on an elimination power (Pe), and provides a cooling power (Pc) no more than the elimination power immediately after the applying of the recording power. Although this seems to be similar to the recording pulse of the present invention shown in FIG. 2, if the recording pulse is expressed in the same manner as the recording pulse of the present invention shown in FIGS. 1-3, the difference between the inventions is apparent (see FIG. 37). Furthermore, since recording onto the phase change materials is premised basically on rewriting, the elimination power (Pe) is employed for constantly applying a predetermined so as to write-in new recording pits while eliminating already written record pits. Meanwhile, in a case of recording onto the conventional recordable type optical recording medium, focusing and tracking are performed with a laser beam having a power equal to or less than reproduction power, and recording is performed by irradiating a beam having a power higher than the reproduction power.

On the other hand, the present invention includes a new feature of further applying bias power to the reproduction power for enhancing recording characteristics.

Meanwhile, owing to the advances in digital technology and improvements in data compression technology in recent years, optical disks including CDs (Compact Disc) and DVDs (Digital Versatile Disc) having the same diameter but having greater recording capacity (approximately 7 times the data) compared to CDs are gaining attention as media used for recording information such as music, movies, photographs, and computer software (hereinafter also referred to as “contents”). Furthermore, optical disk apparatuses that use the optical disks as information recording media are becoming widely used optical disks are becoming less expensive.

In the optical disk apparatus, recording and erasing of information is executed by forming a fine optical spot on a recording surface of an optical disk having spiral or concentric tracks formed thereto. Furthermore, reproduction, of information, for example, is executed based on the light reflected from the recording surface of the optical disk.

Information is recorded in optical disks by using mark areas and space areas having different reflectivity and lengths, and combinations of the areas. In this case, the information is recorded in the optical disk by converting the information into combinations of 0 and 1 (binarization process). A recording method employing the binarization process is described below.

Prior to recording information in an optical disk, the optical disk apparatus writes (records) data in a test area (referred to as PCA, Power Calibration Area) as a test, and obtains an optimum recording power, so that a mark area(s) and a space area(s) of desired lengths can be formed on a target area(s) of the optical disk. This process is referred to as an OPC (Optimum Power Control) process.

In the process of forming the mark area(s) in recordable type optical disks (for example, write-once-read-many optical disks having a recording layer containing organic dye, such as CD-R (CD-Recordable), DVD-R (DVD-Recordable), and DVD+R (DVD+Recordable)), the dye in the recording layer of the optical disk is heated by increasing the emission power of the laser beam irradiated onto optical disk, to thereby cause deformation and/or decomposition of the dye and thus cause a portion of the disk substrate contacting the heated dye to deform and/or decompose. In the process of forming the space area(s) in the recordable type optical disks, the emission power of the laser beam is controlled to a degree substantially equal to the emission power during reproduction so that no deformation and/or decomposition is caused at the dye and at the disk substrate. Thereby, the mark area is formed with a reflectivity which is lower than that of the space area. It is to be noted that the emission power during the formation of the mark area is referred to as recording power. Furthermore, the emission power during the formation of the space area is referred to as reproduction power.

In such a case of forming the mark area(s), the shape, size, etc., of the pulse of the emission power are set in accordance with a rule(s) (formula) that defines the shape, size, etc., of the pulse of the emission power (referred to as “recording strategy”), in order to reduce the fluctuation of thermal distribution that depends on the type of mark area or space area formed before and/or after the target mark area. Since the recording strategy has a large influence on recording quality, it is desired to optimize the recording strategy.

Meanwhile, as the amount of contents continues to increase, expectations for recording greater amounts of information in a single optical disk are growing. One method for enabling more information to be recorded in the optical disk is a method of writing data in the optical disk by converting information into combinations of multilevel data (data levels of three or more types, or symbols). Accordingly, vigorous research continues to be made for putting this technology into practical use (for example, see Japanese Laid-Open Patent Application Nos. 2001-184647, 2002-25114, 2002-83445, 2002-334438, 2002-352428, 2002-352429, 2002-367182, 2003-151137, and 2003-141725). The process of converting information into combinations of 3 levels or more is hereinafter referred to as a multilevel process, and the data on which the multilevel process are performed are referred to as multilevel data or multileveled data. Furthermore, a recording method employing the multilevel process is referred to as a multilevel type recording method.

The same as the binary type recording method, obtaining a suitable recording power and recording strategy is desired in executing the multilevel type recording method for attaining a satisfactory recording quality (For example, see Japanese Laid-Open Patent Application Nos. 2003-151137, 2003-141725, and 2003-132536). In the multilevel type recording method, the linear recording density is higher compared to that of the binary type recording method, and the size of a recording area (cell) to which a single unit (symbol) of multilevel data is recorded is smaller than the spot diameter of the laser spot. Therefore, the multilevel type recording method is susceptible to intersymbol interference. In the example shown in Japanese Laid-Open Patent Application No. 2003-132536, the problem of intersymbol interference is not taken into consideration. Therefore, the obtained recording power and recording strategy are likely to become unsuitable, as the size of the cell is becoming smaller.

In addition, since it is anticipated that the length of the shortest mark area in a binary type recording method and/or the size of the cell in a multilevel type recording method are to become shorter/smaller, the mark area(s) may not be formed into a desired shape (targeted shape) by employing the previously used recording strategy.

### DISCLOSURE OF INVENTION

The above-mentioned problems can be solved with the following processes according to the present invention.

It is a general object of the present invention to provide a recording/reproduction method for binary recording of two values (levels) or multilevel recording of three or more values (levels) by using a simple recording pulse strategy.

In order to achieve the above-mentioned object, there is provided following 1) through 18) inventions (Hereinafter referred to as invention 1 though 18.).

1). A recording and reproduction method, wherein the recording is performed at a condition that Pbi/Pr ratio of reproduction power (Pr) and bias power (Pbi) is set to 0.5 or more than 0.5, and always introducing a power that added bias power (Pbi) to reproduction power (Pr) at the time of recording on a recordable type optical recording medium having a guiding groove and at least one recording layer which can perform recording and reproduction by modulating laser irradiation time or laser irradiation strength to two or more values.

2). A recording and reproduction method, wherein the recording is performed at a condition that a ratio of diameter of beam which is set to 1/e² of central intensity of laser (the diameter of laser beam) D, and a length L of a recording unit (basic cell) of a recording mark for multilevels is the range of 1<D/L and the Pbi/Pr ratio of reproduction power (Pr) and bias power (Pbi) is set to 0.5 or more than 0.5, and always introducing a power that added bias power (Pbi) to reproduction power (Pr) at the time of recording on a recordable type optical recording medium that the recording unit of the recording mark is regular cycle, a kinds (α≧3) of sizes and/or depth of the recording mark within the recording unit are changed and multilevel data is recorded by irradiation of laser beams, and a kinds (α≧3) of mutually different reflective levels by the difference in the size and/or depth of the recording mark are detected, and can reproduce multilevel data.

3). The recording and reproduction method as mentioned in 2), wherein the recoding is performing using a strategy which at least the ratio Wt/Lt of the entire pulse time width Wt of maximum level mark and the time width Lt of basic cell length is between 0.3 to 0.8.

4). The recording and reproduction method as mentioned in 3), wherein the recoding is performed on the recordable type optical recording medium with conditions at the 0.25-0.5 micro meter of track pitch, 15-150 nm of depth and 0.15-0.35 macro meter of average slot width for the guiding groove, and the reflectance of non-recording in is 2-50% using laser beam within blue wavelength range below than 450 nm.

5). The recording and reproduction method as one or more of 1) through 4), wherein the Wg/L ratio of the average slot width Wg of the guiding groove and the length L of the recording unit (basic cell) of recording mark for multilevels is between 0.7 and 1.5.

6). The recording and reproduction method as one or more 1) through 5), wherein the L/Dp ratio of the length L of the recording unit (basic cell) of recording mark for multilevels and the depth Dp of the guiding groove is between 3 and 8.

7). The recording and reproduction method as one or more 1) though 6), wherein the recording is performed using a strategy consists of two or more than two stages of different recording powers.

8). The recording and reproduction method as mentioned in 7), wherein the recording power is two stages and the recording is performed with the strategy that the Pf/Pb ratio of the recording power of the former half (Pf) and the recording power of the latter half (Pb) is between 0.3 and 1.

9). The recording and reproduction method as mentioned in 7) or 8), wherein the recording power is two stages and the recoding is performing using a strategy which Wb/Wt ratio of the pulse time width Wb and the entire pulse time width Wt of the recording power of the latter half of the maximum level mark is between 0.3 and 0.8.

10). The recording and reproduction method as mentioned in 8) or 9), wherein the recording is performed by which a switching point of the recording power of the former half (Pf) and the recording power of the latter half (Pb) corresponds to center of the basic cell.

11). The recording and reproduction method as one or more of 1) through 10), wherein the recording is performed on the recordable type optical recording medium at least having a thin layer (RO layer) including each element of R and O (R is one or more element selected from group consists of Y, B, I, In, and lantern series element and O expresses oxygen) and a thin layer of organic material above its substrate.

12). The recording and reproduction method as mentioned in 11), wherein the recording is performed on the recordable type optical recording medium which the RO film comprising one or more elements M chosen from the group consisting of Al, Cr, Mn, Sc, In, Ru, Rh, Co, Fe, Cu, Ni, Zn, Li, Si, Ge, Zr, Ti, Hf, Sn, Pb, Mo, V and Nb.

13). The recording and reproduction method as mentioned in 11) or 12), wherein the recording is performed on the recordable type optical recording medium which composition is at least layered of the RO film, the thin film of the organic material and a reflective layer on its substrate in order.

14). The recording and reproduction method as mentioned in 11) or 12), wherein the recording is performed on the recordable type optical recording medium which composition is at least layered of the reflective layer, the thin film of the organic material, the RO layer and a cover layer on its substrate in order.

15). The recording and reproduction method as mentioned in 11) or 12), wherein the recording is performed on the recordable type optical recording medium at least having a thin layer (RO layer) including each element of R and O (R is one or more element selected from group consists of Y, B, I, In, and lantern series element and O expresses oxygen) and a dielectric layer which has ZnS as the main ingredients above its substrate.

16). The recording and reproduction method as mentioned in 15), wherein the recording is performed on the recordable type optical recording medium which the RO film comprising one or more elements M chosen from the group consisting of Al, Cr, Mn, Sc, In, Ru, Rh, Co, Fe, Cu, Ni, Zn, Li, Si, Ge, Zr, Ti, Hf, Sn, Pb, Mo, V and Nb.

17). The recording and reproduction method as mentioned in 15) or 16), wherein the recording is performed on the recordable type optical recording medium which composition is at least layered of the RO film, the dielectric layer which has ZnS as the main ingredients and the reflective layer on its substrate in order.

18). The recording and reproduction method as mentioned in 15) or 16), wherein the recording is performed on the recordable type optical recording medium which composition is at least layered of the reflective layer, the dielectric layer which has ZnS as the main ingredients, the RO layer and the cover layer on its substrate in order.

According to another aspect of the present invention, it is another and more specific object of the present invention to provide a recording condition determining method for determining recording conditions for recording multilevel data on a track of a recording surface of an optical disk, the recording condition determining method including the steps of: a) writing plural of the multilevel data levels having a same value in a plurality of test areas, each of the test areas having a prescribed length in a direction of a line tangent to the track, the prescribed length being greater than a spot diameter of an optical spot formed on the track; and b) obtaining a suitable recording power and recording strategy in accordance with the levels of reproduction signals generated from the test areas.

In the recording condition determining method according to an embodiment of the present invention, the suitable recording power and the recording strategy may be obtained when the difference between a greatest value and a least value of the levels of reproductions signals is no more than a reference value.

In the recording condition determining method according to an embodiment of the present invention, the reference value may be recorded in the optical disk.

In the recording condition determining method according to an embodiment of the present invention, the method may further include a step of: c) determining the type of the optical disk; wherein the reference value is selected from predetermined values in accordance with the type of the optical disk.

In the recording condition determining method according to an embodiment of the present invention, the reference value may include a value obtained by calculating a formula of {|DR|/{γ·(α−1)}},

wherein α is a value of the multilevel data which is no less than 3, DR is the difference between a reproduction signal level of an unrecorded area and a reproduction signal level of an area in which a largest mark is recorded, and γ is a value no less than 1.

In the recording condition determining method according to an embodiment of the present invention, the multilevel data may include multilevel data corresponding to the largest mark, wherein the reference value is obtained by referring to the reproduction signals generated from the test areas.

In the recording condition determining method according to an embodiment of the present invention, the suitable recording power and the recording strategy may be obtained when an average value of the levels of the reproduction signals falls within a predetermined range.

In the recording condition determining method according to an embodiment of the present invention, the suitable recording power and the recording strategy may be obtained when the difference between at least one of the greatest value of the levels of the reproduction signals and the least value of the levels of the reproduction signals, and an average value of the levels of the reproduction signals is no more than a predetermined reference value.

In the recording condition determining method according to an embodiment of the present invention, the number of multilevel data levels may be recorded in the test areas is set to satisfy a formula of

β=A+2,

wherein β represents the number of multilevel data levels recorded in the test area, wherein A represents an integer when a calculation result of 2R÷S is rounded up, wherein 2R represents the spot diameter of the optical spot, wherein S represents the length of the test area.

In the recording condition determining method according to an embodiment of the present invention, the levels of reproduction signals generated from the test areas may be derived by omitting the multilevel values of a foremost test area and a rearmost test area obtained by rounding down a calculation result of R÷S, respectively.

Furthermore, the present invention provides a recording method for recording multileveled data on a track of a recording surface of an optical disk, the recording method including a step of: recording the multilevel data on the track of the recording surface of the optical disk by using the suitable recording power and the recording strategy obtained with the aforementioned method of the present invention.

Furthermore, the present invention provides an optical disk apparatus for recording multilevel data on a track of a recording surface of an optical disk, the optical disk apparatus including: a writing part for writing plural of the multilevel data levels having a same value in a plurality of test areas, each of the test areas having a prescribed length in a direction of a line tangent to the track, the prescribed length being greater than a spot diameter of an optical spot formed on the track; an obtaining part for obtaining a suitable recording power and recording strategy in accordance with the levels of reproduction signals generated from the test areas; and a recording part for recording the multilevel data on the track of the recording surface of the optical disk by using the obtained recording power and recording strategy.

In the optical disk apparatus according to an embodiment of the present invention, the suitable recording power and the recording strategy may be obtained when the difference between a greatest value and a least value of the levels of reproductions signals is no more than a reference value.

In the optical disk apparatus according to an embodiment of the present invention, the reference value may be recorded in the optical disk.

In the optical disk apparatus according to an embodiment of the present invention, the optical disk apparatus may further include a determining part for determining the type of the optical disk, wherein the reference value is selected from predetermined values in accordance with the type of the optical disk.

In the optical disk apparatus according to an embodiment of the present invention, the reference value may include a value obtained by calculating a formula of {|DR|/{γ·(α−1)}}, wherein α is a value of the multilevel data which is no less than 3, DR is the difference between a reproduction signal level of an unrecorded area and a reproduction signal level of an area in which a largest mark is recorded, and γ is a value no less than 1.

In the optical disk apparatus according to an embodiment of the present invention, the multilevel data may include multilevel data corresponding to the largest mark, wherein the reference value is obtained by referring to the reproduction signals generated from the test areas.

In the optical disk apparatus according to an embodiment of the present invention, the recording part may further record the obtained reference value in the optical disk.

In the optical disk apparatus according to an embodiment of the present invention, the suitable recording power and the recording strategy may be obtained when an average value of the levels of the reproduction signals falls within a predetermined range.

In the optical disk apparatus according to an embodiment of the present invention, the suitable recording power and the recording strategy may be obtained when the difference between at least one of the greatest value of the levels of the reproduction signals and the least value of the levels of the reproduction signals, and an average value of the levels of the reproduction signals is no more than a predetermined reference value.

In the optical disk apparatus according to an embodiment of the present invention, the number of multilevel data levels recorded in the test areas is set to satisfy a formula of β=A+2, wherein β represents the number of multilevel data levels recorded in the test area, wherein A represents an integer when a calculation result of 2R÷S is rounded up, wherein 2R represents the spot diameter of the optical spot, wherein S represents the length of the test area.

In the optical disk apparatus according to an embodiment of the present invention, the levels of reproduction signals generated from the test areas may be derived by omitting the multilevel values of a foremost test area and a rearmost test area obtained by rounding down a calculation result of R÷S, respectively.

Furthermore, the present invention provides a program used for an optical disk apparatus operable to record multilevel data on a track of a recording surface of an optical disk, the program including: a writing process for writing plural of the multilevel data levels having a same value in a plurality of test areas, each of the test areas having a prescribed length in a direction of a line tangent to the track, the prescribed length being greater than a spot diameter of an optical spot formed on the track; an obtaining process for obtaining a suitable recording power and recording strategy in accordance with the levels of reproduction signals generated from the test areas; and a recording process for recording the multilevel data on the track of the recording surface of the optical disk by using the obtained recording power and recording strategy.

Furthermore, the present invention provides a computer-readable recording medium including: the above-described program of the present invention.

According to another aspect of the present invention, it is another and more specific object of the present invention to provide a recording method for recording data on a recording layer of an optical disk, the recording method including the steps of: a) preheating the recording layer to a temperature less than an initial mark forming temperature by irradiating at least a single preheat pulse onto the optical disk, the preheat pulse having a power level that is greater than a reproduction power for the optical disk and less than a recording power for the optical disk; b) heating the recording layer to a temperature equal to or greater than the initial mark forming temperature by irradiating at least a single main pulse onto the optical disk; the main pulse having a power level the same as the recording power for the optical disk.

In the recording method according to an embodiment of the present invention, the preheat pulse may have a power level that is no more than 80% of the recording power.

In the recording method according to an embodiment of the present invention, the preheat pulse may include a first pulse and a second pulse, wherein the first pulse has a power level that is different from a power level of the second pulse.

In the recording method according to an embodiment of the present invention, one of the first pulse and the second pulse may have a power level that is no more than 40% of the recording power.

In the recording method according to an embodiment of the present invention, the data recorded in the optical disk may include at least one of binarized data and multilevel data having three or more values.

In the recording method according to an embodiment of the present invention, when the data recorded to the optical disk are binarized data, step a) may be executed when a mark among the marks formed on the recording layer is shortest.

In the recording method according to an embodiment of the present invention, the main pulse may include at least a single pulse.

In the recording method according to an embodiment of the present invention, the temperature of the recording layer may have a point where temperature suddenly changes before reaching the initial mark forming temperature.

In the recording method according to an embodiment of the present invention, the temperature of the recording layer may have no point where temperature suddenly changes after the temperature of the recording layer is no less than the initial mark forming temperature.

Furthermore, the present invention provides an optical disk apparatus for recording data on a recording layer of an optical disk, the optical disk apparatus including: an optical pickup apparatus for irradiating a laser light by employing pulse emission; preheating part for preheating the recording layer to a temperature less than an initial mark forming temperature by irradiating at least a single preheat pulse onto the optical disk, the preheat pulse having a power level that is greater than a reproduction power for the optical disk and less than a recording power for the optical disk; a heating part for heating the recording layer to a temperature equal to or greater than the initial mark forming temperature by irradiating at least a single main pulse onto the optical disk; the main pulse having a power level the same as the recording power for the optical disk.

In the optical disk apparatus according to an embodiment of the present invention, the preheat pulse may have a power level that is no more than 80% of the recording power. In the optical disk apparatus according to an embodiment of the present invention, the preheat pulse may include a first pulse and a second pulse, wherein the first pulse has a power level that is different from a power level of the second pulse.

In the optical disk apparatus according to an embodiment of the present invention, one of the first pulse and the second pulse has a power level that is no more than 40% of the recording power.

In the optical disk apparatus according to an embodiment of the present invention, the data recorded in the optical disk may include at least one of binarized data and multilevel data having three or more values.

In the optical disk apparatus according to an embodiment of the present invention, when the data recorded to the optical disk are binarized data, the preheating may be executed when a mark among the marks formed on the recording layer is shortest.

In the optical disk apparatus according to an embodiment of the present invention, the main pulse may include at least a single pulse.

In the optical disk apparatus according to an embodiment of the present invention, the temperature of the recording layer may have a point where temperature suddenly changes before reaching the initial mark forming temperature.

In the optical disk apparatus according to an embodiment of the present invention, the temperature of the recording layer may have no point where temperature suddenly changes after the temperature of the recording layer is no less than the initial mark forming temperature.

Other objects and further features of the present invention will be apparent from the following detailed description when read in conjunction with the accompanying drawings.

### BRIEF DESCRIPTION OF DRAWINGS

FIG. 1 is a drawing showing a recording waveform of strategy A;

FIG. 2 is a drawing showing a recording waveform of strategy B;

FIG. 3 is a drawing showing a recording waveform of strategy C;

FIG. 4 is a drawing showing reproduction signals obtained from parts where stepped waves are recorded;

FIG. 5 is a diagram showing test results of power dependency of the entire pulse width in executing stepped wave recording by using the recording waveform shown in FIG. 1;

FIG. 6 is a diagram showing test results of power dependency of the entire pulse width in executing stepped wave recording by using the recording waveform shown in FIG. 2;

FIG. 7 is a diagram showing test results of power dependency of the entire pulse width in executing stepped wave recording by using the recording waveform shown in FIG. 3;

FIG. 8 is a diagram showing the effects of introducing bias power (Pbi) to the waveform recording shown in FIG. 2;

FIG. 9 is a diagram showing a relation between Wt/Lt (ratio between an entire pulse time span Wt of the highest level marks and a time span Lt for a basic cell length in a case of random recording using the waves shown in FIGS. 2 and 3) and SDR value;

FIG. 10 is a diagram showing a relation between Wg/L (ratio between an average groove width Wg for guide grooves and a basic cell length in a case of random recording using the waves shown in FIGS. 2 and 3) and SDR value;

FIG. 11 is a diagram showing a relation between L/Dp (ratio between a basic cell length L and a depth of a guide groove Dp in a case of random recording using the waves shown in FIGS. 2 and 3) and SDR value;

FIG. 12 is a diagram showing a relation between Pf/Pb (ratio between recording powers Pf and Pb in a case of random recording using the wave shown in FIG. 2) and SDR value;

FIG. 13 is a diagram showing the x axis of FIG. 12 changed to recording power Pb;

FIG. 14 is a diagram showing a relation between Wb/Wt (ratio between a pulse time span Wb and an entire pulse time span Wt of the highest level marks in a case of random recording using the wave shown in FIG. 2) and SDR value;

FIG. 15 is a diagram showing changes of a real part n and an imaginary part k of a complex refractive index of an organic material;

FIG. 16 is a diagram showing a relation between a main absorption band and a recording/reproduction wavelength of an organic material;

FIG. 17 is a view obtained by AFM observation of a part of a substrate surface in a case of recording on a commercially available DVD-R;

FIG. 18 is a diagram showing a relation between a main absorption band and a recording/reproduction wavelength of an organic material;

FIG. 19 is a diagram showing test results of power dependency of the entire pulse width in executing stepped wave recording by using the strategies shown in FIGS. 1-3;

FIG. 20 is a diagram showing the effects of introducing bias power;

FIG. 21 is a diagram showing a relation between Wt/Lt (ratio between an entire pulse time span Wt of the highest level marks and a time span Lt for a basic cell length in a case of random recording using the two-step wave shown in FIG. 2) and SDR value;

FIG. 22 is a diagram showing a relation between Wg/L (ratio between an average groove width Wg for guide grooves and a basic cell length in a case of random recording using the waves shown in FIGS. 2 and 3) and SDR value;

FIG. 23 is a diagram showing a relation between L/Dp (ratio between a basic cell length L and a depth of a guide groove Dp in a case of random recording using the waves shown in FIGS. 2 and 3) and SDR value;

FIG. 24 is a diagram showing a relation between Pf/Pb (ratio between recording powers Pf and Pb in a case of random recording using the wave shown in FIG. 2) and SDR value;

FIG. 25 is a diagram showing a relation between Wb/Wt (ratio between a pulse time span Wb and an entire pulse time span Wt of the highest level marks in a case of random recording using the wave shown in FIG. 2) and SDR value;

FIG. 26 is a diagram showing a correlation between a basic cell width and a multi-value recording pulse position;

FIG. 27 is a diagram showing a relation between multi-value of each level and a center position;

FIG. 28 is a diagram showing test results of power dependency of the entire pulse width in executing stepped wave recording by using the strategies shown in FIGS. 1-3 with respect to phthalocyanine media according to a third embodiment of the present invention;

FIG. 29 is a diagram showing test results of power dependency of the entire pulse width in executing stepped wave recording by using the strategies shown in FIGS. 1-3 with respect to TeO media according to a third embodiment of the present invention;

FIG. 30 is a diagram showing the effects of introducing bias power;

FIG. 31 is a diagram showing a relation between Wt/Lt (ratio between an entire pulse time span Wt of the highest level marks and a time span Lt for a basic cell length in a case of random recording using the two-step wave shown in FIG. 2) and SDR value;

FIG. 32 is a diagram showing a relation between Wg/L (ratio between an average groove width Wg for guide grooves and a basic cell length in a case of random recording) and SDR value;

FIG. 33 is a diagram showing a relation between L/Dp (ratio between a basic cell length L and a depth of a guide groove Dp in a case of random recording using the waves shown in FIGS. 2 and 3) and SDR value;

FIG. 34 is a diagram showing a relation between Pf/Pb (ratio between recording powers Pf and Pb in a case of random recording using the wave shown in FIG. 2) and SDR value;

FIG. 35 is a diagram showing a relation between Wb/Wt (ratio between a pulse time span Wb and an entire pulse time span Wt of the highest level marks in a case of random recording using the wave shown in FIG. 2) and SDR value;

FIG. 36 is a diagram in which a recording waveform of the invention shown in Japanese Laid-Open Patent Application No. 60-150240 is rewritten to be illustrated in the same manner as the waveforms of the present invention shown in FIGS. 1-3;

FIG. 37 is a diagram in which a recording waveform of the invention shown in Japanese Laid-Open Patent Application No. 63-113938 is rewritten to be illustrated in the same manner as the waveforms of the present invention shown in FIGS. 1-3;

FIG. 38 is a block diagram showing a configuration of an optical disk apparatus according to an embodiment of the present invention;

FIG. 39 is a drawing for explaining multi-leveling of information;

FIG. 40 is a drawing for explaining a configuration of an optical pickup apparatus shown in FIG. 38;

FIG. 41 is a flowchart for explaining a recording process according to an embodiment of the present invention;

FIG. 42 is a diagram for explaining a single test area;

FIG. 43 is a waveform diagram for explaining a reproduction signal(s) of a test area;

FIGS. 44A-44C are waveform diagrams for explaining a reproduction signal(s) of a single test area;

FIGS. 45A-45B are waveform diagrams for explaining a reproduction signal(s) in a case where a test area includes ten cells;

FIG. 46 is a diagram for explaining a test area including three cells;

FIGS. 47A-47B are waveform diagrams for explaining a reproduction signal(s) of the test area shown in FIG. 46;

FIG. 48 is a flowchart for explaining a modified recording process according to an embodiment of the present invention;

FIG. 49 is a diagram for explaining a laser control circuit shown in FIG. 38;

FIG. 50 is a diagram for explaining a configuration of a virtual disk used in a simulation according to an embodiment of the present invention;

FIG. 51 is a table for explaining characteristics of a virtual disk used in a simulation according to an embodiment of the present invention;

FIG. 52 is a diagram for explaining multilevel data recorded on a virtual disk in a simulation and a cell;

FIG. 53 is a diagram for explaining change of temperature of the recording layer with respect to a cell center;

FIG. 54 is a diagram for explaining a eight emission pulse including a preheat pulse and a main pulse used in a simulation;

FIG. 55 is a diagram for explaining simulation results in using the light emission pulse of FIG. 54;

FIG. 56 is a diagram for explaining a light emission pulse of only a main pulse used for a purpose of comparison;

FIG. 57 is a diagram for explaining simulation results in using the light emission pulse of FIG. 56;

FIG. 58A is an isothermal diagram of cell B in a case where the light emission pulse of FIG. 54 is used;

FIG. 58B is an isothermal diagram of cell B in a case where the light emission pulse of FIG. 56 is used;

FIG. 59 is a diagram for explaining simulation results in a case where the recording power of FIG. 56 is set to 6.0 mW;

FIG. 60 is a diagram for explaining simulation results in a case where the recording power of FIG. 56 is set to 5.5 mW;

FIG. 61 is a diagram for explaining a first modified example of the light emission pulse of FIG. 54;

FIG. 62 is a diagram for explaining simulation results in using the light emission pulse of FIG. 61;

FIG. 63 is a flowchart for explaining a recording process according to an embodiment of the present invention;

FIGS. 64A-64D are diagrams for explaining a relation of the temperature of a recording layer and the elapsed time after the start of irradiation;

FIG. 65 is a diagram for explaining a second modified example of the light emission pulse of FIG. 54;

FIG. 66 is a diagram for explaining a third modified example of the light emission pulse of FIG. 54;

FIG. 67 is a diagram for explaining a fourth modified example of the light emission pulse of FIG. 54;

FIG. 68 is a diagram for explaining a fifth modified example of the light emission pulse of FIG. 54;

FIG. 69 is a diagram for explaining a sixth modified example of the light emission pulse of FIG. 54;

FIG. 70 is a diagram for explaining a first light emission pulse including a preheat pulse in a case of employing a binary recording type;

FIG. 71 is a diagram for explaining a second light emission pulse including a preheat pulse in a case of employing a binary recording type; and

FIG. 72 is a diagram for explaining a third light emission pulse including a preheat pulse in a case of employing a binary recording type.

### BEST MODE FOR CARRYING OUT THE INVENTION

The present invention is described in detail based on the embodiments illustrated in the drawings.

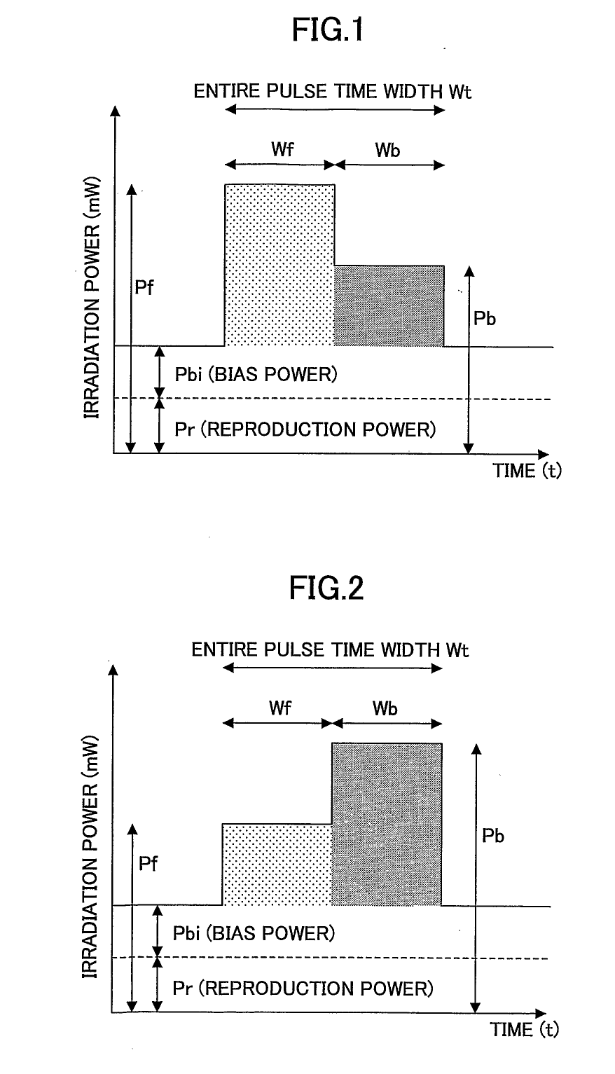

Like the invention 1, these inventors found out that there was an effect which raises a recording sensitivity and lowers the SDR value by setting the ratio (Pbi/Pr) of the reproduction power (Pr) and the bias power (Pbi) to 0.5 or more than 0.5, and always introducing power that added bias power (Pbi) to the reproduction power (Pr) at the time of record. Preferably, Pbi/Pr is 1 or more than 1, and more preferably, Pbi/Pr is between 2 and 4. However, since the optimal Pbi/Pr changes with the reflectance and recording speed of the medium, when carrying out the invention, it is desirable to calculate the optimal Pbi/Pr for every kind of medium. The reproduction power in the invention is laser power used for reading at the time of reproduction of the recorded medium, and the power always introduced in the invention is the power which added bias power to the above reproduction power. FIG. 1 to 3 is mentioned as examples of the waveform of the invention 1. In these figures, Pf is the recording power for the former half, Pb is the recording power for the latter half, Wf is the pulse time width of the recording power for the former half, and Wb is the pulse time width of the recording power for the latter half.

Also, like the invention 2, when the ratio of the diameter of a beam which is set to 1/e² of central intensity of laser (the diameter of laser beam) D, and the length of the recording unit (basic cell) of recording mark for multilevel is the range of 1<D/L and the multilevel recording is performed in the basic cell of length shorter than the diameter of the beam, these inventors found out that there was an effect which raises the recording sensitivity and lowers the SDR value by setting the ratio (Pbi/Pr) of the reproduction power (Pr) and the bias power (Pbi) to 0.5 or more than 0.5, and always introducing power that added bias power (Pbi) to the reproduction power (Pr) at the time of record. Preferably, Pbi/Pr is 1 or more than 1, and more preferably, Pbi/Pr is between 2 and 4. However, since the optimal Pbi/Pr changes with the reflectance and the recording speed of the medium, when carrying out the invention, it is desirable to calculate the optimal Pbi/Pr for every kind of medium.

The SDR is an index equivalent to jitter in 2 value records. When each reflective level of the multilevel data level mi (m₀, m₁, m₂, , , , m_{α-2}, m_{α-1}) which consists of a kinds is set to Ri (R₀, R₁, R₂, , , , R_{α-2}, R_{α-1}) and standard deviation of the reflective level Ri in the multilevels level mi is set to σmi, it is the value given by the following formula.

SDS=(σm₀+σm₁+σm₂+ , , , +σm_{α-2}+σm_{α-1})/[(1+α)|R₀−R_{α-1}|]

In the invention 3, in addition to the requirements for the invention 2, the recoding is performed using the strategy which at least the ratio Wt/Lt of the entire pulse time width Wt of maximum level mark and the time width Lt of basic cell length is between 0.3 to 0.8. By doing this, the SDR value can be lowered especially for the random signal recording.

For the recording and reproduction method of the invention 3, in the invention 4, the recoding is performed on the recordable type optical recording medium with conditions at the 0.25-0.5 micro meter of track pitch, 15-150 nm of depth and 0.15-0.35 macro meter of average groove width for the guiding groove, and the reflectance of non-recording in is 2-50% using laser beam within blue wavelength range below than 450 nm. In this case, the SDR value can be lowered especially for the random signal recording. There is no lower limit of wavelength, if LD is developed, although without limit short wavelength can be used, in the present condition, a BeMgZnSe is direct changes II-VI family compound semiconductor which has large prohibition zone width of 2.68-4.72 eV, and if phosphate gallium (GaP) and silicone (Si) are used as a substrate material, it may be able to cover a 295-345 nm of ultraviolet ray domain.

Also, like the invention 5, it is preferable that the Wg/L ratio of the average groove width Wg of the guiding groove and the length L of recording unit (basic cell) of recording mark for multilevel is between 0.7 and 1.5. If the Wg/L is below than 0.7, the influence of a crosstalk becomes large, and if the Wg/L is above the 1.5, the interference between codes becomes large.

Also, like the invention 6, it is preferable that the L/Dp ratio of the length L of recording unit (basic cell) of the recording mark for multilevel and the depth Dp of the guiding groove is between 3 and 8. If the L/Dp is below than 3, the interference between codes becomes large, and if the L/Dp is above the 8, the SDR value deteriorates.

In the invention 7, the recording is performed using the strategy consists of two or more than two stages of different recording powers.

Although these inventors found out that it was possible to lower the SDR value by shortening the pulse width and making interference between codes small by each recording mark, it is necessary to raise the recording power and the sensitivity falls to make the pulse width small and obtain equivalent modulation. Therefore, as a result of examining, it found out acquiring good SDR values, without reducing the sensitivity according to the conditions of the invention 7.

For example, like the invention 8, if the recording power is two stages and the recording is performed with the strategy that the Pf/Pb ratio of the recording power of the former half (Pf) and the recording power of the latter half (Pb) is between 0.3 and 1, the above-mentioned effect can be acquired easily. However, when the recording power of the former half Pf was enlarged, most effects which lower sensitivity were not seen. Although a range from 0.3 to 1 shows good SDR values, it is more desirable range from 0.4 to 0.9. An example of waveform of the invention 8 is the FIG. 2. Although it is desirable for the former half and the latter half to be the same pulse time width as the invention 10 later explains, it will be satisfactory if the former half and the latter half are divided into the extent which does not affect the record characteristic.

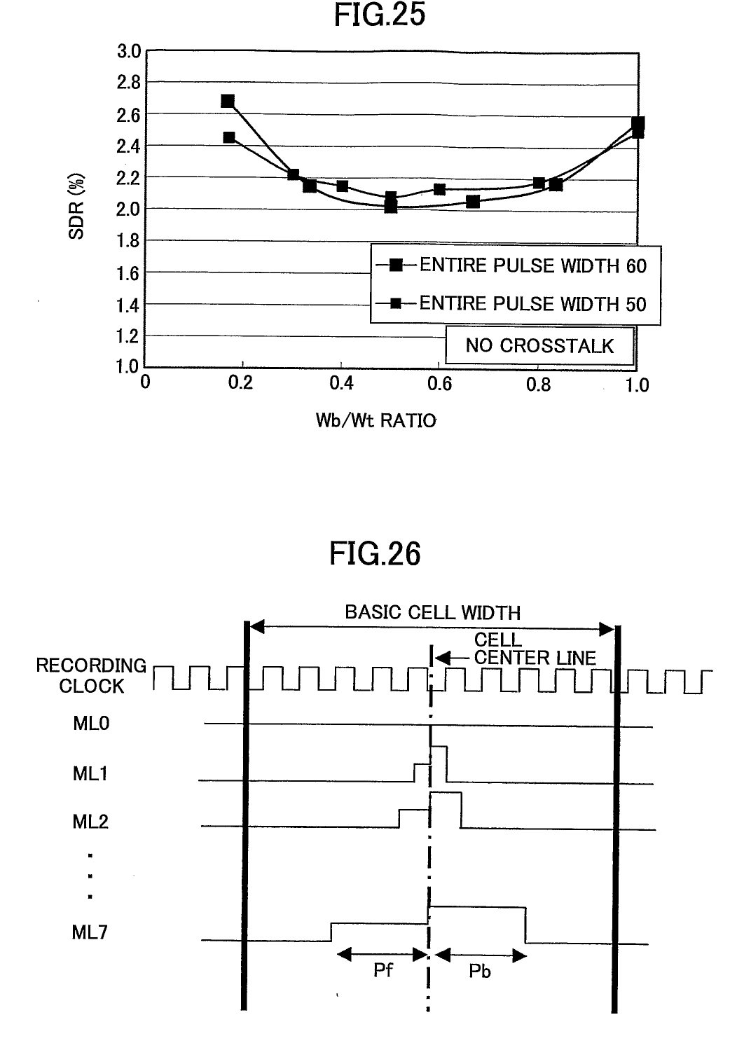

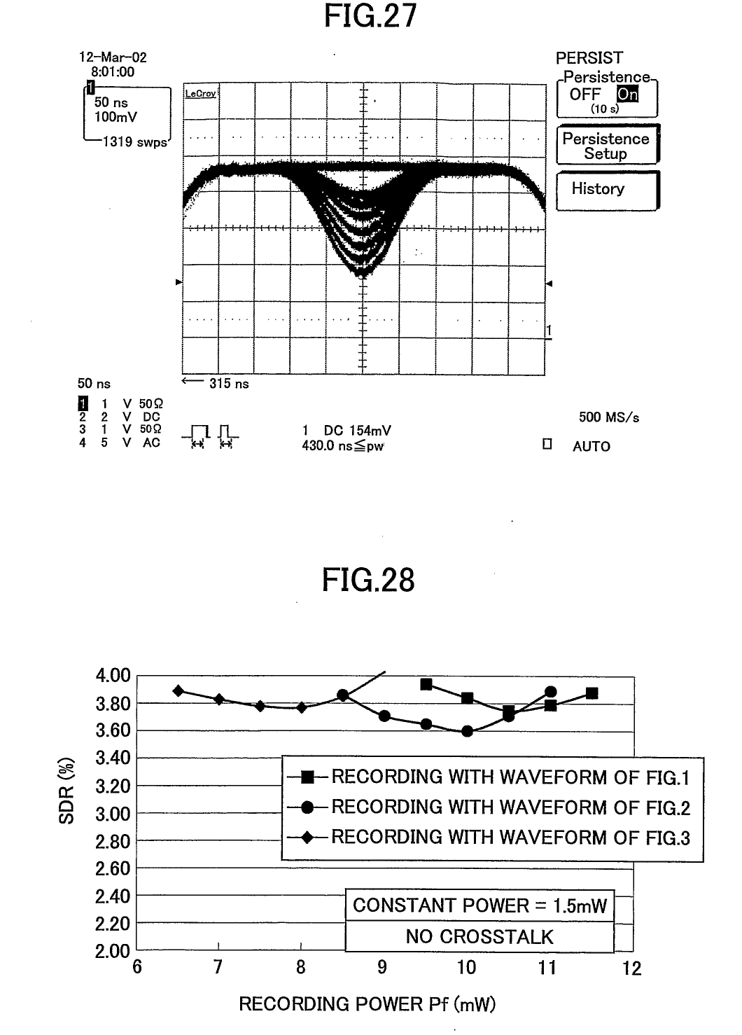

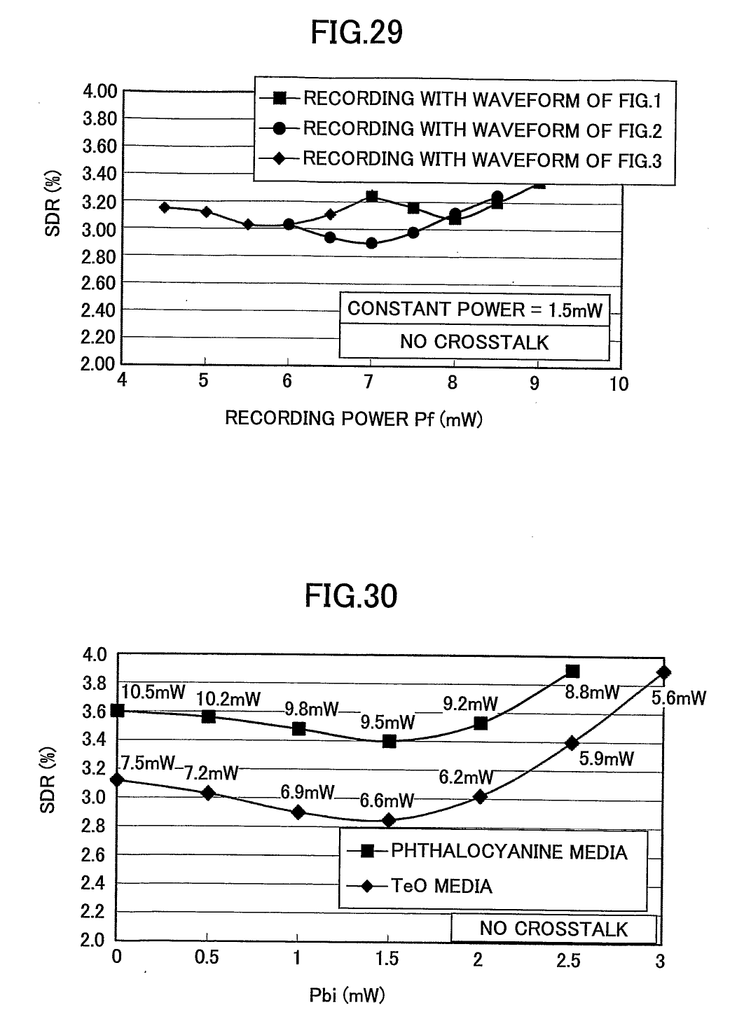

Also, in the invention 9, the recoding is performed using the strategy which the Wb/Wt ratio of the pulse time width Wb and the entire pulse time width Wt of the recording power of the latter half of maximum level mark is between 0.3 and 0.8. By doing so, still better SDR value can be acquired. In the invention 10, the recording is performed by which a switching point of the recording power of the former half (Pf) and the recording power of the latter half (Pb) for two stages in the recording power corresponds to the center of the basic cell. That is, since it is an ideal that the multilevel signal recorded by the method of this invention is arranged at the center of each basic cell, as for the correlation of the basic cell width and the multilevel recording pulse position, it is desirable to make the center of the basic cell in accord with the switching point of Pf and Pb as shown in FIG. 26, thereby, the multilevel signal is arranged at the center of each basic cell, and shows good SDR values. The multilevel signal of FIG. 26 shows eight values, and ML (multi-level) is between 0 and 7.

By the invention 10, the effect by which the multilevel recording signal came to be arranged in the center position of the basic cell is shown in FIG. 27. Although this figure displays the multilevel signal of each level for the basic cell in layers with an oscilloscope, the multilevel signal of each level is uniform to the central position of the basic cell, and it can be understood that there is a great effect by uniting the position of the signal like the invention 10.

In the invention 11, the recording is performed on the recordable type optical recording medium at least having a thin layer (RO layer) including each element of R and O (R is one or more element selected from group consists of Y, B, I, In, and lantern series element and O expresses oxygen) and a thin layer of organic material above its substrate. Mainly, coloring pigments are used as the organic material.

These inventors previously applied for an invention about the recordable type optical recording medium in which the recording and the reproduction is possible by the laser of a blue domain (Patent Application Number 2003-110867, and Patent Application Number 2003-112141). Again, the details are explained to the following briefly.

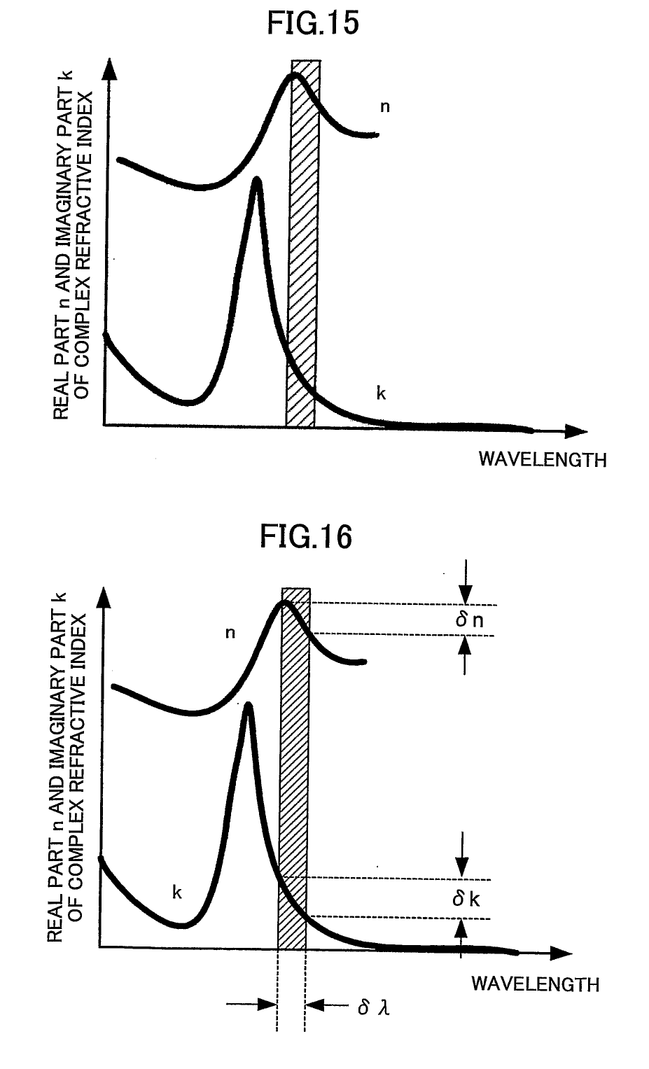

It is necessarily that any suitable material of the optical property and decomposition action to the blue laser wavelength is selected for the organic material used in the recording layer of the recordable type optical recording medium for blue laser. In order to improve the reflectance at the time of non-recording, and for the organic material to decompose by laser irradiation and to make it a great refractive index change arise (thereby the great degree of tone change is obtained by this.), the recording reproduction wavelength is chosen such that it may be located in the skirt by the side of the long wavelength of a large absorption zone. It is because the skirt by the side of the long wavelength of the large absorption zone of the organic material serves as a wavelength domain where it has a moderate absorption coefficient, and a great refractive index is obtained as the reason (Please refer FIG. 15. In the recordable type optical recording medium whose conventional organic material is a recording layer, the recording and the reproduction wavelength are set as the slash portion in the FIG. 15.).

However, any organic material having the value which can use the optical property over blue laser wavelength has not been found yet. Although it is necessary to make a molecule frame small or to shorten a conjugate system in order to obtain the organic material which has the absorption zone near the blue laser wavelength, because of the fall of an absorption coefficient, i.e., the decline in the refractive index. That is, although it is possible to be existed much organic material having the absorption zone near the blue laser wavelength and to control the absorption coefficient, because it is not a big refractive index, the great degree of tone change cannot be obtained.

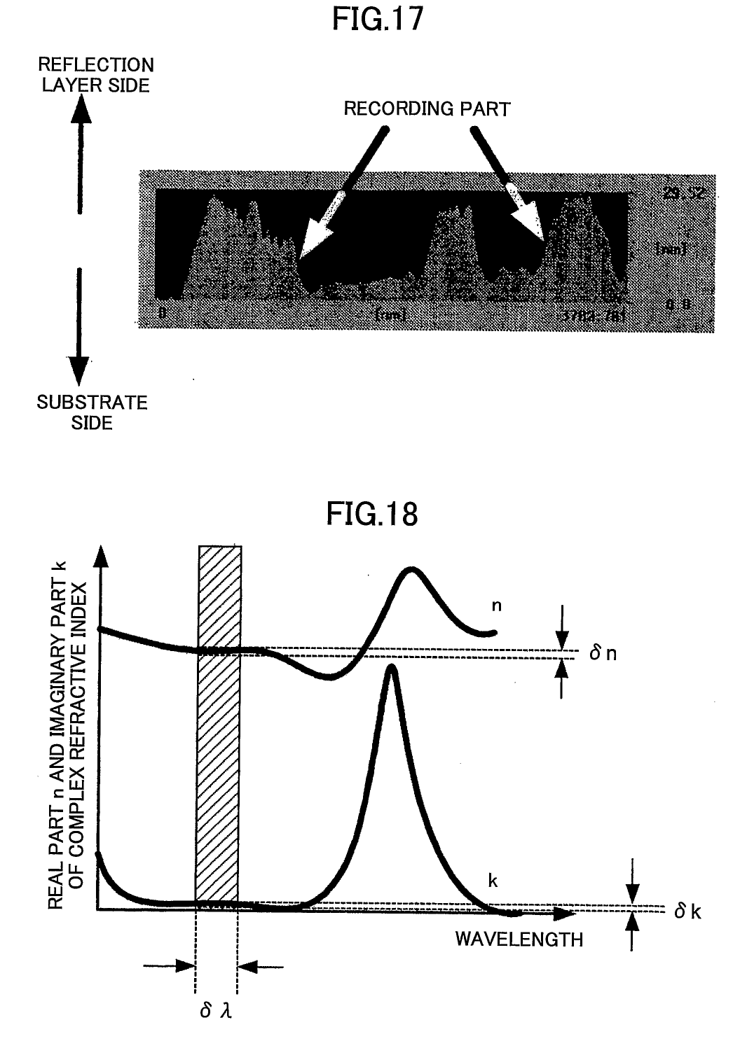

Also, in the conventional recordable type optical recording medium, the recording is performed by modification of the substrate with the change of refractive index by decomposition and deterioration of the organic material. For example, as seen by FIG. 17 [figure observed from the surface of the substrate of the portion which is recorded into commercial CVC-R by AFM (Atomic force microscope)], the substrate is changing into the reflective layer side, thereby generating the degree of tone change by this modification.

Also, in the conventional recordable type optical recording medium with organic material, as indicated in FIG. 16, because the main absorption zone of the organic material existed near the recording/reproduction wavelength, the dependability of the wavelength of the optical constant of the organic material became high (the optical constant is considerably changed with wavelength.), there was a problem which the record characteristic like the recording sensitivity, the degree of tone change, jitter, and the rate of an error, and reflectance change a lot to the change of the recording and reproduction wavelength by the solid difference of laser, changes of environmental temperature, etc. However, because the interference between the recording marks will become large even if good jitter and the degree of tone change are obtained when modification is the main principle of recording, there is a problem that the margin of various kinds of recording and reproduction characteristics becomes narrow. Therefore, it is a subject in the recordable type optical recording medium using blue wavelength domain laser to generate the great degree of tone change by the recording mark of the small amount of modification.

In addition, because the organic material does not have sufficient absorption ability to the recording light, it cannot make thickness of the film of the organic material thin. Thus, it is necessary to use the substrate having deep spot (because the organic material is usually formed by the spin coat method, it buries the organic material into the deep groove, and thickens the film.). Therefore, the formation of the substrate having the deep groove becomes very difficult, and it becomes a factor which reduces the quality as the optical recording medium.

Also, because thickness of the film of the organic material was not able to be made thin, it had a problem that the recording power margin etc. became narrow (the problem that various kinds of margins of the recording and reproduction characteristic are narrow).

The subject of the invention which is the point for making it achieve to generate the great degree of tone change by the recording mark of the small amount of modification is the following (A)-(D).

(A) The layer having an optical absorption function does not make decomposition, deterioration, composition change, etc. cause, and the layer itself having the optical absorption function does not make it change greatly.

(B) The layer having an optical absorption function does not make decomposition, deterioration, composition change, etc. cause, and many heat is not transmitted to contiguity layers which are easy to change, such as the substrate. (The heat generated in the layer having the optical absorption function is consumed in the layer having the optical absorption function, thereby it is possible to suppress modification of the substrate etc. small.)

(C) Even if it reduces the amount of modification, in order to generate sufficient degree of tone change, it has the layer which causes a big optical constant change.

(D) Even if it reduces the amount of modification, in order to generate sufficient degree of tone change, the recording principle which makes a layer interface with a contiguity layer unclear is used.

As a result of examining the material which has such a function, it found out that the recordable type optical recording medium which has the combination of the thin film which consists of specific material specified by this invention 11, and the thin film of the organic material was very effective. By using this combination, it is possible to make contribution of the modification in the recording mark very little compared with the past, and the above-mentioned problems can be solved.

In the conventional recordable type optical recording medium, by decomposition and deterioration of the organic material, the absorption coefficient in recording and reproduction wavelength was reduced, and the degree of tone change was generated using the big refractive index change by this.

On the other hand, in the recordable type optical recording medium of the invention 11, conventionally, the function of the main heat generating layers is separated from the heat generating layer due to the optical absorption function and the organic material thin film which was functioning as the recording layer by refractive index change (real part of complex refractive index) which originated in decomposition and deterioration, and RO film which has the optical absorption function apart from the organic material thin film was provided. This is a characteristic of the invention 11.

In the recordable type optical recording medium of the invention 11, the recording mark is formed based on the recording principle of the following A-I.

A) The RO film is modified.

B) The complex refractive index of RO film is changed.

C) The composition of RO film is changed.

D) The RO film is dissolved.

E) The compositional element in RO film is diffused to a contiguity layer.

F) The crystal structure of the RO film is changed.

G) The volume of the organic material thin film is changed.

H) The complex refractive index of the organic material thin film is changed.

I) A cavernous part is made to form in the organic material thin film.

Especially, in the recordable type optical recording medium of the invention 11, it is desirable to mainly form the recording mark for various kinds of changes of state of the RO film (i.e., the above A) to I)). Especially, B) To F) are preferable. For example, because the change of composition, dissolution, or the diffusion to the contiguity layer of compositional elements can be used, the complex refractive index of the RO film is a lot changeable. Also, because the layer interface with the contiguity layer can be made indefinite and the multiplex reflective effect can be repealed, even if it is small modification, the big degree of tone change can be obtained.

That is, by using the above recording principles, it has the following characteristic of (1) to (7), and the recordable type optical recording medium which can generate the large degree of tone change by the recording mark of the small amount of modification can be achieved.

(1) The high-density recordable type optical recording medium which can perform recording and reproduction of 2 values recording easily even if in the blue laser wavelength domain (500 nm or less than 500 nm), especially it is a nearby wavelength domain to 405 nm.

(2) The high-density recordable type optical recording medium which can perform recording and reproduction of multilevel recording easily even if in the blue laser wavelength domain (500 nm or less than 500 nm), especially it is a nearby wavelength domain to 405 nm.

(3) The high-density recordable type optical recording medium suitable for recording and reproduction by the signal processing system by the PRML system even if in the blue laser wavelength domain (500 nm or less than 500 nm), especially it is a nearby wavelength domain to 405 nm.

(4) The recordable type optical recording medium with large margins of jitter, the rate of an error, and so on to the changing of the recording power,

(5) The recordable type optical recording medium with small changing of the record characteristic like recording sensitivity, the degree of tone change, jitter, the rate of an error, the reflectance and so on to the changing of recording and reproduction wavelength.

(6) The recordable type optical recording medium which can perform recording and reproduction easily even if the substrate has shallow groove and superior transferring nature.

(7) The recordable type optical recording medium which recordable to land part.

1. Functions of RO Layer

In the recordable type optical recording medium of the invention 11, the RO film has the main optical absorption functions.

Because this RO film is a material which shows normal distribution (Like the organic material, because it is not the material which has a big absorption zone within a certain wavelength range, the wavelength dependability of the complex refractive index is little.), it can greatly solve the conventional problem with large changing of the record characteristic like recording sensitivity, the degree of tone change, jitter, the rate of an error, the reflectance and so on to the changing of recording and reproduction wavelength due to the individual difference of laser, change of environmental temperature, etc.

In the conventional recordable type optical recording medium, since the thin film of the organic material served functions of the record layer and the optical absorption layer as a double purpose, it is the indispensable condition of the organic material to have a big refractive index n and a comparatively small absorption coefficient k to record reproduction wavelength. Therefore, in order to reach to the decomposition temperature of the organic material, the thickness of a comparatively thick film was required (moreover, the depth of the groove on the substrate was very deep to the phase change typed optical recording medium.).

However, in the recordable type optical recording medium of the invention 11, since the thin film of the organic material mainly needs to have neither the optical absorption function nor the recording function, the thickness of the thin film of the organic material can be thinner compared with the past.

Also, since it is possible to make the thin film of the organic material thin, the substrate which are excel in transferring nature (fabrication nature) and its groove is shallow can be used, while the signal quality of the optical recording medium improves greatly, compared with the past, the substrate can be manufactured (fabricated) easily and cheaply.

Also, by the above-mentioned recording principle, it is hard to be influenced of the form of groove of the substrate at the time of reproduction, the degree of permission to the variation in the form of substrate is high, and the substrate can be manufactured easily and cheaply compared with the past.

Also, because it is possible to make the thin film of the organic material thin, it is possible to extend the recording power margin etc.

The RO film also has the recording function with the optical absorption function.

Specifically, the RO film itself causes the following changes of state by the optical absorption function of the RO film.

(1) Modification (However, compared with the conventional, the amount of modification is little.)

(2) Changes of complex refractive index

(3) Changes of composition

(4) Dissolution

(5) Diffusion to the contiguity layer of compositional elements

(6) Changes of the crystal structure

Thus, because it also has the recording function while having the optical absorption function to the recording and reproduction wavelength of 500 nm or less, it is desirable to choose as R the element which has the optical absorption function to the recording and reproduction wavelength of 500 nm or less.

Also, in order to cause a big complex refractive index change, change of the composition, and the dissolution or to make the contiguity layer diffuse compositional elements, as for R, in the RO film, it is desirable to choose elements which have comparatively low melting point.

From the above viewpoint, one or more elements chosen from group consisting of Y, Bi, In, and the lantern series elements are used as the R. The O represents Oxygen.

Although the invention is about the strategy which embodies good jitter or the SDR value to the recordable type optical recording medium which has the RO film mainly recordable by blue domain laser, also effective in laser recording of large wavelength domain other than the blue wavelength domain.

2. The Function of the Thin Film of the Organic Material

Functions of the thin film of the organic material can be divided roughly into (a) generating functions of the degree of tone change, (b) functions to compensate the waveform of the reproduction signal, (c) control functions, such as reflectance and a tracking signal, and (d) the control function of recording sensitivity.

The generating function of the degree of tone change (a) is expressed by causing the following phenomena specifically for the thin film of the organic material.

The volume of the thin film of the organic material changes with records.

The complex refractive index of the thin film of the organic material changes with records.

The cavernous part is formed into the thin film of the organic material by records.

State changes of the RO film by records are received.

Modifications of the reflective layer are received.

Modifications, changes of complex refractive index, changes of composition, dissolution, diffusion (mix) to the contiguity layer of compositional elements and changes of the crystal structure are indicated to be “changes of state of the RO film” of the description here.

(b) functions to compensate the waveform of the reproduction signal means that although it has a high possibility which the reproduction signal waveform will be confused only by the RO film[a recording polarity cannot change easily with single polarity as high to low.], it is the function which can make the reproduction signal waveform a desired waveform (generally, the recording polarity is high to low.) by providing the thin film of the organic material as the contiguity layer.

Since the thin film of the organic material can control its complex refractive index and thickness in the very wide range, it is clear to have (c) control functions, such as reflectance and a tracking signal.

Also for the function of (d), in the recordable type optical recording medium of the invention 11, although the optical absorption function is mainly given to the RO film, the recording sensitivity is controllable because the thin film of the organic material can be used auxiliary as the optical absorption layer by controlling the complex refractive index (especially, imaginary part of complex refractive index) of the thin film of the organic material.

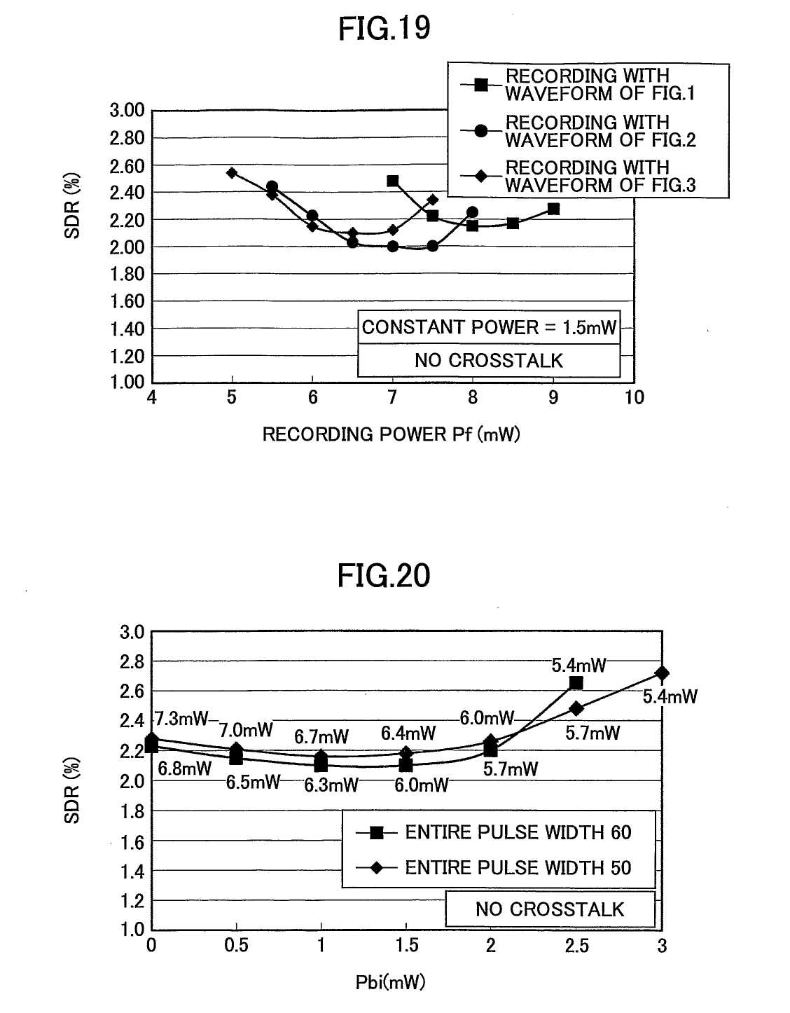

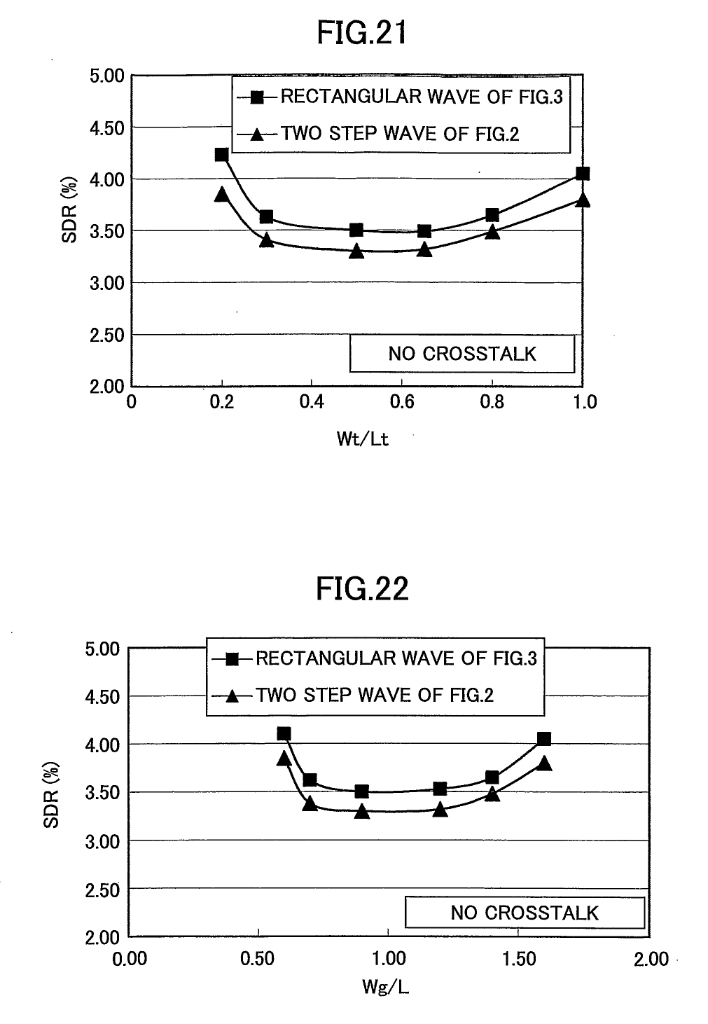

In the recordable type optical recording medium of the invention 11, in order to expand the range of selection of the organic material greatly, even if it is the recordable type optical recording medium using the thin film of the organic material further, in order to make little change of the complex refractive index near the recording and reproduction wavelength (wavelength dependability is made little.), as for the thin film of the organic material, it is desirable that the main absorption zone is located in a long wavelength side to the recording and reproduction wavelength (please refer FIG. 18. A slash portion shows the recording and reproduction wavelength.).

When using the thin film of the organic material auxiliary as the optical absorption layer, as for the value of the imaginary part of the complex refractive index in the recording and reproduction wavelength of the thin film of the organic material, it is desirable that it is less than the value of the imaginary part of the complex refractive index of the RO film. The reason is the following. Making the value of the imaginary part of the complex refractive index in the record reproduction wavelength of the thin film of the organic material large beyond necessity worsens wavelength dependability.

Also, when using the thin film of the organic material auxiliary as the optical absorption layer, as for the thin film of the organic material, it is desirable that the main absorption zone is located in a long wavelength side to the recording and reproduction wavelength, and also it is desirable to have the absorption zone which does not belong to the main absorption zone near the recording and reproduction wavelength.

The invention 12 is characterized by the RO film of the recordable type optical recording medium of the invention 11 containing one or more elements M chosen from the group consisting of Al, Cr, Mn, Sc, In, Ru, Rh, Co, Fe, Cu, Ni, Zn, Li, Si, Ge, Zr, Ti, Hf, Sn, Pb, Mo, V and Nb. Especially, in the case of composition of R₃M₅O₁₂ which forms the so-called Garnett structure, since the hardness of the material can be improved and the hardness of the RO film increases, it is possible to suppress the modification of the RO film itself or the modification of contiguity layers such as the substrate and so on, and the interference between recording marks can be made little.

Also, for the further improvement in preservation stability, it is desirable to choose Bi as R. Although C, Si, Ge, Sn, Pb are mentioned as a 4B family elements, especially Si and Ge are desirable especially. Also, Fe, Co, Cu, Ni, Zn are mentioned as a transition metallic elements, especially Fe and Cu are desirable especially.

Also, in the case of BiOM layer, by action of the addition element M, a large change of complex refractive index, change of composition, and the dissolution are caused, or the capability to make the contiguity layer diffuse compositional elements improves further.

Several advantages using the material comprising each element of R and O, further R, O and M is the following.

(1) Hardness of the layer can be improved by making it an oxide. (It is possible to suppress modification of the RO film itself or modification of contiguity layers, such as substrate.)

(2) Preservation stability can be improved by making it an oxide.

(3) The recording sensitivity can be raised by including elements with the optical high absorptivity to the light of wavelength regions 500 nm or less, such as Bi.

(4) By including elements of low melting point, such as Bi, or elements which are easy to cause diffusion, in spite of not being accompanied with large modification, the recording mark which generates the large degree of tone change can be made to form.

(5) A good thin film can be formed by the gaseous phase growing-up methods, such as sputtering. The thickness of the RO film has desirable 20-500 Angstrom.

Like the invention 13 and 14, the composition using these RO films and the thin film of an organic material is effective in the recordable type optical recording medium and outstanding multilevel recording with low SDR values can be achieved by using the strategy of the invention. Its composition is at least layered of the RO film, the thin film of the organic material and a reflective layer on its substrate in order, or at least layered of the reflective layer, the thin film of the organic material, the RO layer and a cover layer on its substrate in order.

In the invention 15, it records on the recordable type optical recording medium which has the thin layer including at least each element of R and O (however, R is one or more elements selected from a group including Y, Bi, In and lantern series element) on a substrate (called RO layer, below), and the dielectric layer which has ZnS as the main ingredients. Here, of the main ingredient means containing at least 50 mol % of ZnS.

While the above-mentioned invention 11 is aimed at the recordable type optical recording medium which has the thin film of the organic material, in the invention 15, it does not have the thin film of the organic material, but is aimed at the recordable type optical recording medium of structure using the dielectric layer whose ZnS is the main ingredient. About the recording principle and details of others, it is the same as the invention 11.

Same as the invention 12, the invention 16 is characterized by the RO film of the recordable type optical recording medium containing one or more elements M chosen from the group consisting of Al, Cr, Mn, Sc, In, Ru, Rh, Co, Fe, Cu, Ni, Zn, Li, Si, Ge, Zr, Ti, Hf, Sn, Pb, Mo, V and Nb. For the invention 16, the details are the same as that of the invention 12.

Like the invention 17 and 18, the composition using these RO films and the dielectric layer whose ZnS is the main ingredient is effective in the recordable type optical recording medium and outstanding multilevel recording with a low SDR value can be achieved by using the strategy of the invention. Its composition is at least layered of the RO film, the dielectric layer whose ZnS is the main ingredient and a reflective layer on its substrate in order, or at least layered of the reflective layer, the dielectric layer whose ZnS is the main ingredient, the RO layer and a cover layer on its substrate in order.

According to the invention, the recording and reproduction method, in which 2 values (binary) recording or multilevel recording of three or more values is possible, can be offered by the simple record pulse strategy.

Although embodiments and examples of comparison explain the invention still more concretely, the invention is not limited by these embodiments.

### FIRST EMBODIMENT

65 nm of ZnS—SiO₂ thin layer and 12 nm of Bi₂O₃ thin layer were provided in order on a polycarbonate substrate (0.6 mm thickness) having an guiding groove (50 nm of depth) using sputtering. Then, on the above, the thin film (average thickness is about 30 nm) of the organic material consisting of the coloring pigment shown below chemical structure was formed with the spin coating method, and then 150 nm of Ag reflective layer was provided on the above using sputtering, then about 5 micro meter of protection layer consisting of ultraviolet ray hardening type resin (SD1700, Dainihon ink chemical industry inc.) was provided on the above with the spin coating method, thereby the recordable type optical recording medium was fabricated.

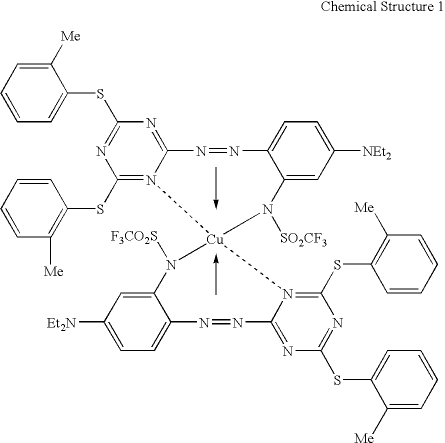

For the above optical recording medium, the multilevel recording was performed. In this case, 8 values (level 0 to level 7) were performed. In the implementation, optical disc evaluation equipment DDU-1000 (wavelength: 405 nm, NA: 0.65, central intensity of laser (1/e² of beam diameter): setup of recording strategy using about 0.55 micro meter (luminescence waveform control of the laser light at the time of recording)) of Pulstec Industry Inc. was operated using AWG-610 of Sony techtronics, Inc, with the basic cell length (recording unit of recording mark): 0.24 micro meter, time width of basic cell length: 48 ns, clock frequency: 2.5 GHZ, recording and reproduction line speed: 5.0 m/s. The reproduction power was 0.5 mW, as explained below, the regular introductory power (Pr+Pbi) was set at 1.5 mW. The ratio of 1/e² of beam diameter of central intensity of laser (laser beam diameter) D and the basic cell length of recording mark for multilevel L is a range of 1<D/L.

First of all, in the record waveform shown in FIGS. 1-3, the steps wave strategy as shown in FIG. 4 estimated the medium so that it might specify which waveform is good. Each record waveform of the invention is made on the regular introductory power (Pr+Pbi).

FIG. 4 is an example in case a multilevel level is eight. The pattern recording the multilevel level continued for five record units (imaginary cell) m₀ (level 0) and the multilevel level continued for 32 record units (imaginary cell) mᵢ are based, then selected a pattern recording the above basic pattern about every each of multilevel level mᵢ (i=0-7) as a test pattern, then recording into the optical recording medium, and FIG. 4 is the example that reproduced the portion on which the test pattern was recorded.

This test pattern is in the state where interference between codes was fixed clearly, and the multilevel level m₀ (level 0) to the multilevel level m₇ (level 7) shows a regular reflective level.

In order to judge the reflective level of the multilevel level mᵢ correctly, also in continuous multiple samplings, it is desirable to choose the test pattern (for example, the test pattern which the multilevel level mᵢ can observe in the shape of an schematic straight line in observation with an oscilloscope) covering multiple recording units which the multilevel level mᵢ continues so that it may be the length from which the reflective level of the same multilevel level mᵢ is obtained. For example, the test pattern from which the multilevel level mᵢ is repeatedly recorded over the recording unit (imaginary cell) which plurality continues, and the (the number of repetitions)×(the length of a record unit) becomes more than the diameter of reproduction light is desirable.

Although it considered as a pattern with which a multilevel level m₀ is inserted by the above-mentioned test pattern whenever the multilevel level mᵢ changed, insertion of this m₀ is not indispensable. However, by inserting m₀, the switching of the multilevel level m₁ becomes clear, and, thereby there is a merit that the timing of a sampling becomes exact. The interference between codes generated when the multilevel level m₁ switches can be suppressed, and there is a merit that the homogeneity of the multilevel level m₁ is improved further. Hereafter, the recording pattern of the waveform of FIG. 4 is called steps wave record. In steps wave record, because interference between codes is little, since the SDR value lower than random wave record can generally be acquired, SDR of steps wave record can be compared with SDR of random wave record.

The time width of the basic cell length corresponds to 48 ns, and conditions were set up as follows. The pulse length setting value (The setting value of the time width in the pulse voltage impressed to laser light elements. Hereafter, it is same.) of the laser light for forming a level 1 (size small to the 2^{nd} and/or the recording mark having the depth) is 7.2 ns, the pulse length setting value of the laser light for forming a level 2 is 10.4 ns, the pulse length setting value of the laser light for forming a level 3 is 12.8 ns, the pulse length setting value of the laser light for forming a level 4 is 15.2 ns, the pulse length setting value of the laser light for forming a level 5 is 16.8 ns, the pulse length setting value of the laser light for forming a level 6 is 19.2 ns, the pulse length setting value of the laser light for forming a level 7 (the greatest size and/or the record mark having the depth)) is 24.ns.

The notation “the entire pulse width” in the figure shown below divides the time width of basic cell length into 100 equally, and is the setting value of the entire pulse time width for the level 7 (the maximum level) of them. That is, in the example that the time width of the basic cell length is 48 ns and the pulse length setting value of the level 7 is 24.ns, the entire pulse width is 50. Also, when the entire pulse width is varied (changed), the pulse length setting values of the other levels 1-6 is changed in proportion to it.

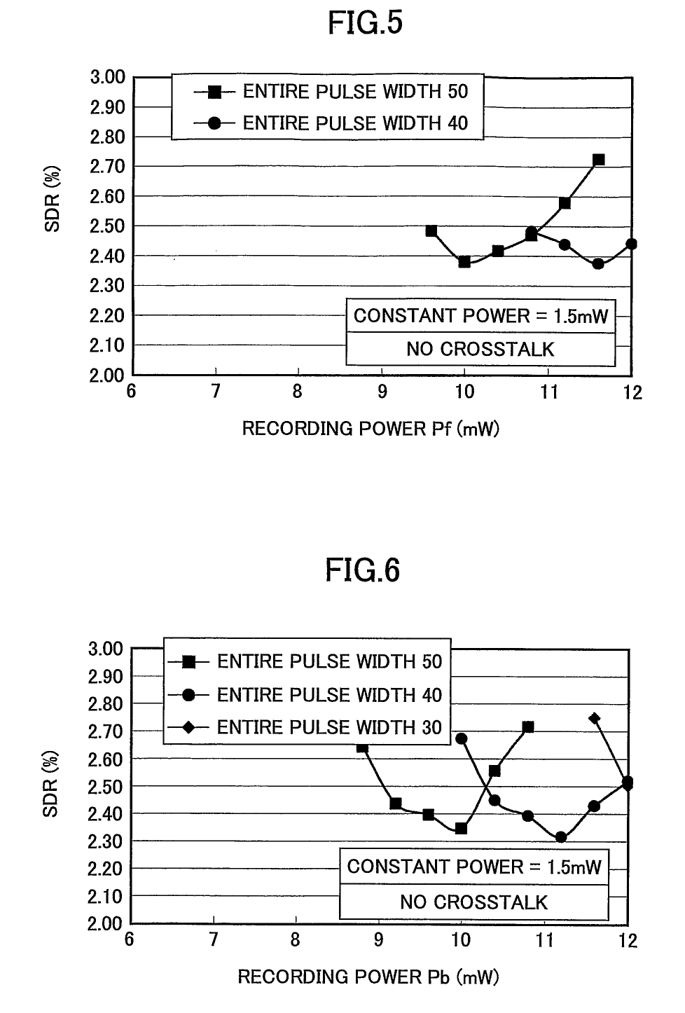

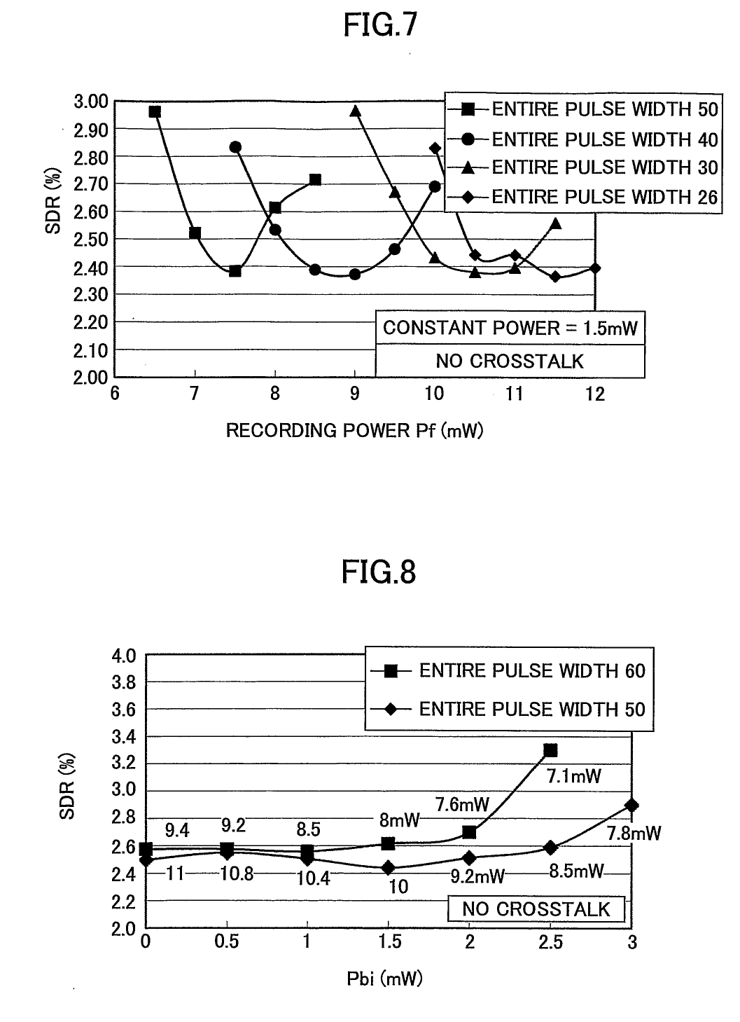

In FIGS. 5-7, steps wave record is performed using recording waveforms shown in FIGS. 1-3, and the result which investigated power dependability about various entire pulse width were shown. Pf, Pb, Wf, and Wb in the figure are the same meaning as the case of FIG. 1, and are similar also in the figure mentioned later. Here, the ratio of the pulse width, Wb/Wf is 1/1, the power ratio, Wb/Wf is respectively 2/1 for FIG. 5, 1/2 for FIG. 6, and 1/1 for FIG. 7.

If the same ratio of the entire pulse width compares these ratios, the sensitivity is good in order of FIG. 7, FIG. 6, and FIG. 5, it is found that the rectangular wave strategy is more highly sensitive than two step wave strategy. However, the FIG. 6 when the recording power, Wb of the latter half is large like the strategy of FIG. 2, the best SDR value (low value) was indicated. In the case of the strategy of FIG. 2, like the strategy of FIG. 1, it was more highly sensitive than the case where the recording power of the former half is large, and the SDR value was also low.

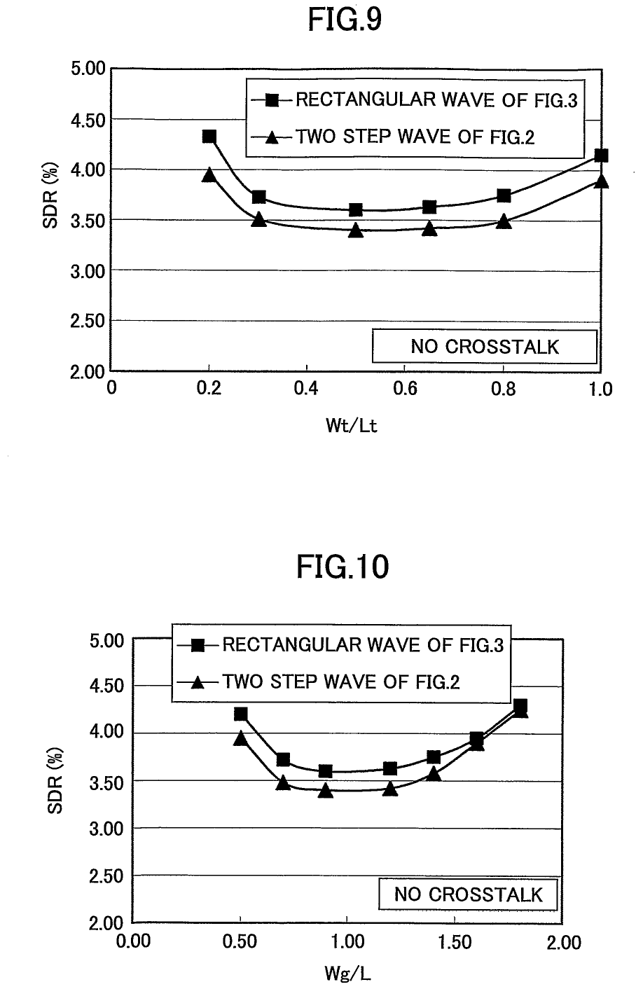

The effect which introduced bias power (Pbi) into waveform record of FIG. 2 is shown in FIG. 8. The recording power (mW) from which, as for the number in the figure, the optimal SDR value for every bias power was acquired was shown, and the recording was performed by the steps wave. The reproduction power (Pr) for carrying out tracking at the time of recording may also be one kind of bias powers, an expression that how much powerful than the reproduction power was used about the regularly introducing bias power in the invention. Therefore, the numerical value of the horizontal axis of FIG. 8 is the bias power value which deducted the numerical value of the reproduction power, 0.5 mW of this experiment from actual regular introductory power (Pr+Pbi).

According to FIG. 8, even when the entire pulse time width of the maximum level mark is any of 50 and 60, by introducing the bias power, it shows that the power which shows the optimal SDR value falls and the sensitivity is improved. It is found that the SDR value at that time is equivalent, or falls. As for bias power, it is desirable to introduce large power 0.25 mW or more than 0.25 mW than reproduction power, preferably 0.5 mW or more than 0.5 mW, more preferably from 1.0 mW to 2.0 mW. In other words, preferably, the ratio of the reproduction power (Pr) and the bias power (Pbi), Pbi/Pr is 1 or more than 1, more preferably, the ratio is between 2 and 4. If the Pbi/Pr exceeds 4, the reflectance change arises on a level 0 and the SDR value deteriorates extremely. However, this value is a numerical value in this embodiment to the utmost, especially, the maximum value is influenced by the laser wavelength of recording and reproduction, the recording and reproduction speed, the reflectance, the sensitivity of the medium, etc. However, when the Pbi/Pr is 0.5 or more at least, there is an effect clear irrespective of conditions.

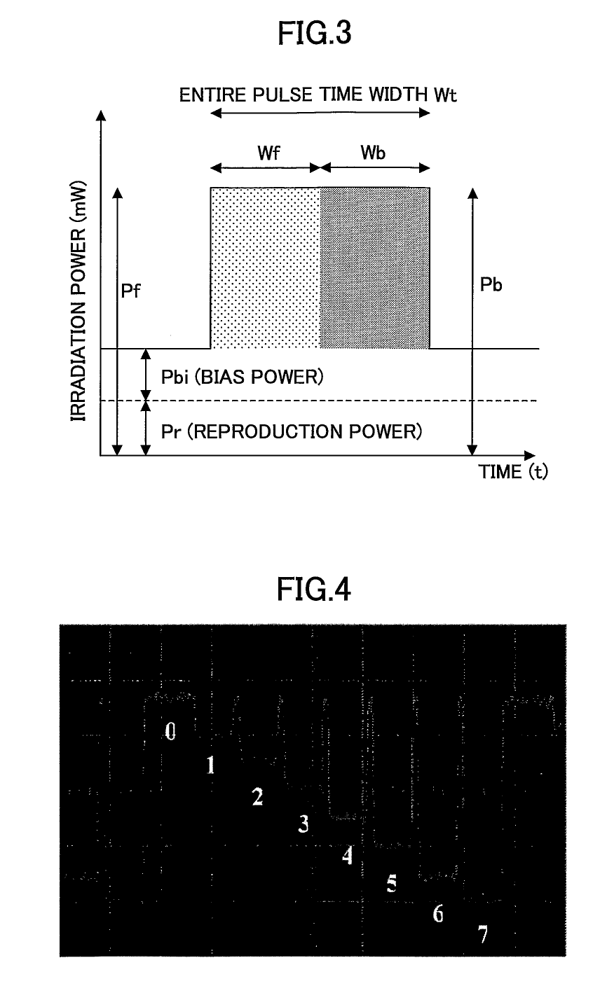

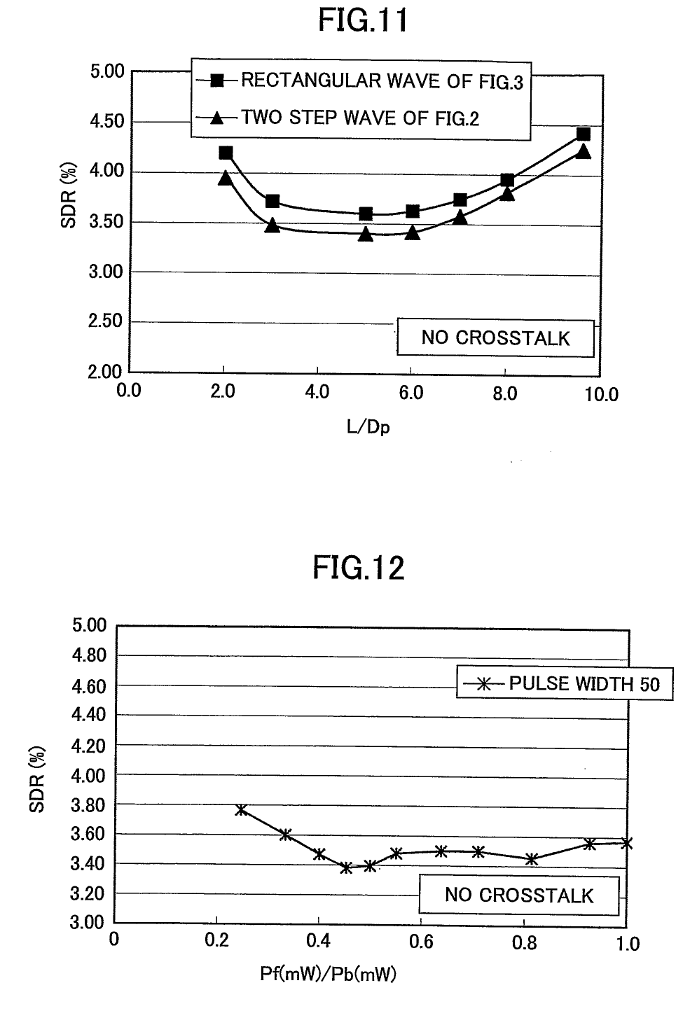

FIG. 9 shows a relationship between the ratio (Wt/Lt) of the entire pulse width Wt of the maximum level mark and the time width of the basic cell length (Lt) at random record for recording with rectangular wave (6.5 mW) of FIG. 3 and two stage waves (8.5 mW) of FIG. 2, and The SDR value. The bias power introduced the value larger 1.0 mW than reproduction power. In two stage waves of FIG. 2, the power ratio of Pb/Pf is 1/2.

As can be seen from FIG. 9, when it is 30 to 80 which divided into 100 equally the time width, Lt of the basic cell length whose entire pulse time width, Wt of the maximum level mark is 0.24 micrometers, that is, both of the strategies showed the good SDR value in the range from 0.3 to 0.8. More preferable range is between 0.35 and 0.7.

Also, in various kinds of factors, the relation between average 0 of groove width, Wg of the guiding groove and the basic cell length, L is very important in order to raise the characteristic of multilevel recording.

FIG. 10 shows a relationship between the ratio (Wg/L) of the average groove width Wg of the guiding groove and the basic cell length (L) at random record for recording with rectangular wave of FIG. 3 and two stage waves of FIG. 2, and The SDR value. 1.0 mW of bias power was introduced. The basic cell length was fixed at 0.24 micro meter and the average groove width Wg of the guiding groove was varied (changed) between 0.5 and 1.8 micro meters.

As can be seen in FIG. 10, the SDR showed good value between 0.7 and 1.5, but out of the range, the value deteriorated rapidly.

Similarly, the relation between depth, Dp of the guiding groove and the basic cell length, L is very important in order to raise the characteristic of multilevel recording.

FIG. 11 shows a relationship between the ratio (L/Dp) of the basic cell length (L) and the depth of the guiding groove (Dp) at random record for recording with rectangular wave of FIG. 3 and two stage waves of FIG. 2, and The SDR value. 1.0 mW of the bias power was introduced. The basic cell length was fixed at 0.24 micro meter and depth Dp of the guiding groove was varied between 25 and 120 micro meters.

As can be seen in FIG. 11, the SDR showed good value between 0.7 and 1.5 of L/Dp, but out of the range, the value deteriorated rapidly. Preferably, L/Dp is between 4 and 7.

FIG. 12 shows a relationship between the ratio (Pf/Pb) of the recording power Pf and Pb at random record for recording with two stage waves of FIG. 2, and The SDR value. 1.0 mW of bias power was introduced. The basic cell length was 0.24 micro meters, the entire pulse time width Wt of the maximum level mark was set to 50 of the half which divided time width Lt of the basic cell length into 100 equally, and the ration of pulse width Wb/Wf was set to 1/1.

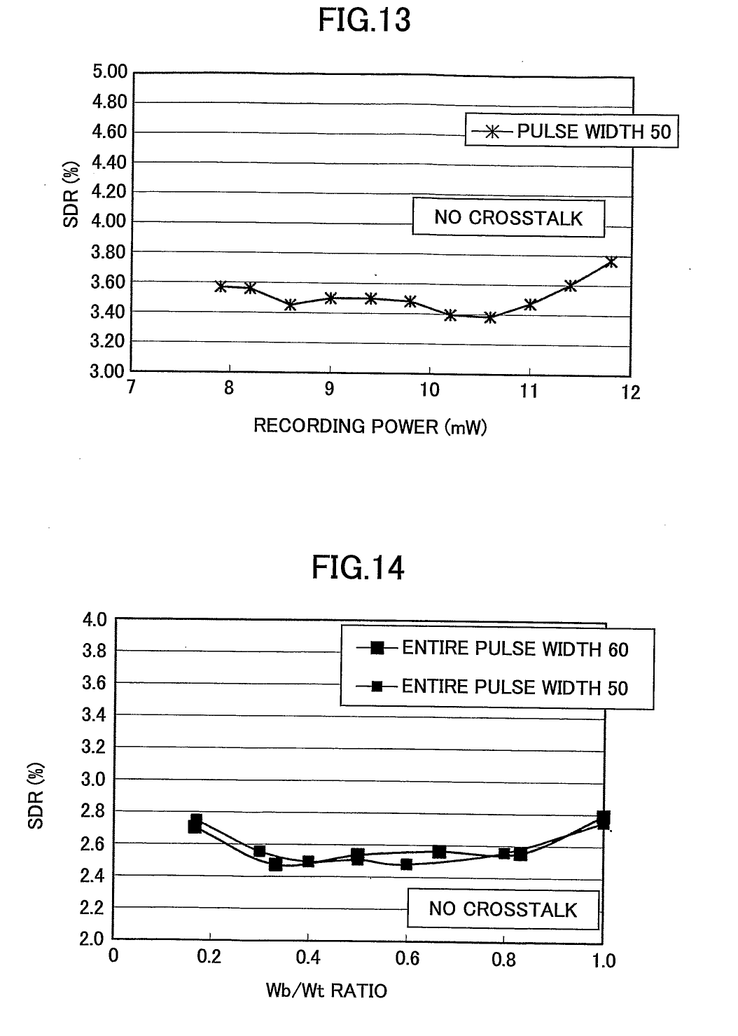

FIG. 13 used same data as well as FIG. 12, and the x axis is substituted with recording power P, instead of Pf/Pb, then FIG. 13 corresponds with the graph of right-and-left reversal of FIG. 12.

As can be seen in FIG. 12, the SDR value showed good value between 0.3 and 1 of Pf/Pb. Especially, the SDR value showed lower value between 0.4 and 0.9 of Pf/Pb, and the recording power fell as the value became large. That is, the recording sensitivity rose.

FIG. 14 shows a relationship between the ratio (Wb/Lt) of the pulse time width Wb of the maximum level mark and the entire pulse time width (Wt) at random record for recording with two stage waves of FIG. 2, and The SDR value. The bias power was made larger 1.0 mW than the reproduction power. The basic cell length was 0.24 micro meters, the entire pulse time width Wt was set to 50 of the half or 60 which divided time width Lt of the basic cell length into 100 equally, and the ration of recording power Pf/Pb was set to 1/2. Also, this experiment was performed using the stage waveform of FIG. 4.

As can be seen in FIG. 14, the SDR value showed good value between 0.3 and 0.8 of Wb/Wt. Especially, the SDR value showed lower value between 0.4 and 0.8 of Wb/Wt, and the recording power fell as the value became large. That is, the recording sensitivity rose.

In addition, even when Y₂O₃ layer, In₂O₃ layer were used instead of the Bi₂O₃ layer of the optical recording medium used in the above-mentioned experiment, the same result as the above was obtained.

Also, the same result was obtained when Bi₂O₃ layer containing one or more elements M chosen from the group consisting of Al, Cr, Mn, Sc, In, Ru, Rh, Co, Fe, Cu, Ni, Zn, Li, Si, Ge, Zr, Ti, Hf, Sn, Pb, Mo, V and Nb.

Also, its layer composition on the substrate is made reverse, 150 nm of Ag reflective layer was provided on a polycarbonate substrate (0.6 mm thickness) having an guiding groove (50 nm of depth) using sputtering. Then, on the above, the thin film (average thickness is about 30 nm) of the organic material consisting of the coloring pigment shown above chemical structure was formed with the spin coating method, and then 12 nm of Bi₂O₃ thin layer and 65 nm of ZnS—SiO₂ thin layer were provided in order on the above using sputtering, then the cover layer with a thickness of 0.08 mm was stuck with a double-sided adhesion sheet with a thickness of 0.02 mm, thereby the recordable type optical recording medium of the invention was fabricated.

For the optical recording medium, recording was performed from the side of the cover layer using optical disc evaluation equipment DDU-1000 (wavelength: 405 nm, NA: 0.65) of Pulstec Industry Inc. Even if the compositional order of the substrate changed and the laser having large value of NA was used, the effect of the invention was acquired similarly. Also, in the same multilevel recording as the embodiment, in the medium of the feature by which track pitch of guiding groove is between 0.25 and 0.5 micro meters, depth is between 15 and 150 nm, average groove width is between 0.15 and 0.35 micro meters and reflectance in the state of non-recorded is between 2 and 50%, the effect of this invention was acquired similarly.

### SECOND EMBODIMENT

20 nm of Bi₂O₃ thin layer, 65 nm of ZnS—SiO₂ thin layer and 150 nm of Ag reflective layer were provided in order on a polycarbonate substrate (0.6 mm thickness) having an guiding groove (26 nm of depth) using sputtering. Then, about 5 micro meter of protection layer consisting of ultraviolet ray hardening type resin (SD1700, Dainihon ink chemical industry inc.) was provided on the above with the spin coating method, thereby the recordable type optical recording medium was fabricated.

For the above optical recording medium, multilevel recording was performed. In this case, 8 values (level 0 to level 7) were performed. In the implementation, optical disc evaluation equipment DDU-1000 (wavelength: 405 nm, NA: 0.65, central intensity of laser (1/e² of beam diameter): setup of recording strategy using about 0.55 micro meter (luminescence waveform control of the laser light at the time of recording)) of Pulstec Industry Inc. was operated using AWG-610 of Sony techtronics, Inc, with basic cell length (record unit of record mark): 0.24 micro meter, time width of basic cell length: 48 ns, clock frequency: 2.5 GHz, recording and reproduction line speed: 5.0 m/s. The reproduction power was 0.5 mW, as explained below, the regular introductory power (Pr+Pbi) was set at 1.5 mw. The ratio of 1/e² of beam diameter of central intensity of laser (laser beam diameter) D and the basic cell length of recording mark for multilevel L is a range of 1<D/L.

First of all, in the record waveform shown in FIGS. 1-3, the steps wave strategy as shown in FIG. 4 estimated the medium so that it might specify which waveform is good. Each record waveform of the invention is made on the regular introductory power (Pr+Pbi).

A steps waveform was recorded using the strategy of FIGS. 1-3, and the result which investigated power dependability is shown in FIG. 19. Here, the ratio of pulse width, Wb/Wf is 1/1, the power ratio, Wb/Wf is 1/2, 2/1, 1/1, respectively, and the entire pulse time width Wt of the maximum level mark was 50. The entire pulse time width of the maximum level mark divides the basic cell length into 100 equally, and is the setting time value of the entire pulse time width of the level 7 of them. The reproduction power was 0.5 mW, the bias power was set to 1.0 mW.

Comparing these ratios, sensitivity is good in order of FIG. 3, FIG. 2, and FIG. 1, it is found that the rectangular wave strategy is more highly sensitive than two step wave strategy. However, when the recording power Wb of the latter half is large like the strategy of FIG. 2, the best SDR value (low value) was indicated. In the case of the strategy of FIG. 2, like the strategy of FIG. 1, it was more highly sensitive than the case where the recording power of the former half is large, and the SDR value was also low.

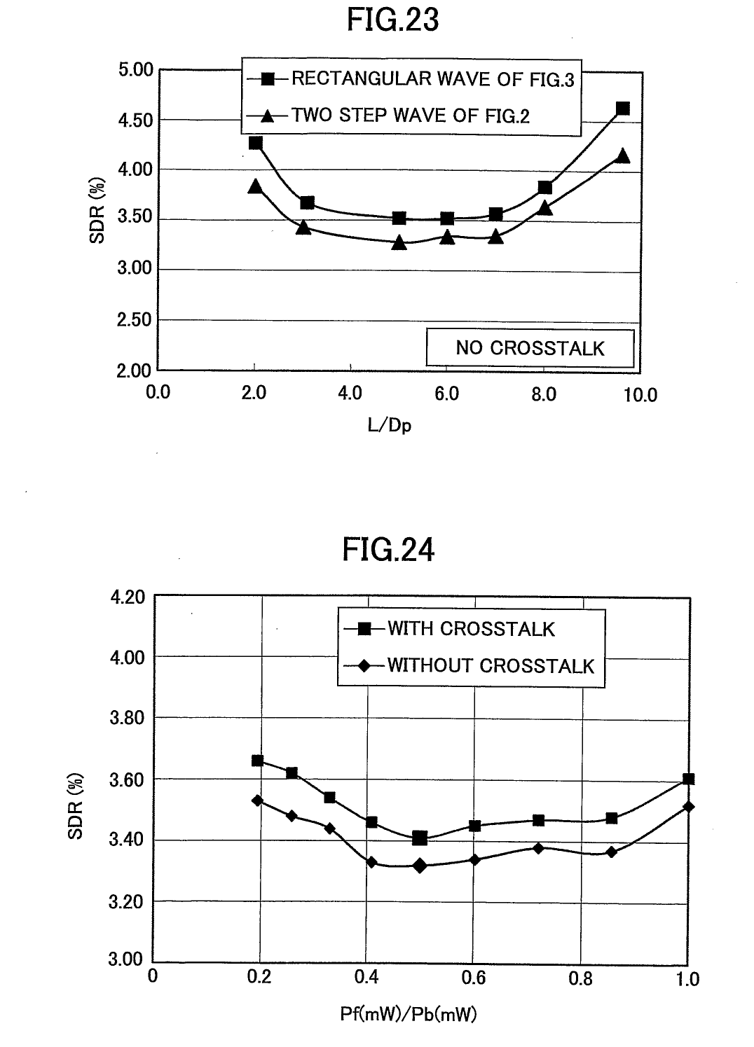

The effect which introduced bias power is shown in FIG. 20. The recording power (mW) from which, as for the number in a figure, the optimal SDR value for every bias power was acquired was shown, and the recording was performed by the steps wave.

According to FIG. 20, even when the entire pulse time width of the maximum level mark is any of 50 and 60, by introducing the bias power, it shows that the power which shows the optimal SDR value falls and the sensitivity is improved for the medium of the invention. It is found that the SDR value at that time is equivalent, or falls.

As for bias power, it is desirable to introduce large power 0.25 mW or more than 0.25 mW than reproduction power, preferably 0.5 mW or more than 0.5 mW, more preferably from 1.0 mW to 2.0 mW. In other words, preferably, the ratio of the reproduction power (Pr) and the bias power (Pbi), Pbi/Pr is 1 or more than 1, more preferably, the ration is between 2 and 4. If the Pbi/Pr exceeds 4, the reflectance change arises on the level 0 and the SDR value deteriorates extremely. However, this value is a numerical value in this embodiment to the utmost, especially, the maximum value is influenced by the laser wavelength of recording and reproduction, the recording and reproduction speed, the reflectance, the sensitivity of a medium, etc. However, when the Pbi/Pr is 0.5 or more at least, there is an effect clear irrespective of conditions.

FIG. 21 shows a relationship between the ratio (Wt/Lt) of the entire pulse time width (Wt) of the maximum level mark and the time width of basic cell length (Lt) at random record for recording with rectangular wave of FIG. 3, two stage waves of FIG. 2, and The SDR value. The bias power introduced the value larger 1.0 mW than reproduction power.

As can be seen from FIG. 21, when it is 30 to 80 which divided into 100 equally the time width, Lt of the basic cell length whose entire pulse time width, Wt of the maximum level mark is 0.24 micrometers, that is, both of the strategies showed the good SDR value in the range from 0.3 to 0.8. More preferable range is between 0.35 and 0.7.

Also, in various kinds of factors, the relation between average groove width, Wg of the guiding groove and the basic cell length, L is very important in order to raise the characteristic of multilevel recording.

FIG. 22 shows a relationship between the ratio (Wg/L) of the average groove width Wg of the guiding groove and the basic cell length (L) at random record for recording with rectangular wave of FIG. 3 and two stage waves of FIG. 2, and The SDR value. The bias power was larger than the reproduction power 1.0 mW. The basic cell length was fixed at 0.24 micro meter and the average groove width Wg of the guiding groove was varied (changed) between 0.5 and 1.8 micro meters.

As can be seen in FIG. 22, the SDR showed good value between 0.7 and 1.5, but out of the range, the value deteriorated rapidly.

Similarly, the relation between depth, Dp of the guiding groove and the basic cell length, L is very important for various factors in order to raise the characteristic of multilevel recording.

FIG. 23 shows a relationship between the ratio (L/Dp) of the basic cell length (L) and the depth of the guiding groove (Dp) at random record for recording with rectangular wave of FIG. 3 and two stage waves of FIG. 2, and The SDR value. The bias power was larger than the reproduction power 1.0 mW. The basic cell length was fixed at 0.24 micro meter and the depth Dp of the guiding groove was varied between 25 and 120 micro meters.

As can be seen in FIG. 23, the SDR showed good value between 3 and 8 of L/Dp, but out of the range, the value deteriorated rapidly. Preferably, L/Dp is between 4 and 7.

FIG. 24 shows a relationship between the ratio (Pf/Pb) of the recording power Pf and Pb at random record for recording with two stage waves of FIG. 2, and The SDR value. The bias power was larger than the reproduction power 1.0 mW. The basic cell length was 0.24 micro meters, the entire pulse time width Wt of the maximum level mark was set to 50 of the half which divided time width Lt of the basic cell length into 100 equally, and the ration of pulse width Wb/Wf was set to 1/1.

As can be seen in FIG. 24, the SDR value showed good value between 0.3 and 1 of Pf/Pb. Especially, the SDR value showed lower value between 0.4 and 0.9 of Pf/Pb, and the recording power fell as the value became large. That is, the recording sensitivity rose.

FIG. 25 shows a relationship between the ratio (Wb/Lt) of the pulse time width Wb of the maximum level mark and the entire pulse time width (Wt) at random record for recording with two stage waves of FIG. 2, and The SDR value. The bias power was made larger 1.0 mW than the reproduction power. The basic cell length was 0.24 micro meters, the entire pulse time width Wt was set to 50 of the half or 60 which divided time width Lt of the basic cell length into 100 equally, and the ration of the recording power Pf/Pb was set to 1/2. Also, this experiment was performed using the stage waveform of FIG. 4.

As can be seen in FIG. 25, the SDR value showed good value between 0.3 and 0.8 of Wb/Wt. Especially, the SDR value showed lower value between 0.4 and 0.8 of Wb/Wt, and the recording power fell as the value became large. That is, the recording sensitivity rose.

In addition, even when Y₂O₃ layer, In₂O₃ layer were used instead of the Bi₂O₃ layer of the optical recording medium used in the above-mentioned experiment, the same result as the above was obtained.

Also, the same result was obtained when Bi₂O₃ layer containing one or more elements M chosen from the group consisting of Al, Cr, Mn, Sc, In, Ru, Rh, Co, Fe, Cu, Ni, Zn, Li, Si, Ge, Zr, Ti, Hf, Sn, Pb, Mo, V and Nb.

Also, its layer composition on the substrate is made reverse, 150 nm of Ag reflective layer, 65 nm of ZnS—SiO₂ thin layer and 12 nm of Bi₂O₃ thin layer were provided in order on a polycarbonate substrate (0.6 mm thickness) having an guiding groove (26 nm of depth) using sputtering. Then, the cover layer with a thickness of 0.08 mm was stuck with a double-sided adhesion sheet with a thickness of 0.02 mm, thereby the recordable type optical recording medium of the invention was fabricated.

For the optical recording medium, the recording was performed from the side of the cover layer using optical disc evaluation equipment DDU-1000 (wavelength: 405 nm, NA: 0.65) of Pulstec Industry Inc. Even if the composition order of the substrate changed and the laser having large value of NA was used, the effect of the invention was acquired similarly. Also, in the same multilevel recording as the embodiment, in the medium of the feature by which track pitch of the guiding groove is between 0.25 and 0.5 micro meters, the depth is between 15 and 150 nm, the average groove width is between 0.15 and 0.35 micro meters and the reflectance in the state of non-recorded is between 2 and 50%, the effect of this invention was acquired similarly.

### THIRD EMBODIMENT

### The Embodiment which Applied the Strategy of the Invention to Other Medium

Phthalocyanine Media

Phthalocyanine shown below chemical structure 2 was covered on a polycarbonate substrate (0.6 mm thickness) having an guiding groove (26 nm of depth) using the spin-coating. In addition, the spin-coating was performed using the solution, in which the coloring pigment was dissolved and prepared in the mixed solvent of the following composition.

| Solvent | Weight % |
|---|---|
| Methanol | 23% |
| Ethanol | 55% |
| 2-Propanol | 22% |

### All absorption degree of light of coloring pigments in the wavelength of 405 nm were set to 0.65.

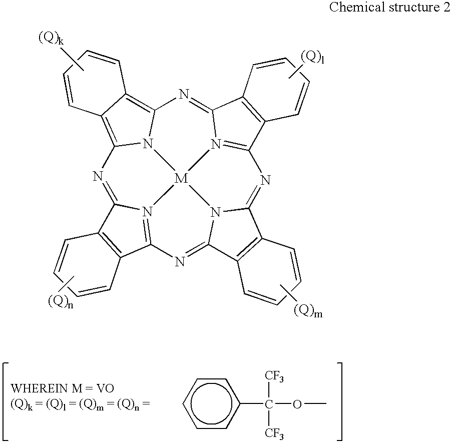

Thus, 100 micro meters of Ag reflective layer was formed on the recording layer consisting of Phthalocyanine formed as above, then about 5 micro meter of a protection layer consisting of ultraviolet ray hardening type resin (SD1700, Dainihon ink chemical industry inc.) was provided on the above with the spin coating method,

TeO Media

65 nm of ZnS—SiO₂ thin layer, 20 nm of TeO₂ thin layer, 65 nm of ZnS—SiO₂ thin layer and 150 nm of Ag reflective layer were provided in order on a polycarbonate substrate (0.6 mm thickness) having an guiding groove (26 nm of depth) using sputtering. Then, on the above, then about 5 micro meter of the protection layer consisting of ultraviolet ray hardening type resin (SD1700, Dainihon ink chemical industry inc.) was provided with the spin coating method, thereby the recordable type optical recording medium was fabricated.

Like the embodiment 2, the recording was performed on two kinds of above-mentioned optical recording medium.

A steps waveform was recorded using the strategy of FIGS. 1-3, and the result which investigated power dependability is shown in FIGS. 28 and 29. FIG. 28 is a graph for phthalocyanine media, and FIG. 29 is a graph for TeO media. Here, the ratio of pulse width, Wb/Wf is 1/1, the power ratio, Wb/Wf is 1/2, 2/1, 1/1, respectively, and the entire pulse time width of the maximum level mark was 50. The entire pulse time width of the maximum level mark divides the basic cell length into 100 equally, and is the setting time value of the entire pulse time width of the level 7 of them. The reproduction power was 0.5 mW, the bias power was made larger 1.0 mW than reproduction power.

Based on FIGS. 28 and 29, the sensitivity is good in order of FIG. 3, FIG. 2, and FIG. 1, it is found that the rectangular wave strategy is more highly sensitive than two step wave strategy. However, when the recording power Wb of the latter half is large like the strategy of FIG. 2, the best SDR value (low value) was indicated. In the case of the strategy of FIG. 2, like the strategy of FIG. 1, it was more highly sensitive than the case where the recording power of the former half is large, and the SDR value was also low. That is, also in these medium, the effect of the recording method of the invention was acquired with the same tendency.

The effect which introduced bias power is shown in FIG. 30. The recording power (mW) from which, as for the number in the figure, the optimal SDR value for every bias power was acquired was shown, and the recording was performed by the steps wave.

According to FIG. 30, by introducing the bias power, it shows that the power which shows the optimal SDR value falls and the sensitivity is improved for the either medium of the invention. It is found that the SDR value at that time is equivalent, or falls.

As for bias power, it is desirable to introduce large power 0.2 mW or more than 0.2 mW than the reproduction power, preferably 0.5 mW or more than 0.5 mW, more preferably from 0.8 mW to 2.0 mW. In other words, preferably, the ratio of the reproduction power (Pr) and the bias power (Pbi), Pbi/Pr is 1 or more than 1, more preferably, the ration is between 2 and 4. If the large bias power was introduced, in which the Pbi/Pr exceeds 4, the reflectance change arises on the level 0 and the SDR value deteriorates extremely. However, this value is a numerical value in this embodiment to the utmost, especially, the maximum value is influenced by the laser wavelength of recording and reproduction, the recording and reproduction speed, the reflectance, the sensitivity of a medium, etc. However, when the Pbi/Pr is 0.5 or more at least, there is an effect clear irrespective of conditions.

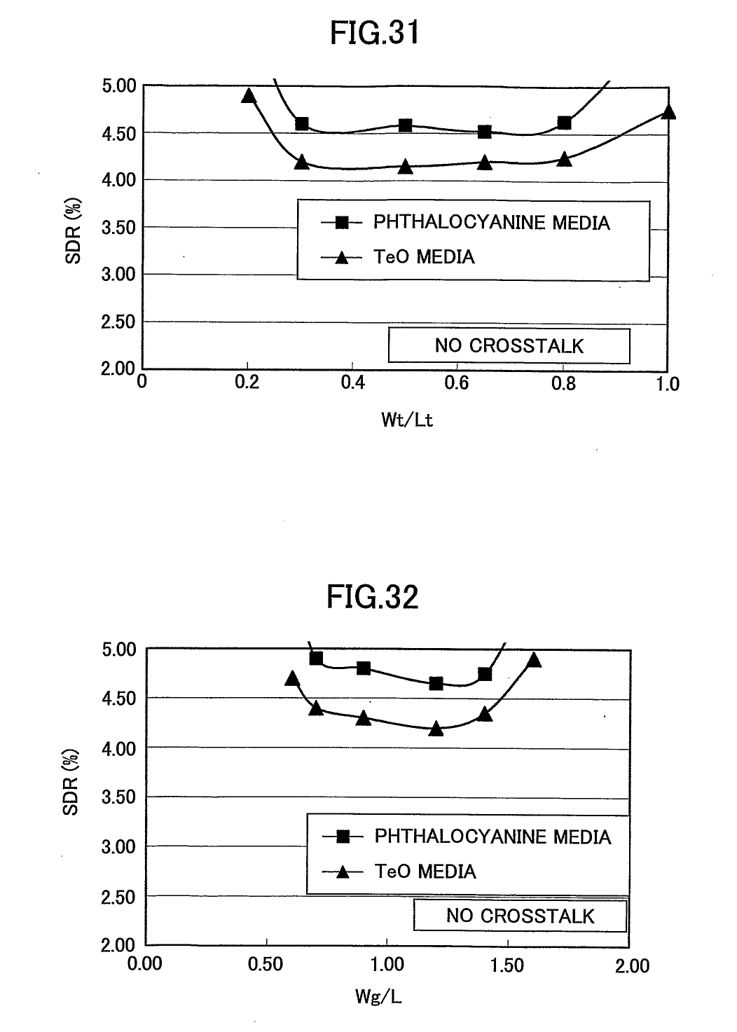

FIG. 31 shows a relationship between the ratio (Wt/Lt) of the entire pulse time width (Wt) of the maximum level mark and the time width of the basic cell length (Lt) at random record for recording with two stage waves of FIG. 2, and The SDR value. The bias power introduced the value larger 1.0 mW than reproduction power.

As can be seen from FIG. 31, when it is 30 to 80 which divided into 100 equally the time width, Lt of the basic cell length whose entire pulse time width, Wt of the maximum level mark is 0.24 micrometers, that is, both of the medium showed the good SDR value in the range from 0.3 to 0.8. More preferable range is between 0.35 and 0.7.

Also, in various kinds of factors, the relation between average groove width, Wg of the guiding groove and the basic cell length, L is very important in order to raise the characteristic of multilevel recording.

FIG. 32 shows a relationship between the ratio (Wg/L) of the average groove width Wg of the guiding groove and the basic cell length (L) at random record for recording with rectangular wave of FIG. 3 and two stage waves of FIG. 2, and The SDR value. The bias power was larger than the reproduction power 1.0 mW. The basic cell length was fixed at 0.24 micro meter and the average groove width Wg of the guiding groove was varied between 0.15 and 0.38 micro meters.

As can be seen in FIG. 32, the SDR showed good value between 0.7 and 1.5, but out of the range, the value deteriorated rapidly.

Similarly, the relation between depth, Dp of the guiding groove and the basic cell length, L is very important for various factors in order to raise the characteristic of multilevel recording.

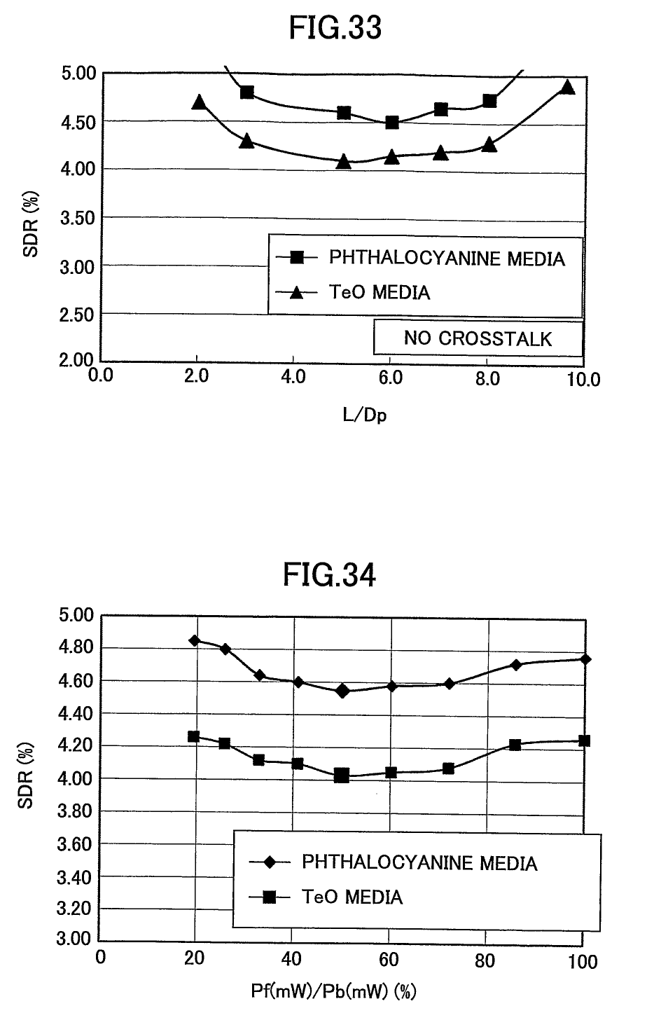

FIG. 33 shows a relationship between the ratio (L/Dp) of the basic cell length (L) and the depth of guiding groove (Dp) at random record for recording with rectangular wave of FIG. 3 and two stage waves of FIG. 2, and The SDR value. The bias power was larger than the reproduction power 1.0 mW. The basic cell length was fixed at 0.24 micro meter and depth Dp of the guiding groove was varied between 25 and 120 micro meters.

As can be seen in FIG. 33, the SDR showed good value between 3 and 8 of L/Dp for both medium, but out of the range, the value deteriorated rapidly. Preferably, L/Dp is between 4 and 7.

FIG. 34 shows a relationship between the ratio (Pf/Pb) of the recording power Pf and Pb at random record for recording with two stage waves of FIG. 2, and The SDR value. The bias power was larger than the reproduction power 1.0 mW. Without crosstalk, the basic cell length was 0.24 micro meters, the entire pulse time width Wt of the maximum level mark was set to 50 of the half which divided time width Lt of the basic cell length into 100 equally, and the ration of pulse width Wb/Wf was set to 1/1.

As can be seen in FIG. 34, the SDR value showed good value between 0.3 and 1 of Pf/Pb for both of medium. Especially, the SDR value showed lower value between 0.4 and 0.9 of Pf/Pb, and the recording power fell as the value became large. That is, the recording sensitivity rose.

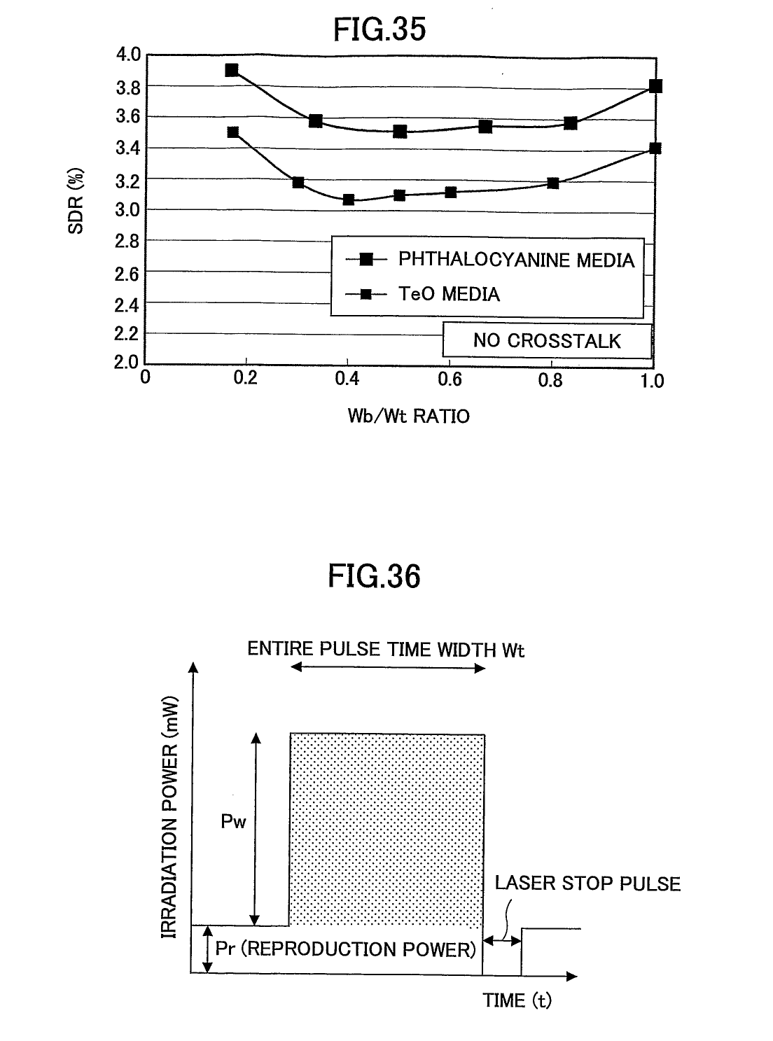

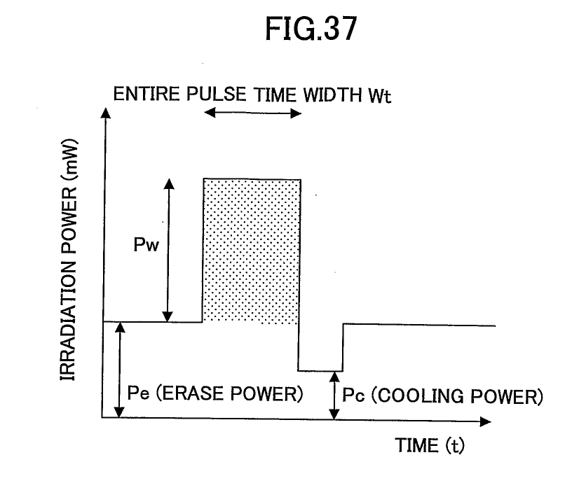

FIG. 35 shows a relationship between the ratio (Wb/Lt) of the pulse time width Wb of the maximum level mark and the entire pulse time width (Wt) at random record for recording with two stage waves of FIG. 2, and The SDR value. The bias power was made larger 1.0 mW than the reproduction power. The basic cell length was 0.24 micro meters, the entire pulse time width Wt was set to 50 of the half which divided the time width Lt of the basic cell length into 100 equally, and the ratio of the recording power Pf/Pb was set to 1/2. Also, this experiment was performed using the stage waveform of FIG. 4.

As can be seen in FIG. 35, the SDR value showed good value between 0.3 and 0.8 of Wb/Wt for both of medium. Especially, the SDR value showed lower value between 0.4 and 0.7 of Wb/Wt, and the recording power fell as the value became large. That is, the recording sensitivity rose.

As mentioned above, even when the recording method of the invention was applied to medium other than target medium of inventions 11 to 18, the effect was large and showed the effect with same tendency.

Also, in the same multilevel recording as the embodiment, in the medium of the feature by which track pitch of the guiding groove is between 0.25 and 0.5 micro meters, the depth is between 15 and 150 nm, the average groove width is between 0.15 and 0.35 micro meters and the reflectance in the state of non-recorded is between 2 and 50%, the effect of this invention was acquired similarly.

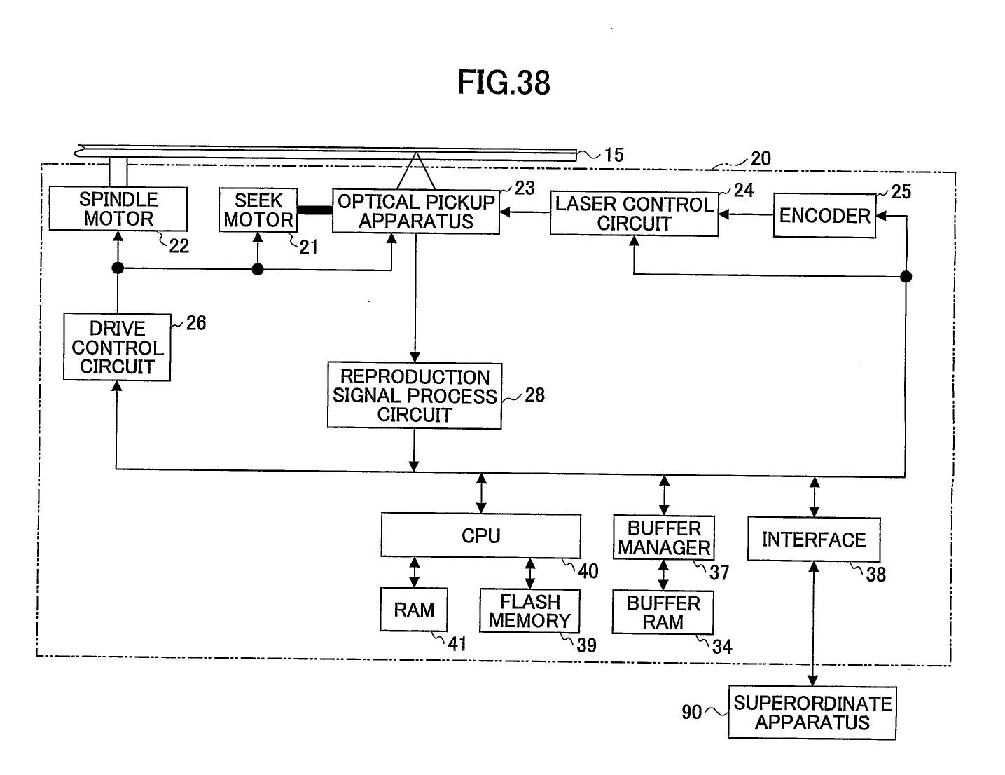

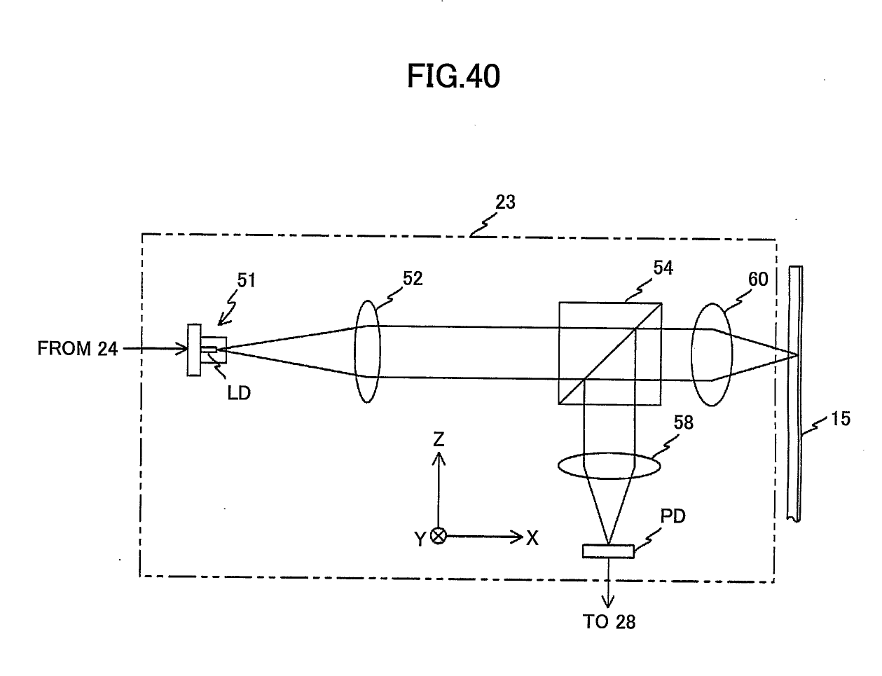

According to another aspect of the present invention, another embodiment of the present invention is described with reference to FIGS. 38-45. FIG. 38 shows an overall configuration of an optical disk apparatus 20 according to an embodiment of the present invention. The optical disk apparatus 20 includes, for example, a spindle motor 22 for driving the rotation of an optical disk 15, an optical pickup apparatus 23, a seek motor 21 for driving the optical pickup apparatus toward a sledge direction, a laser control circuit 24, an encoder 25, a drive control circuit 26, a reproduction signal process circuit 28, a buffer RAM 34, a buffer manager 37, an interface 38, a flash memory 39, a CPU 40, and a RAM 41. It is to be noted that the arrows illustrated in FIG. 38 indicate the flow of representative signals and information and do not indicate all of the connections for each of the illustrated blocks. Furthermore, the optical disk apparatus 20 is applicable to a multilevel recording type (multilevel recording method) and the data (information) used for recording are subject to a multilevel process, for example, eight levels (0-7). Furthermore, an information recording medium corresponding to a wavelength of approximately 405 nm, for example, is employed as the optical disk 15 according to the embodiment of the present invention.

In the multilevel recording method, a track is, virtually, divided into multiple areas (cells), in which each area (cell) has a predetermined length (referred to as length S in this example) in the direction of a tangential line of the track, as exemplified in FIG. 2. A single unit (value) of multilevel data is stored in a single cell. In a case where the value of the multilevel data is 1-7, a recording mark is formed in a center part of the cell, in which each recording mark has an area corresponding to the value of the multilevel data. It is to be noted that no mark is formed in the cell when the value of the multilevel data is 0.

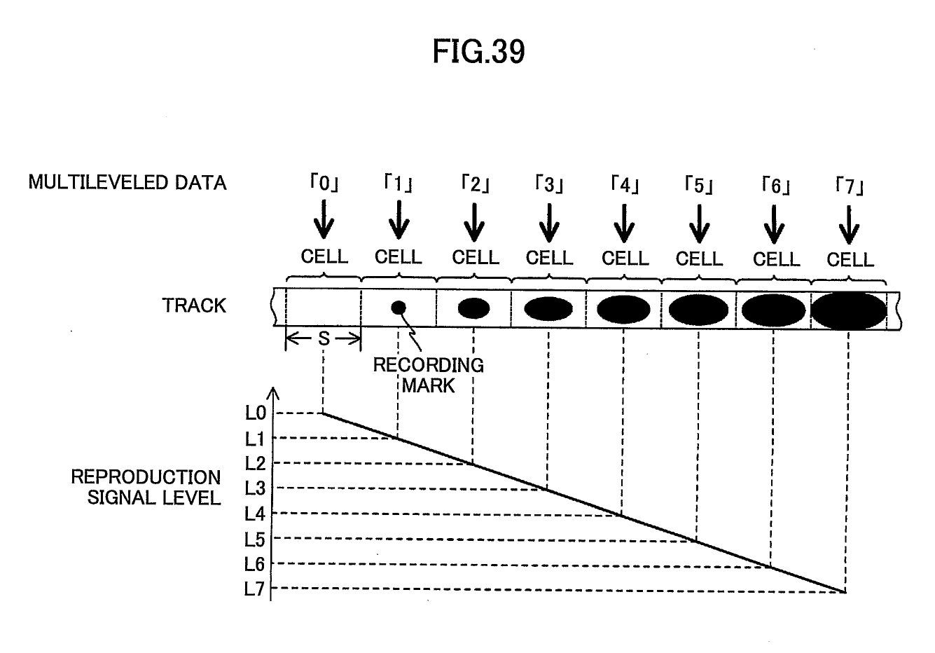

Since reflectivity decreases as the area of the recording mark part becomes larger, a reproduction signal (RF signal), which is generated from the reflection of laser light from the recording surface of the optical disk 15, is at a highest level (L0) when the value of the multilevel data is 0, as shown in FIG. 39. Furthermore, the reproduction signal is at a lowest level (L7) when the value of the multilevel data is 7. It is to be noted that the levels of the reproduction signals are L1-L6 when the values of the multilevel data are 1-6, respectively.

Meanwhile, in the multilevel type recording method, an index SDR for evaluating recording quality is calculated in accordance with the below given formula (1).

SDR=(σm₀+σm₁+ . . . +σm_{α-1}+σm_{α})/((1+α)·|R₀−R_{α}|) (1)

Here, the information is converted to combinations of (α+1) types of levels (m₀, m₁, . . . , m_{α-1}, m_{α}). Furthermore, m₀, m₁, . . . , m_{α-1}, m_{α} represent the standard deviation of the reproduction signal levels (R0, R1, . . . , R_{α-1}, R_{α}) of corresponding multilevel data m₀, m₁, . . . , m_{α-1}, m_{α}.

The optical pickup apparatus 23 is configured to irradiate a laser beam on spiral or concentric tracks formed on the recording surface of the optical disk 15 rotated by the spindle motor 22 and to receive the light reflected from the recording surface of the optical disk 15. As shown in FIG. 3, the optical pickup apparatus 23 includes, for example, a light source unit 51, a collimator lens 52, a beam splitter 54, an objective lens 60, a detection lens 58, a photodetector PD, and a drive unit (a focusing actuator, tracking actuator, not shown).

The light source unit 51 includes a semiconductor laser LD as a light source for emitting a laser beam with a wavelength of approximately 405 nm. It is to be noted that the maximum strength light beam of the laser irradiated from the light source unit 51 is directed toward direction +X direction. The collimator lens 52, which is disposed toward the +X direction of the light source unit 51, collimates the laser beam irradiated from the light source unit 51 to a substantially parallel light.

The beam splitter 54, which is disposed toward the +X direction of the collimator lens 52, deflects the light beam (returning light beam) reflected from the optical disk 15 to the −Z direction. The objective lens 60, which is disposed toward the +X direction of the beam splitter 54, condenses light beam transmitted through the beam splitter 54 to the recording surface of the optical disk 15.

The detection lens 58, which is disposed toward the −Z direction of the beam splitter, condenses the split light beam (returning light beam) to a light receiving surface of the photodetector PD. The photodetector PD, as in a typical optical disk apparatus, includes multiple light receiving elements (photodetector elements) for outputting signals including, for example, wobble signal information, reproduction data information, focus error information, and tracking error information.

The focusing actuator (not shown) is an actuator for minutely driving the objective lens 60 in a focusing direction (direction of optical axis of the objective lens 60). The tracking actuator (not shown) is an actuator for minutely driving the objective lens 60 in a tracking direction (direction perpendicular to the tangential direction of the track).

Next, the process of the optical pickup apparatus 23 is briefly described. First a light beam emitted from the light source unit 51 is collimated to a substantially parallel light by the collimator lens 52. Then, the collimated light beam becomes incident to the beam splitter 54. Then, the light beam transmitted through the beam splitter 54 is condensed to a fine spot on the recording surface of the optical disk 15 via the objective lens 60. Then, the light beam reflected from the recording surface of the optical disk 15 becomes a substantially parallel light at the objective lens 60, and is incident to the beam splitter 54. After the returning beam is deflected to the −Z direction by the beam splitter 54, the returning lens 58 is received at the photodetector PD via the detection lens 58. The photodetector PD generates current signals by executing photoelectric conversion in correspondence with the received amount of light. The generated current signals are output to the reproduction signal process circuit 28.

According to the signals output from the photodetector PD, the reproduction signal process circuit 28 obtains signals such as servo signals (e.g. focus error signals, tracking error signals), address information, synchronizing signals, and RF signals. With reference to FIG. 38, the obtained servo signals are output to the drive control circuit 26, the address information is output to the CPU 40, and the synchronizing signals are output to the encoder 25. Furthermore, the reproduction signal process circuit 28 performs processes such as a decoding process and/or an error detection process on the RF signals. The reproduction signal process circuit 28 stores the RF signals (in a case where an error is detected, after correcting the error) in the buffer RAM 34 via the buffer manager 37.

In accordance with the track error output from the reproduction signal process circuit 28, the drive control circuit 26 generates drive signals for driving the tracking actuator, to thereby correct the positional deviation of the objective lens in the tracking direction. In accordance with the focus error signals output from the reproduction signal process circuit 28, the drive control circuit 26 generates drive signals for driving the focusing actuator, to thereby correct the positional deviation of the objective lens in the focus direction. The generated drive signals are output to the optical pickup apparatus 23. The optical pickup apparatus 23 performs tracking control and focus control according to the drive signals. Furthermore, the drive control circuit 26 also generates drive signals for driving the seek motor 21 and drive signals for driving the spindle motor 22 based on the instructions of the CPU 40. The drive signals are output to the seek motor 21 and the spindle motor 22, respectively.

The buffer RAM 34 temporarily stores, for example, data to be recorded in the optical disk 15 (recording data) and data to be reproduced from the optical disk 15 (reproduction data). The data output and input to the buffer RAM 34 are managed by the buffer manager 37.

The encoder 25 retrieves the recording data stored in the buffer RAM 34. After performing processes such as data modulation and adding of error correction codes on the retrieved recording data, the encoder 25 generates write signals (signals for writing on the optical disk 15). The generated write signals are output to the laser control circuit 24.

The laser control circuit 24 controls the emission power of the semiconductor laser LD. For example, in a recording operation, the laser control circuit 24 generates drive signals for driving the semiconductor laser LD based on the above-described write signals, recording conditions, and emission characteristics of the semiconductor laser LD.

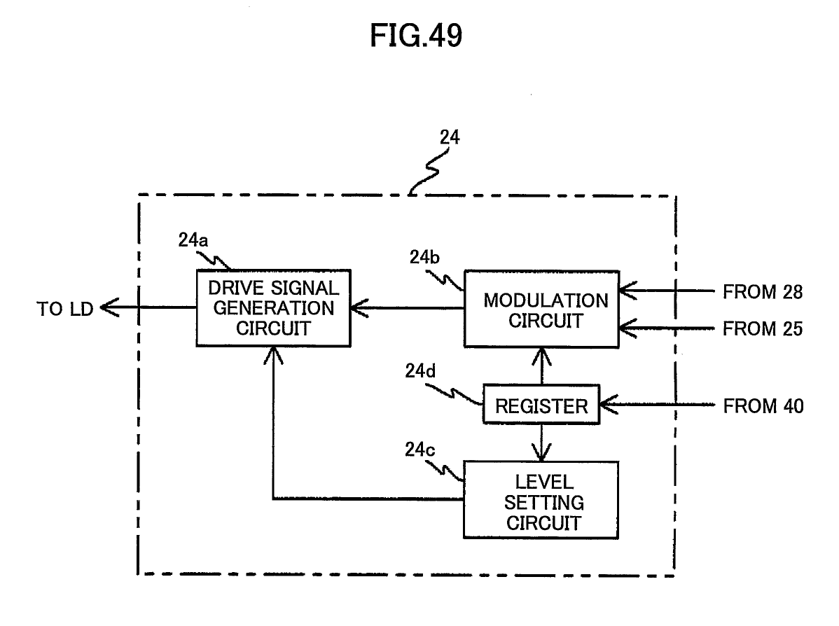

In one example shown in FIG. 49, the laser control circuit 24 may include a drive signal generation circuit 24a, a modulation circuit 24b, a level setting circuit 24c, and a register 24d.

The register 24d is loaded with recording strategy information including power information regarding recording power and reproduction power for the optical disk 15 and information regarding a preheating pulse (described below).

The modulation circuit 24b generates modulation signals based on the recording strategy information stored in the register 24d, write signals from the encoder 25, and synchronization signals from the reproduction signal process circuit 28. The generated modulation signals are output to the drive signal generation circuit 24a.

The level setting circuit 24c generates level signals based on the power information stored in the register 24d for setting the signal levels of the above-described modulation signals. The generated level signals are output to the drive signal generation circuit 24a.

The drive signal generation circuit 24a generates drive signals for driving the semiconductor laser LD based on the signals output from the modulation circuit 24b (modulation signals) and the signals output from the level setting circuit 24c (level signals). The generated drive signals are output to the semiconductor laser LD. It is to be noted that further details of the generated drive signals are described below.

The interface 38 is a communication interface for communicating with a superordinate apparatus 90 (e.g. personal computer). The interface 38 complies with standard interfaces such as ATAPI (AT Attachment Packet Interface), SCSI (Small Computer System Interface), and USB (Universal Serial Bus).

The flash memory 39 is configured having a program space and a data space. The program space of the flash memory 39 is loaded with, for example, a program that is written with a code decodable by the CPU 40. The data space of the flash memory 39 is loaded with, for example, recording conditions such as emission characteristics of the semiconductor laser LD, recording power, and/or recording strategies. The recording conditions including the power information and the recording strategies may be obtained according to, for example, test results, simulation results, theoretical calculation, and experience in correspondence with each type of optical disk (e.g. manufacturer name, lot) and/or each recording speed.

In accordance with the program(s) stored in the program space of the flash memory 39, the CPU 40 controls the above-described components/parts and also stores data required for the control in the RAM 41 and the buffer RAM 34. For example, when the optical disk 15 is loaded (mounted), the CPU 40 the extracts the power information and the recording strategy information corresponding to the type of the optical disk 15 and transfers the extracted information to the register 24d.

Next, the drive signals generated in the drive signal generation circuit 24 are described. The drive signals are pulse signals which include signals of a preheat pulse for preheating the recording layer to a temperature less than an initial mark forming temperature Tm and signals of a main pulse for heating the recording layer to a temperature no less than the initial mark forming temperature Tm. The preheat pulse includes at least one pulse having a power level which is greater than the reproduction power (Pr) for the optical disk 15 and a power level no more than 80% of the recording power (Pw). The main pulse includes at least one pulse having the power level of the recording power Pw.

A simulation is executed beforehand with respect to the preheat pulse and the main pulse. Based on the results and observations of the simulation, optimum shapes are set to the preheat pulse and the main pulse, so that recording marks corresponding to multilevel data can be accurately formed on the recording layer. Information regarding the optimum shapes of the preheat pulse and main pulse are included in the above-described recording strategy information. The simulation is described below.

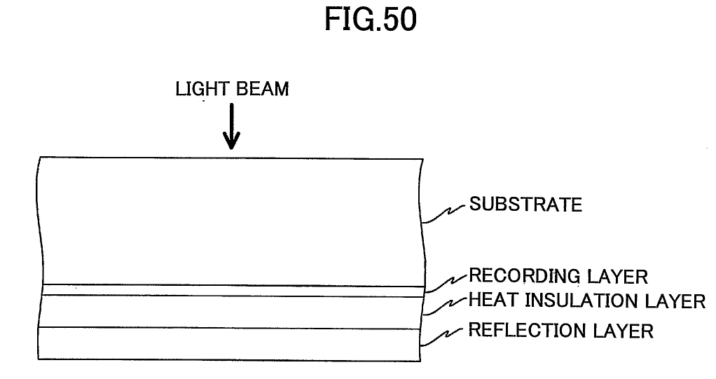

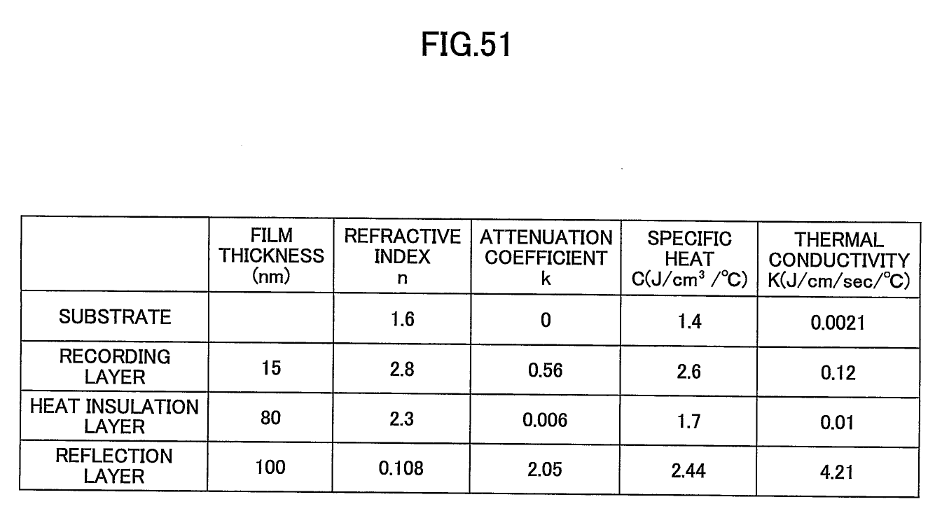

The optical disk used in the simulation (hereinafter referred to as “virtual disk” for the sake of convenience) includes a substrate, a recording layer, and a reflection layer which are provided in an order starting from the side of the incident ray as shown in FIG. 50. With reference to the table shown in FIG. 51, the substrate has a refractive index n of 1.6, an attenuation coefficient k of 0, a specific heat C of 1.4 (J/cm³/° C.), and a thermal conductivity K of 0.0021 (J/cm/sec/° C.); the recording layer has a film thickness of 15 (nm), a refractive index n of 2.8, an attenuation coefficient k of 0.56, a specific heat C of 2.6 (J/cm³/° C.), and a thermal conductivity K of 0.12 (J/cm/sec/° C.); the heat insulation layer has a film thickness of 80 (nm), a refractive index n of 2.3, an attenuation coefficient k of 0.0006, a specific heat C of 1.7 (J/cm³/° C.), and a thermal conductivity K of 0.01 (J/cm/sec/° C.); and the reflection layer has a film thickness of 100 (nm), a refractive index n of 0.108, an attenuation coefficient k of 2.05, a specific heat C of 2.44 (J/cm³/° C.), and a thermal conductivity K of 4.21 (J/cm/sec/° C.).

In the simulation, the wavelength of the laser beam irradiated to the virtual disk is 405 nm; the length of a single cell is 240 nm; the radius of an optical spot (beam spot) formed on the recording layer is 265 nm; and the temperature of the initial mark forming temperature Tm on the recording layer is 500° C.

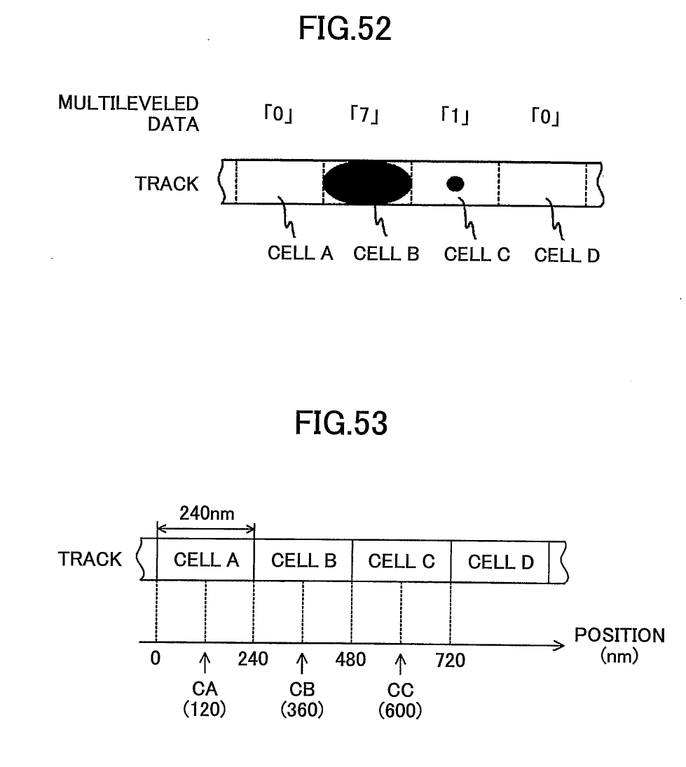

With reference to FIGS. 52-53, emission pulses are input for recording multilevel data levels of “0”, “7”, “1” and “0” to four cells (in an order of cell A, cell B, cell C, and cell D), respectively. Here, in relation with elapsing of time, changes of temperature at the interface between the recording layer and the heat insulation layer (hereinafter referred to as “recording layer temperature”) are obtained with respect to a center of cell A (referred to as “CA”, a center of cell B (referred to as “CB”), and a center of cell C (referred to as “CC”).

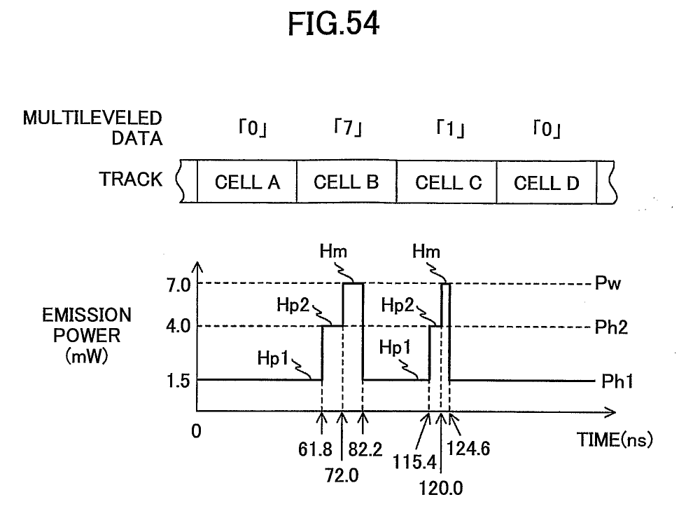

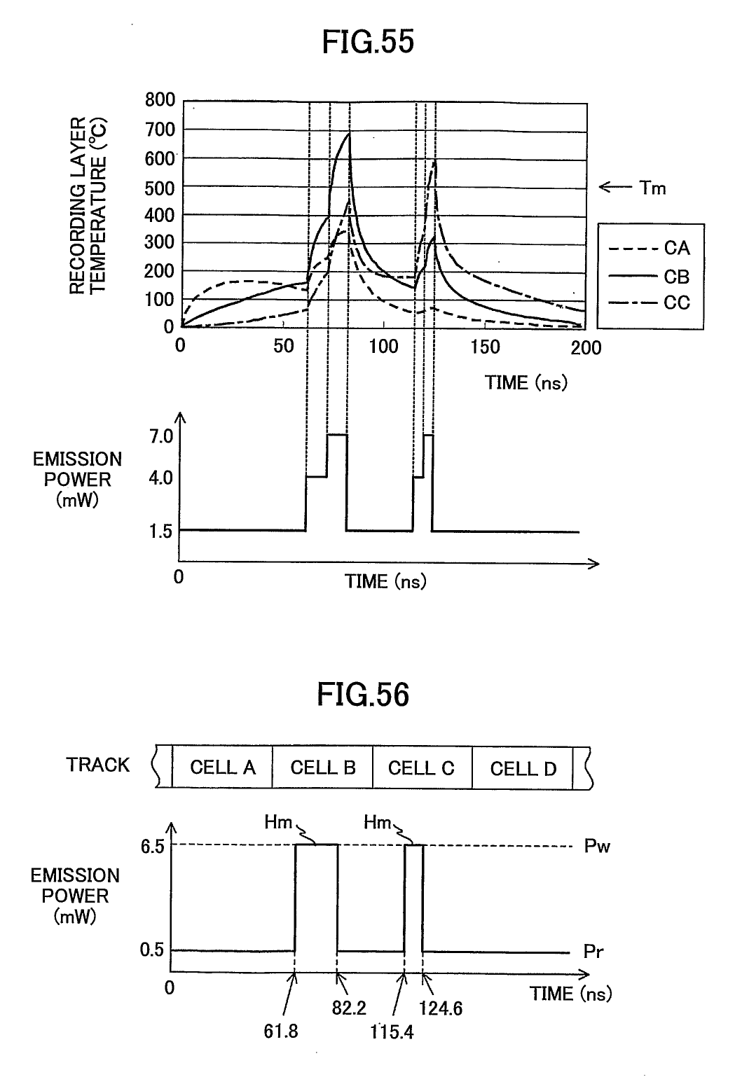

First, a single light emission pulse corresponding to a single recording mark is described in a case where the light emission pulse includes two preheat pulses (Hp1, Hp2) and one main pulse (Hm). As shown in FIG. 54, with respect to a recording mark corresponding to multileveled data “7”, a first preheat pulse Hp1 having power of 1.5 mW is irradiated for a period between 0.0 ns to 61.8 ns, then a second preheat pulse Hp2 having power of 4.0 mW is irradiated for a period between 61.8 ns to 72.0 ns, and then a main pulse Hm having power of 7.0 mW is irradiated as the recording power for a period between 72.0 ns to 82.2 ns. Furthermore, with respect to a recording mark corresponding to multileveled data “1”, a first preheat pulse Hp1 having power of 1.5 mW is irradiated for a period between 82.2 ns to 115.4 ns, then a second preheat pulse Hp2 having power of 4.0 mW is irradiated for a period between 115.4 ns to 120.0 ns, and then a main pulse Hm having power of 7.0 mW is irradiated for a period between 120.0 to 124.6. In this example, the power of the first preheat pulse Hp1 (indicated as “Ph1” in the drawings) is approximately 21% of the recording power Pw, and the second preheat pulse Hp2 (indicated as “Ph2” in the drawings) is approximately 57% of the recording power Pw. It is to be noted that the time (ns) commences from a point where the center of the optical spot reaches the beginning (top) of the cell A. The results of the exemplary simulation are shown in FIG. 55.

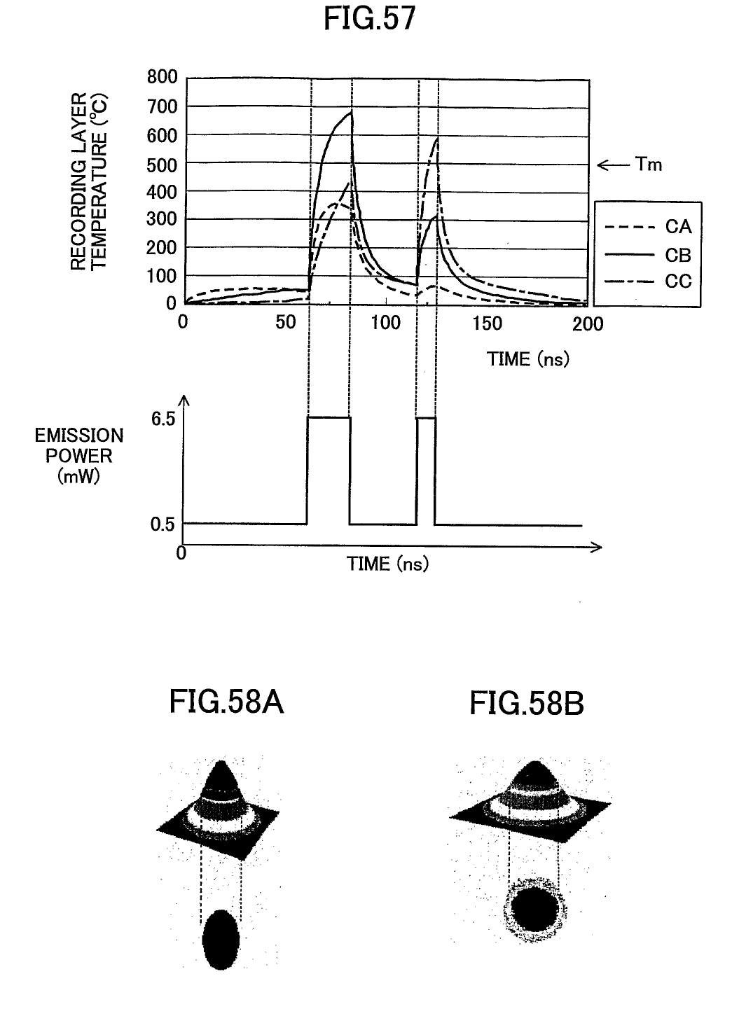

Next, for the purpose of comparison, a single light emission pulse corresponding to a single recording mark is described in a case where the light emission pulse includes only one main pulse (Hm). As shown in FIG. 56, with respect to a recording mark corresponding to multilevel data level “7”, a main pulse Hm having power of 6.5 mW is irradiated as the recording power for a period between 61.8 ns to 82.2 ns. Furthermore, with respect to a recording mark corresponding to multilevel data level “1”, a main pulse Hm having power of 6.5 mW is irradiated as the recording power for a period between 115.4 ns to 124.6 ns. Other than the main pulse, a laser beam having power of 0.5 mW is irradiated as the reproduction power Pr. The results of the comparative simulation are shown in FIG. 57.

In comparing the results shown in FIGS. 55 and 57:

(1) the recording layer temperatures for both CB and CC in FIG. 55 surpass the initial mark forming temperature Tm for a shorter period of time than those shown in FIG. 57;
(2) the recording layer temperatures for both CB and CC in FIG. 55 increase more rapidly at the proximity of the initial mark forming temperature Tm compared to those shown in FIG. 57.

This shows that providing the preheat pulse(s) enables fine-sized recording marks to be accurately formed and jitter to be effectively prevented (See FIGS. 58A and 58B). It is to be noted that FIG. 58A is an isothermal diagram of cell B in a case where the preheat pulse is provided and FIG. 58B is an isothermal diagram of cell B in a case where no preheat pulse is provided.

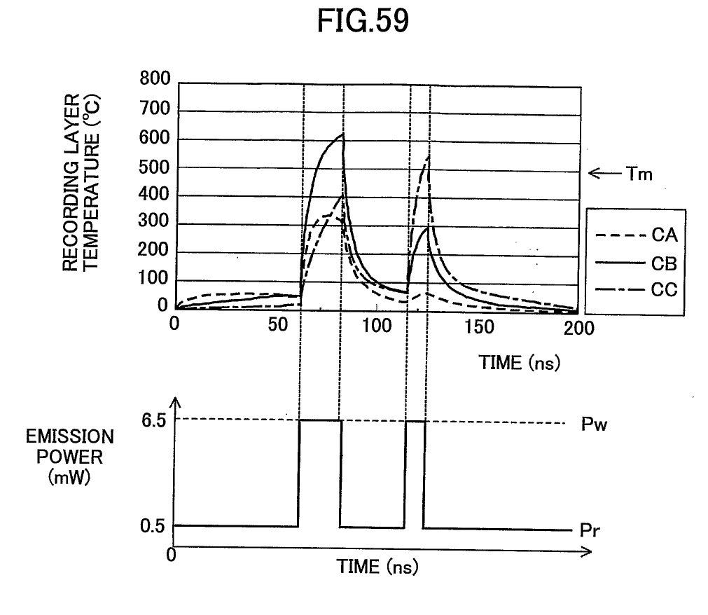

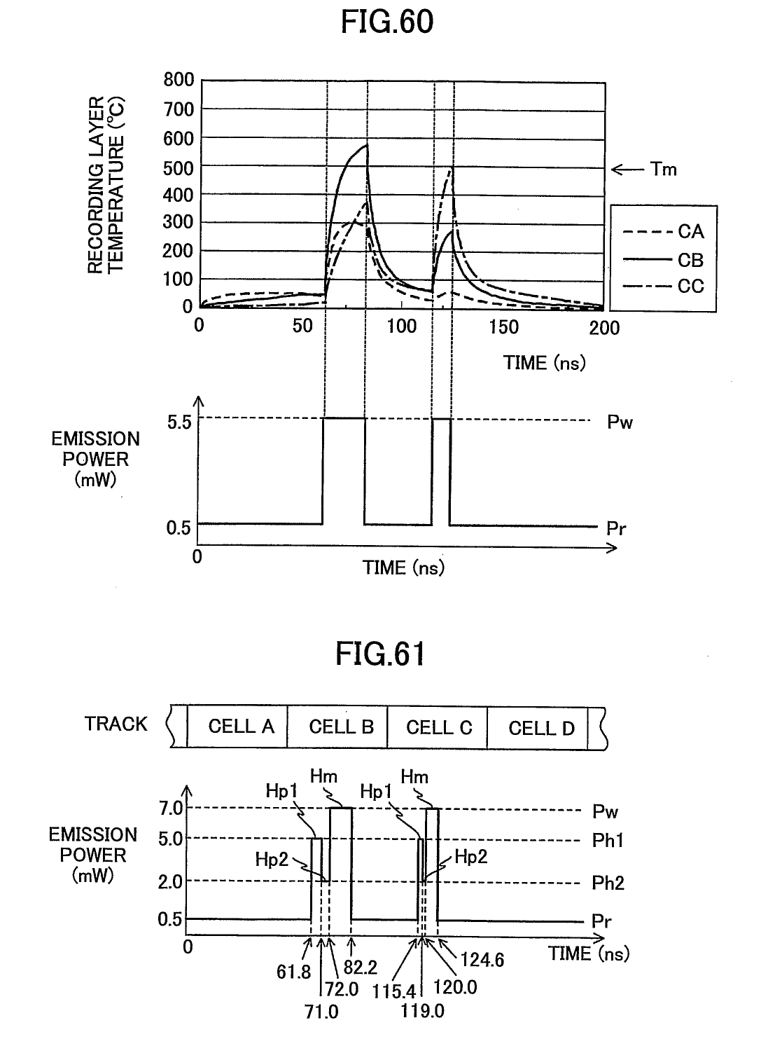

Next, further simulations are executed by reducing recording power Pw and using only the main pulse so as to make the time of the recording layer temperature of CB surpassing the initial mark forming temperature Tm substantially the same as that in the example shown in FIG. 55. FIG. 59 shows the results of one of the simulations in a case where the recording power is set to 6.0 mW, and FIG. 60 shows the results of another one of the simulations in a case where the recording power is set to 5.5 mW. Both cases demonstrated that not only the time of the recording layer temperature of CB surpassing the initial mark forming temperature Tm becomes shorter but also that of CC becomes shorter, thereby preventing multilevel data from being formed in a normal state. Furthermore, similar to the results shown in FIG. 57, there is a risk that the fluctuation in the shapes of the recording marks will increase since the temperature rise at the proximity of the initial mark forming temperature is slow. In other words, this shows that recording quality cannot be improved merely by adjustment of recording power Pw.

Next, another simulation is executed where the shape of the preheat pulse is changed.

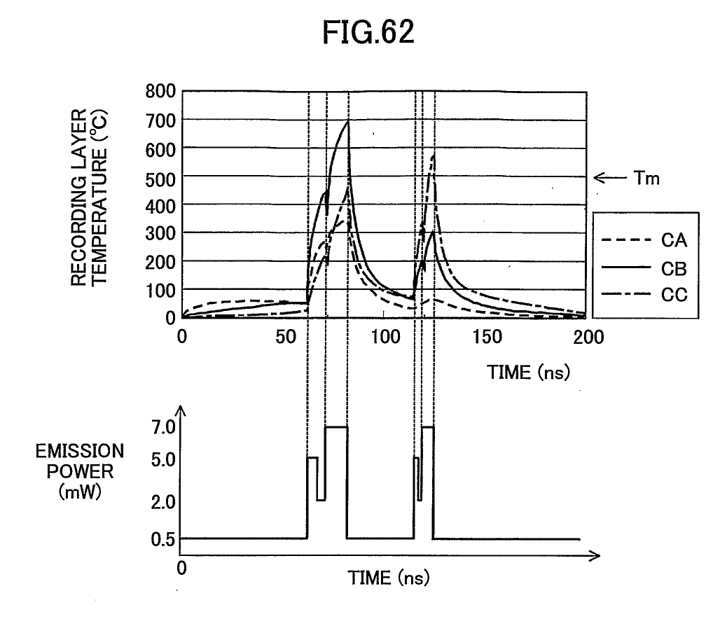

As shown in FIG. 61, with respect to a recording mark corresponding to multilevel data level “7”, a first preheat pulse Hp1 having power of 5.0 mW is irradiated for a period between 61.8 ns to 71.0 ns, then a second preheat pulse Hp2 having power of 2.0 mW is irradiated for a period between 71.0 ns to 72.0 ns, and then a main pulse Hm having power of 7.0 mW is irradiated as the recording power for a period between 72.0 ns to 82.2 ns. Furthermore, with respect to a recording mark corresponding to multilevel data level “1”, a first preheat pulse Hp1 having power of 5.0 mW is irradiated for a period between 115.4 ns to 119.0 ns, then a second preheat pulse Hp2 having power of 2.0 mW is irradiated for a period between 119.0 ns to 120.0 ns, and then a main pulse Hm having power of 7.0 mW is irradiated for a period between 120.0 to 124.6. In this example, the power of the first preheat pulse Hp1 (indicated as “Ph1” in the drawings) is approximately 71% of the recording power Pw, and the second preheat pulse Hp2 (indicated as “Ph2” in the drawings) is approximately 29% of the recording power Pw. Other than the main pulse and the preheat pulses, a laser beam having power of 0.5 mW is irradiated as producing the reproduction power Pr. That is, FIG. 54 is a case where Ph<Ph2, and FIG. 61 is a case where Ph1>Ph2. The results of this simulation are shown in FIG. 62.

As shown in FIG. 62, the recording layer temperature is raised by the preheat pulse Hp1, then is lowered by the preheat pulse Hp2, and then is raised again by the main pulse Hm. Like the results of the light emission pulse shown in FIG. 54, the results of this simulation also show that (1) the recording layer temperatures for both CB and CC surpass the initial mark forming temperature Tm for a short period of time, and (2) the recording layer temperatures for both CB and CC increase rapidly at the proximity of the initial mark forming temperature Tm. Particularly, in this simulation, in comparison with the results shown in FIG. 54, (1) increase of temperature can be restrained at the cells where no recording marks are formed, and (2) the cooling speed is faster after the formation of the recording marks. For example, jitter and/or loss of SDR can be prevented even in a case where the initial mark forming temperature Tm is broad or a case where thermal stability of the recording marks is insufficient.

### (First Exemplary Recording Operation)

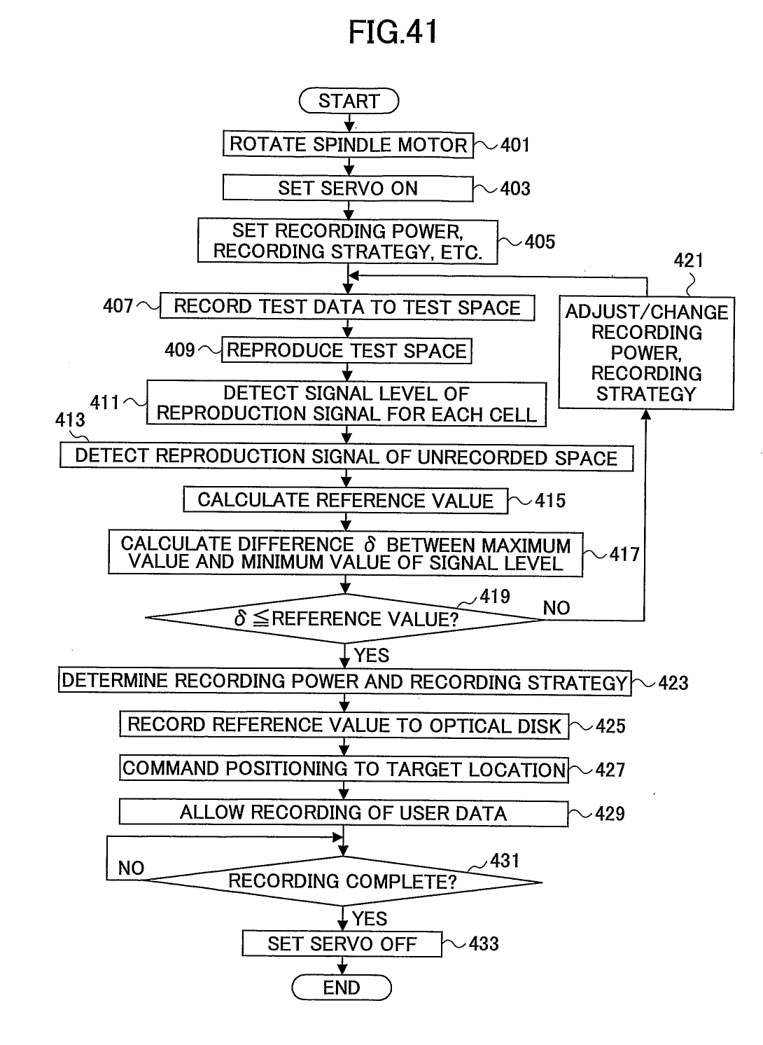

Next, a first example of a recording operation according to an embodiment of the present invention is described with reference to FIG. 41 in a case where the optical disk apparatus 20 receives a recording request command from the superordinate apparatus 90. The flowchart shown in FIG. 41 corresponds to a sequence of process algorithms executed by the CPU 40.

When the optical disk apparatus 20 receives the recording request command from the superordinate apparatus 90, the top address of the program corresponding to the flowchart shown in FIG. 4 (recording operation program) is set to a program counter of the CPU 40; thereby the recording operation is started. It is to be noted that the type of optical disk 15 is determined when the optical disk 15 is set to the optical disk apparatus 20, and the type is communicated to circuits such as the laser control circuit 24 and/or the reproduction signal process circuit 28. Furthermore, the type of optical disk 15 is stored beforehand in the RAM 41.

In Step S401, the rotation of the spindle motor 22 is initiated by outputting a drive signal to the spindle motor 22 in accordance with the recording speed and reporting reception of the recording request command from the superordinate apparatus 90 to the reproduction signal process circuit 28. In addition, the CPU 40 instructs the buffer manager 37 to store user data (recording data) received from the superordinate apparatus 90 in buffer RAM 34.

Next, in Step S403, once the CPU 40 confirms that the optical disk 15 is rotating at a predetermined linear velocity (or angular velocity), the servo for the drive control apparatus 26 is set on. Thereby, the above-described tracking control and focus control are executed. It is to be noted that the tracking control and the focus control may be executed at all times until the end of the recording operation.

Next, Step S405, the CPU 40 sets recording conditions such as recording power and recording strategy. The recording conditions are extracted from the data space of the flash memory 39 in correspondence with the type and recording speed of the optical disk 15. It is to be noted that a default recording condition(s) stored in the data space is used in a case where no corresponding recording condition is found. Furthermore, in a case where a recording condition(s) is recorded in the optical disk 15, such recorded recording condition may be used.

Next, in Step S407, multiple test patterns having the same multilevel data are recorded, in accordance with the recording conditions set in Step S405, in a test area(s) provided in the optical disk 15. In other words, a test recording (test writing) operation is executed.

Here, the size of the test area is described. In this embodiment of the present invention, the number of cells β included in a single test area is set to satisfy the below given formula (1).

β=A+2 (1)

In this formula (1), A is an integer when a calculation result of 2R/S is rounded up wherein 2R is a spot diameter (in a tangential line direction of the track) of the optical spot formed on the track during reproduction. For example, β=5 is satisfied in a case where S=0.24 (μm) and 2R=0.54 (μm). Accordingly, the number of cells in a single test area in this example is 5.

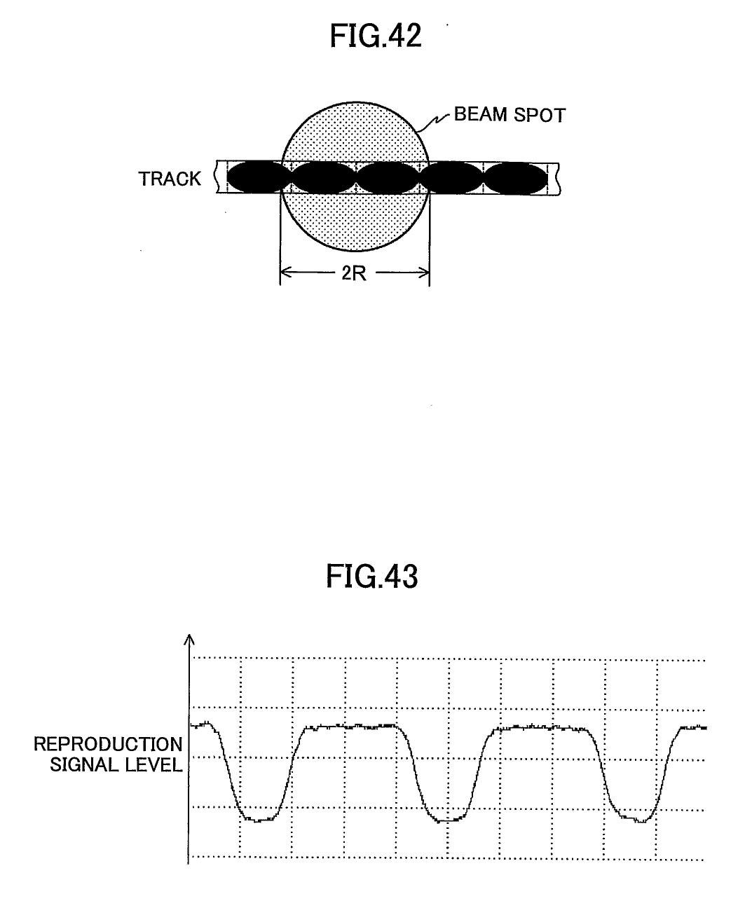

The largest mark corresponding to multilevel data level “7” is recorded in each cell in the test area (See FIG. 42). That is, the test pattern is formed with 5 multilevel data level “7”. In the embodiment of the present invention, the same test patterns are repeatedly recorded three times (see FIG. 43). It is to be noted that, although unrecorded spaces having longer length than the beam diameter are provided before and after the test patterns as shown in FIG. 43, the unrecorded spaces may or may not be provided before and after the test patterns. Furthermore, the test area may be provided outside of the data space (inner side or outer side of the data space) or inside of the data space.

Next, in Step S409, each of the test areas are recorded in (See FIG. 43).

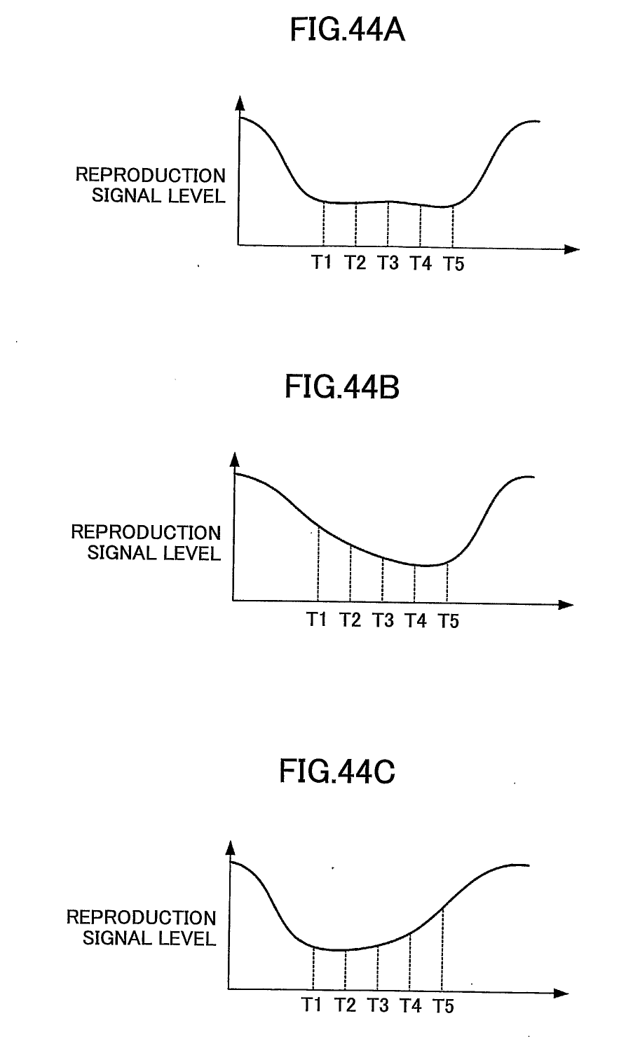

Next, in Step S411, the CPU 40 samples the reproduction signals of the test areas at timings (T1-T5) corresponding to the center position of each cell and detects the signal level of each cell (See FIG. 44A-44C).

Next, in Step S413, the signal levels of the unrecorded spaces are detected.

Next, in Step S415, a reference value Q for evaluating the reproduction signals of the test areas is calculated based on the below given formula (2).

Q=|DR|/{γ·(α−1)} (2)

Here, “DR” represents the difference between the reproduction signal level of the unrecorded space and that of the space in which the largest mark is recorded; “α” represents the value of the multilevel data (in this example, 8); and “γ” represents a value no less than 1 (preferably 2≦γ≦100).

In this embodiment of the present invention, DR can be obtained from the reproduction signals of the unrecorded spaces and those of the test areas given that the multilevel data recorded in the test area are of a level of 7 (corresponding to the largest mark) and that unrecorded spaces are provided between the test areas.

Furthermore, although recording quality can be improved by increasing the value of γ, evaluation may be executed excessively if the value of γ is too large. Therefore, the value of γ is determined in correspondence with the type of optical disk 15 and characteristics of the optical disk apparatus 20. That is, γ is a value (coefficient) that defines the allowable limit of the discrepancy (scattering) of the reproduction levels. For example, in a case where the number of cells β in a single test area is considerably large (for example, 100 or more), the detection data regarding the amount of discrepancy of the reproduction signal levels are highly reliable. Therefore, γ may satisfy a relation of γ≈1. On the other hand, in a case where the number of cells β in a single test area is considerably small (for example, less than 100), the detection data regarding the amount of discrepancy of the reproduction signal levels have insufficient reliability. Therefore, it is preferable for γ to satisfy a relation of γ≧2. In the embodiment of the present invention, the values of γ are obtained by performing experiments or the like beforehand and are stored in the flash memory 39. It is to be noted that, in a case where the value of γ is recorded in the optical disk 15, the recorded value may alternatively be used.

Next, in Step S417, the greatest value and least value of signal levels are obtained from each test area. However, with respect to the top (foremost) test area and bottom (rearmost) test area, the data corresponding to a cell having a value obtained by rounding down a calculation result of R÷S are not used in obtaining the signal levels. In this case where the value obtained by rounding down the calculation result of R÷S is 1, the greatest value and least value of signals levels are obtained from the data of the three cells in the middle, that is, the sampling data corresponding to the timings T2, T3, and T4. In this embodiment of the present invention, the three greatest values and three least values are obtained since three test patterns are recorded. Accordingly, the average of the three greatest values is set as the new greatest value and the average of the three least values is set as the new least value. Then, the difference (δ) between the newly set greatest value and the newly set least value is calculated. It is to be noted that no abnormal value due to defect or the like is included in the greatest value and the least value.

In Step S419, the CPU 40 determines whether the difference δ is less than or equal to the reference value Q.

In a case where the reproduction signal levels are considerably inclined (the signal levels vary) (for example, as in FIGS. 44B and 44C), the difference δ is greater than the reference value Q (No in Step S419); thereby the operation proceeds to Step S421. That is, the large inclination of the reproduction signal levels indicates that the amount of intersymbol interference differs depending on the recording position.

In Step S421, the CPU 40 adjusts/changes at least one of the recording power and recording strategy in correspondence with the difference δ with respect to the reference value Q. The, the operation returns to Step S407.

The Steps S407-S412 are repeated until it is determined that the reference value Q is no less than the difference δ (Yes in Step S419).

In a case where the reproduction signal levels are substantially flat (for example, as in FIG. 44A), the difference δ is no more than the reference value Q (Yes in Step S419); thereby the operation proceeds to Step S423. That is, the substantially flat reproduction signal levels indicate that the amount of intersymbol interference is uniform regardless of the recording position.

In Step S423, the CPU 40 determines the most suitable recording power and recording strategy. The information of the determined recording power and the recording strategy is reported to the laser control circuit 24. Accordingly, the laser control circuit 24 generates a suitable drive signal.

In Step S425, the CPU 40 directs the recording of information of the calculated reference value by the optical disk 1.

Next, in Step S427, the CPU 40 instructs the drive control circuit 26 to form an optical spot before the target position. Accordingly, a seek movement of the optical pickup apparatus 23 is executed. It is to be noted that this process may be skipped in a case where the seek movement is unnecessary.

Next, in Step S429, the CPU 40 allows recording of user data. Accordingly, user data are recorded in the optical disk 15 in accordance with suitable recording conditions via the above-described components such as the encoder 25, the laser control circuit 24, and the optical pickup apparatus 23.

Next, in Step S431, the CPU 40 determines whether the recording of the user data is completed. If the recording of the user data is not completed, the completion of the recording is determined as negative (No in Step S431). After a predetermined time elapses, the CPU 40 again determines whether the recording of the user data is completed. If the recording of the user data is completed, the completion of the recording is determined as affirmative (Yes in Step S431), thereby the operation proceeds to Step S433.

In Step S433, the CPU 40 instructs the drive control circuit 26 to set the servo off. Subsequently, the recording operation is finished.

Accordingly, in the optical disk apparatus 20 according to the above-described embodiment of the present invention, a test writing part (test recording part) and an obtaining part (recording condition obtaining part) and functions thereof can be obtained by employing the CPU 40 and executing the above-described processes of the program with the CPU 40. That is, the test writing part can be realized with Step S407 shown in FIG. 41, and the recording condition obtaining part can be realized with Steps S409-S423 shown in FIG. 41. It is to be noted that the parts obtained by executing the processes of the program with the CPU 40 may be obtained partially or entirely in the form of hardware.

Furthermore, a processing apparatus and functions thereof can be obtained by the encoder 25, the laser control circuit 24, the optical pickup apparatus 23, the CPU 40, and the program executed by the CPU 40.

Furthermore, the program of the present invention can be executed with the above-described recording operation program included in the programs stored in the flash memory 39 according to an embodiment of the present invention. That is, a test writing procedure (test recording procedure) is executed with a program corresponding to the process of Step S407 shown in FIG. 41, an obtaining procedure (recording condition obtaining procedure) is executed with a program corresponding to the processes of Steps S409-S423 shown in FIG. 41, and a recording procedure is executed with a program corresponding to the process of Step S429 shown in FIG. 41.

Furthermore, the recording condition determining method and the recording method of the present invention can be realized by executing the above-described recording operation. That is, the first step of the recording condition determining method can be realized with the process of Step S407 shown in FIG. 41, the second step of the recording condition determining method can be realized with the processes Steps S407-S423, and the recording step of the recording method can be realized with Step S429 shown in FIG. 41.

In the optical disk apparatus 20 according to the embodiment of the present invention, the test writing process is performed prior to the process of recording user data. In the test writing process, the same (identical) multilevel data levels are consecutively test-written (test-recorded) in a predetermined test area in a manner so that the length of the test area is longer than the spot diameter of the optical spot formed on the track during reproduction. Thus, the recording power and the recording strategy are obtained when the difference between the maximum value and the minimum value of the reproduction signals in the test area become no greater than the reference value Q. Given that the test area has a greater length than the spot diameter and that multiple same multilevel data levels are written in the test area, the influence of intersymbol interference can be clearly indicated (identified) in the reproduction signal in the test area. Therefore, the obtained recording power and recording strategy are recording conditions for a case where there is little influence of intersymbol interference. This allows determination of recording conditions that are suitable for a case of recording multilevel information (three or more levels) in an optical disk.

Furthermore, since information is recorded in the optical disk with recording conditions corresponding to a case where influence of intersymbol interference is little, multilevel information of 3 or more levels can be recorded in an optical disk with high recording quality.

Furthermore, since the reference value Q is calculated with use of reproduction signals in the test area, the influence of intersymbol interference can be evaluated with sufficient precision.

Furthermore, since the calculated reference value Q is recorded in the optical disk 15, the reference value Q may be reused when the optical disk 15 is reloaded.

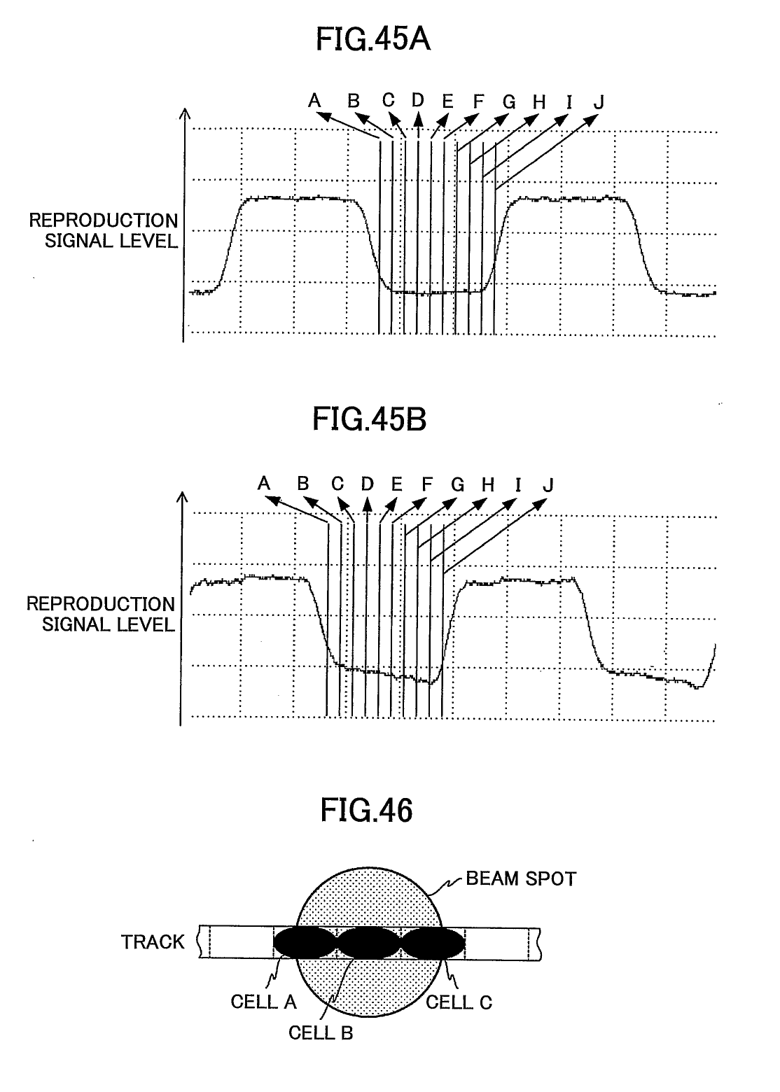

It is to be noted that, although a single test area includes five cells according to the above-described embodiment of the present invention, the number of cells in a single test area is not to be limited to five. A single test area may be provided with cells other than five as long as the number of cells is no less than the value of β. For example, FIGS. 45A and 45B show a case where ten cells (cells A-J) are included in a single test area. FIG. 45A shows a reproduction signal in a case where both recording power and recording strategy are suitable. FIG. 45B shows a reproduction signal in a case where both recording power and recording strategy are unsuitable.

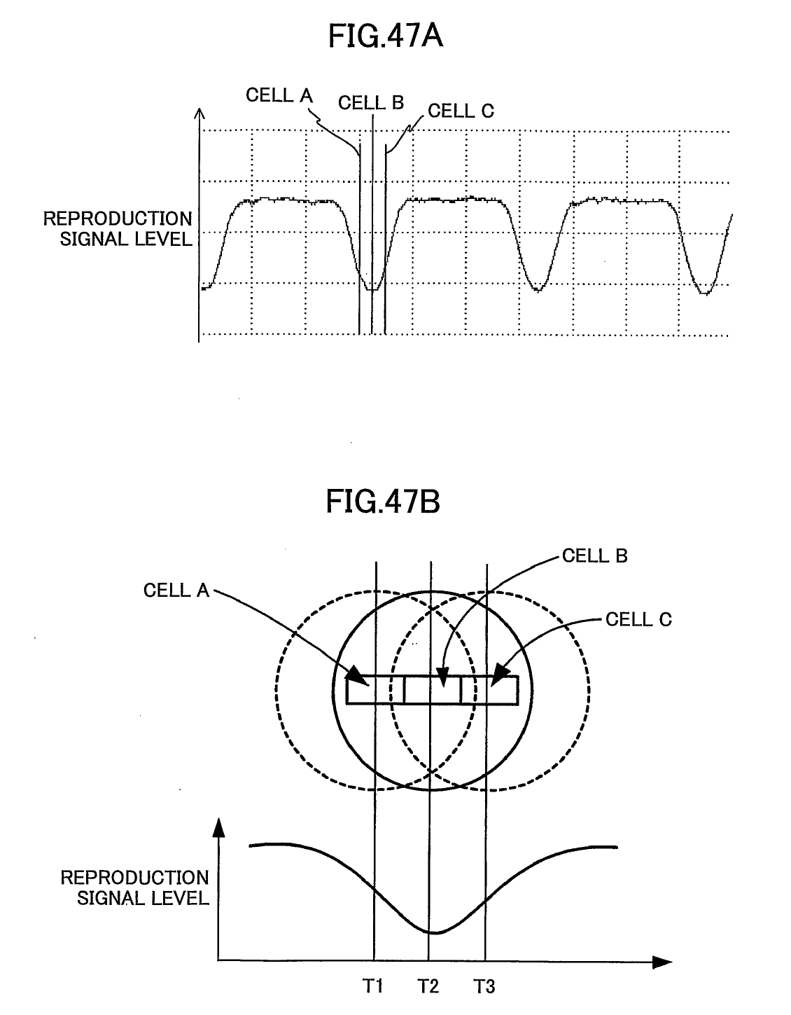

Meanwhile, in a case where a single test area includes three cells (i.e. cells fewer than the value of β), the signal levels at sampling timings T1 and T3 are not sufficiently reduced, as shown in FIGS. 47A and 47B. Accordingly, although the same (identical) recording marks are formed in each cell (cell A-C), the reproduction signal levels are not the same. Therefore, it cannot be sufficiently evaluated whether the recording power and the recording strategy are suitable.

Furthermore, although formation of the same (identical) test patterns is repeated three times, the test-pattern may alternatively be formed once. Furthermore, the formation of the test patterns may be modified in correspondence with desired precision and/or allowable processing time.

In the optical disk 15 of the above-described embodiment of the present invention, the signal level of the reproduction signal becomes smaller as the area of the recording mark increases. Alternatively, the signal level of the reproduction signal of the optical disk 15 may become larger as the area of the recording mark increases.

The above-described embodiment of the present invention describes a case where information (data) is multileveled to 8 levels (0-7). The information (data), however, may be multileveled to other levels as long as the levels are three or more.

Furthermore, although the above-described embodiment of the present invention describes a case where S=0.24, 2R=0.54 (μm), other values may be applied to “S” and/or “2R”.

Furthermore, the above-described embodiment describes a case where a recording mark having an area corresponding to the multilevel data is formed in a cell. Alternatively, a recording mark having a depth corresponding to the multilevel data may be formed in a cell. Furthermore, a recording mark having an area and depth corresponding to the multilevel data may, alternatively be formed in a cell.

Furthermore, the above-described embodiment describes a case where recording power and recording strategy are determined by referring to the reference value Q obtained from using the formula (2). Alternatively, recording power and recording strategy may be determined by referring to a reference value obtained by dividing the reproduction signal level of the unrecorded space with an empirically obtained value.

### (Second Exemplary Recording Operation)

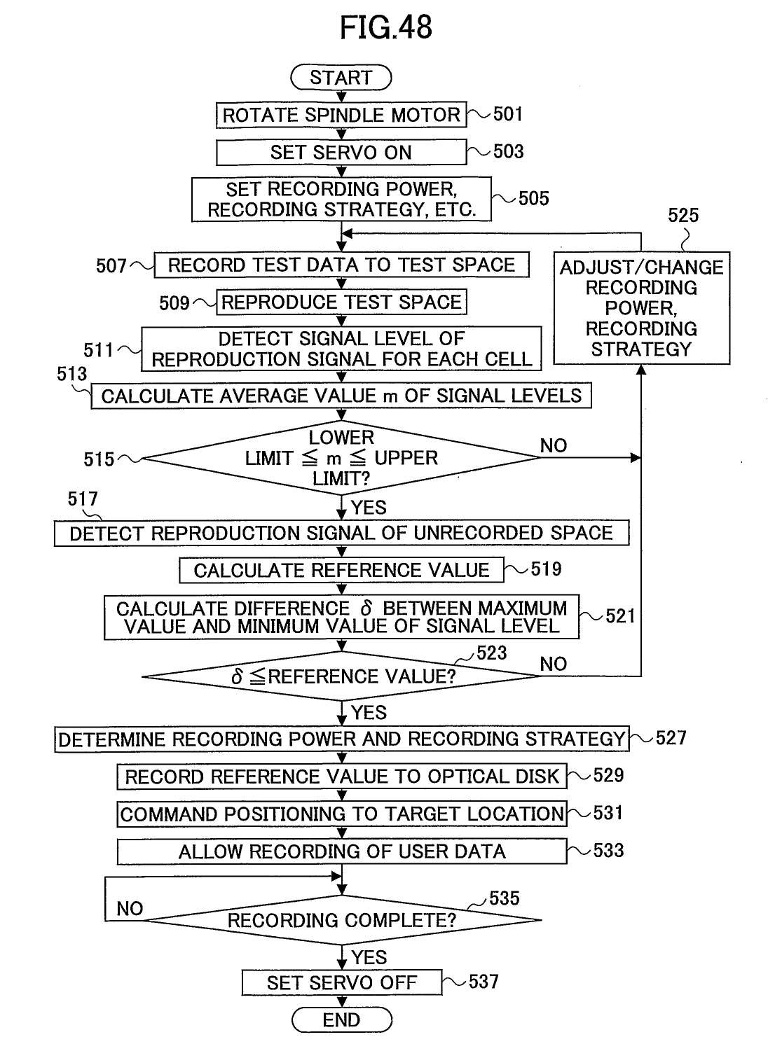

Although suitability of recording power and recording strategy are determined based on the difference between the greatest value and the least value of the reproduction signal levels according to the above-described embodiment of the present invention, the determination may alternatively be based on the average value of the reproduction signal levels. The operation and processes of the CPU 40 in such a case are described with reference to a flowchart shown in FIG. 48.

The first steps of Steps S501-S511 shown in FIG. 48 are the same as Steps S401-S411 shown in FIG. 41.

In Step S513, the average value m of the reproduction signals detected in Step S511 is calculated. However, with respect to the top (foremost) test area and bottom (rearmost) test area, the data corresponding to a cell having the greatest integer value which is less than R/S is not used in calculating the average value m. In this case, the average value m is obtained from the data of the three cells in the middle, that is, the sampling data corresponding to the timings T2, T3, and T4.

Next, in Step S515, it is determined whether the average value m is no less than a predetermined lower limit and whether the average value m is no more than a predetermined upper limit (lower limit≦=m≦upper limit). It is determined as affirmative if the average value m is equal to either or between the lower limit and the upper limit (Yes in Step S515), thereby the operation proceeds to Step S517.

Next, Steps S517-S521 are executed in the same manner as the above-described Steps S413-S417, in which the reference value Q and the difference δ between the greatest and least value of the reproduction signal levels are calculated.

Next, in Step S523, it is determined whether the difference δ is no greater than (i.e. same as or less than) the reference value Q. It is determined as negative if the difference δ is greater than the reference value Q, thereby the operation proceeds to Step S525.

In Step S525, the same process is executed as that in Step S421. Subsequently, the operation returns to Step S507.

It is to be noted that if the average value m is less than the lower limit or greater than the upper limit, it is determined as negative in Step S515 (No in Step S515). Subsequently, the operation proceeds to Step S525.

Furthermore, in Step S523, it is determined as positive if the difference δ is no more than the reference value Q (Yes in Step S523). Subsequently, the operation proceeds to Step S527.

Steps S527-S533 are executed in the same manner as the above-described Steps S423-S429.

Next, in Step S535, the CPU 40 determines whether the recording of user data is completed. If the recording of user data is not completed, the completion of the recording is determined as negative (No in Step S535). After a predetermined time elapses, the CPU 40 again determines whether the recording of the user data is completed. If the recording of the user data is completed, the completion of the recording is determined as affirmative (Yes in Step S535). Subsequently, the operation proceeds to Step S537.

In Step S537, the CPU 40 instructs the drive control circuit 26 to set the servo off. Subsequently, the recording operation is finished.

Likewise to the above-described embodiment of the recording operation of the present invention, this modified example of the recording operation also provides suitable recording conditions in recording user data. It is to be noted that the determination executed by referring to the difference δ (Step S523) may be performed prior to the determination executed by referring to the average value m (Step S515).

In the above-described embodiment of the recording operation of the present invention and the modified example of the recording operation, the determination of the suitable recording power and recording strategy may be executed by referring to the difference between the greatest value of the reproduction signal levels and the average value of the reproduction signal levels, the difference between the least value of the reproduction signal levels and the average value of the reproduction signal levels, or the standard deviation of the reproduction signal levels as an alternative to referring to the difference δ between the greatest value and least value of the reproduction signal levels. In such cases, however, a reference value different from the above-described reference value Q is employed.

Alternatively, the determination of suitable recording power and recording strategy may be executed based on at least one of the reproduction signal level of a first test area (average value, referred to as reproduction signal level S1), the reproduction signal level of a second test area (average value, referred to as reproduction signal level S2), or the difference between the reproduction signal level S1 and the reproduction signal level S2 (absolute value), wherein multilevel data level (multilevel data value) of 1 is test-written in the first test area, and multilevel data level of 7 is test-written in the second test area. It is to be noted that the reference value may be a value stored in the data space of the flash memory 39 and/or a value recorded to the optical disk 15.

In a case of executing the determination of suitable recording power and recording strategy for numerous amounts of times in various methods, the order of executing the determinations may be altered.

In the above-described embodiment of the recording operation of the present invention and the modified example of the recording operation, the reference value Q is calculated each time by referring to the reproduction signal level of the unrecorded area and the reproduction signal level of the test area. However, the reference value Q may alternatively be calculated beforehand by using the reproduction signal level of the unrecorded area and the reproduction signal level of the area where multilevel data level of 7 is recorded. Furthermore, in a case where the reference value Q is recorded in the optical disk 15, the recorded reference value may be used. Furthermore, a table indicative of types of optical disks 15 and corresponding reference values Q may be formed beforehand and stored in the flash memory 39. In this case, a reference value Q corresponding to the type of optical disk 15 is extracted (selected) from the table.

In the above-described embodiment of the recording operation of the present invention and the modified example of the recording operation, although the multilevel data level of 7 is employed as the multilevel data level included in the test pattern, other multilevel data levels of 1-7 may alternatively be employed. However, in a case where the multilevel data levels is anyone of multilevel data 1-6, a reference value Q, which is obtained beforehand, is used.

Furthermore, by inserting the test patterns in the user data beforehand, the user data can be recorded while adjustments of recording power and recording strategy can be made. That is, this allows the so-called OPC running. In the above-described embodiment of the present invention, a recording mark is not formed in a case where the multilevel data level is 0. However, a recording mark smaller than the recording mark corresponding to the multilevel data level of 1 may alternatively be formed in a case where the multilevel data level is 0.

In the above-described embodiment of the present invention, the program of the present invention is recorded in a flash memory 39. However, the program of the present invention may alternatively be recorded in other recording media (e.g. CD, magneto optical disk, memory card, USB memory, flexible disk). In such a case, the program of the present invention is loaded in the flash memory 39 via a reproduction apparatus (or a dedicated interface) corresponding to the recording medium. The program of the present invention may also be transferred to the flash memory 39 via a network (e.g. LAN, intranet, Internet). In other words, the program of the present invention may be provided in any manner as long as it is stored in the flash memory 39.

In the above-described embodiment of the present invention, the optical disk 15 is an information recording medium applicable to a laser beam having a wavelength of approximately 405 nm. However, other information recording media may alternatively be employed such as a commercially available write-once-read-many type information recording medium or a re-writable information recording medium.

### (Third Exemplary Recording Operation)

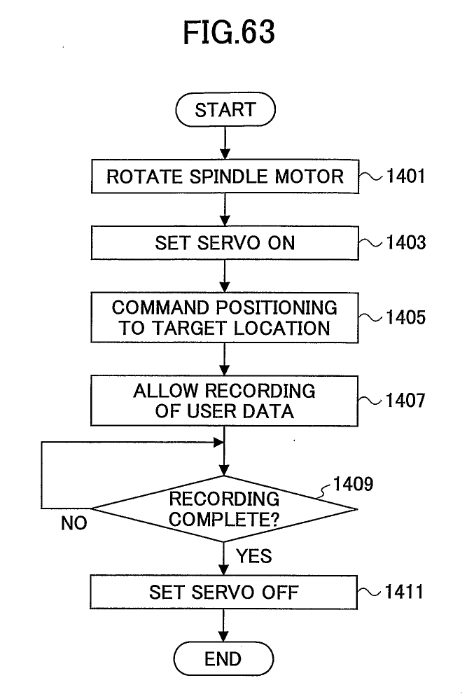

Next, a third example of a recording operation according to an embodiment of the present invention is described with reference to FIG. 63 in a case where the optical disk apparatus 20 receives a recording request command from the superordinate apparatus 90. The flowchart shown in FIG. 63 corresponds to a sequence of process algorithms executed by the CPU 40.

When the optical disk apparatus 20 receives the recording request command from the superordinate apparatus 90, the top address of the program corresponding to the flowchart shown in FIG. 63 (recording operation program) is set to a program counter of the CPU 40; thereby the recording operation is started. It is to be noted that the type of optical disk 15 is determined when the optical disk 15 is set to the optical disk apparatus 20, and the type is communicated to circuits such as the laser control circuit 24 and/or the reproduction signal process circuit 28. Furthermore, the type of optical disk 15 is stored beforehand in the RAM 41. Furthermore, in this example, power information and recording strategy information corresponding to the optical disk 15 are already transferred to the register 24d.

In Step S1401, the rotation of the spindle motor 22 is initiated by outputting a drive signal to the spindle motor 22 in accordance with the recording speed and reporting reception of the recording request command from the superordinate apparatus 90 to the reproduction signal process circuit 28. In addition, the CPU 40 instructs the buffer manager 37 to store user data (recording data) received from the superordinate apparatus 90 in buffer RAM 34.

Next, in Step S1403, once the CPU 40 confirms that the optical disk 15 is rotating at a predetermined linear velocity (or angular velocity), the servo for the drive control apparatus 26 is set on. Thereby, the above-described tracking control and focus control are executed. It is to be noted that the tracking control and the focus control may be executed at all times until the end of the recording operation.

In Step S1405, the CPU 40 instructs the drive control circuit 26 to form an optical spot at a position situated before a target area. Accordingly, a seek operation of the optical pickup apparatus 23 is executed. This process may be may be skipped in a case where no seek operation is necessary.

In Step S1407, the CPU 40 allows recording of user data. In the above-described manner, a recording mark(s) corresponding to the user data is recorded to the recording layer via the encoder 25, the laser control circuit 24, and the optical pickup apparatus 23, for example. That is, a light emission pulse including a preheat pulse and a main pulse is irradiated from the optical pickup apparatus 23 for recording a single recording mark to the optical disk 15.

Next in Step S1409, the CPU 40 determines whether the recording of the user data is completed. If the recording of the user data is not completed, the completion of the recording is determined as negative (No in Step S1409). After a predetermined time elapses, the CPU 40 again determines whether the recording of the user data is completed. If the recording of the user data is completed, the completion of the recording is determined as affirmative (Yes in Step S1409), thereby the operation proceeds to Step S1411.

In Step S1411, the CPU 40 instructs the drive control circuit 26 to set the servo off. Subsequently, the recording operation is finished.

The third example of the recording operation is performed by using the optical disk apparatus 20 according to an embodiment of the present invention including the laser control circuit 24, the CPU 40, and the program executed by the CPU 40. Furthermore, the recording operation of the present invention is executed by performing the third example of the recording operation.

As described above, in the optical disk apparatus 20 with respect to the third example of the recording operation, a mark (recording mark) is formed on a recording layer of the optical disk (recordable optical disk) 15 by pulse light emission of a laser light (laser beam). The forming of the mark is initiated when the temperature reaches a predetermined temperature (i.e. initial mark forming temperature). In the recording method according to an embodiment of the present invention, first, the recording layer is preheated to a temperature that is less than the initial mark forming temperature by irradiation of at least a single pulse as a preheat pulse onto the optical disk 15. The preheat pulse has a power (power level) that is greater than the reproduction power for the optical disk 15 and less than the recording power for the optical disk 15 (for example, 80% or less of the recording power for the optical disk 15). Then, the recording layer is heated to a temperature that is equal to or greater than the initial mark forming temperature by irradiating at least a single pulse as a main pulse onto the optical disk 15. The main pulse has a power (power level) same as the recording power (power level) for the optical disk 15. Given that the recording layer is heated beforehand (preheated) with the preheat pulse, the temperature of the recording layer rapidly rises to a temperature equal to or greater than the initial mark forming temperature. This enables accurate control in recording to the area where the temperature of the recording layer is equal to or greater than the initial mark forming temperature and also accurate control in forming the shape of the recording mark even in a case where the recording mark is smaller than the beam diameter of the laser light (laser beam). Therefore, recording mark(s) can be formed on the recording layer of the optical disk 15 (recordable optical disk) with satisfactory precision. Hence, data (information) can be recorded to the optical disk (recordable optical disk) 15 with high recording quality.

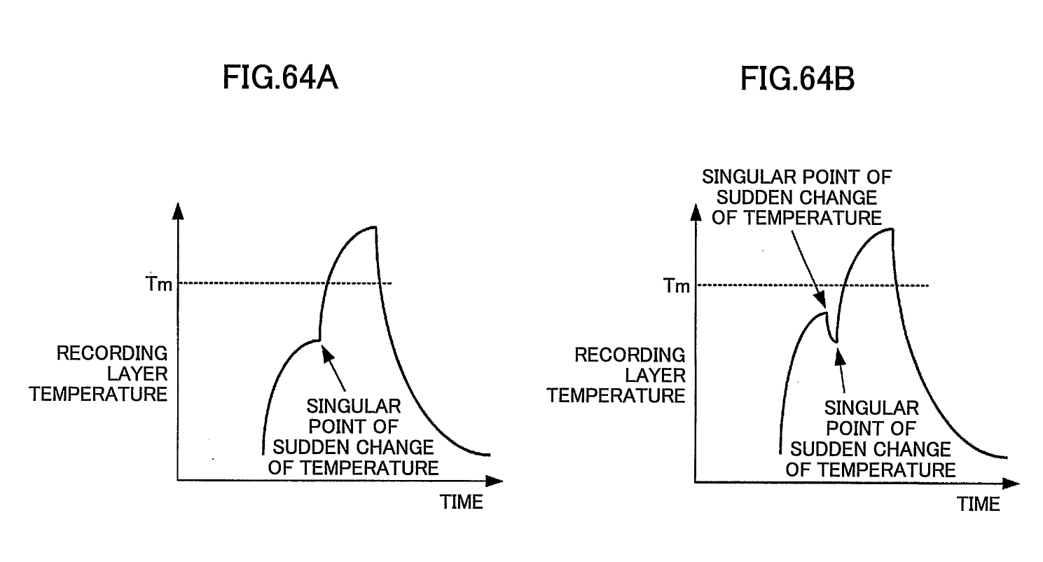

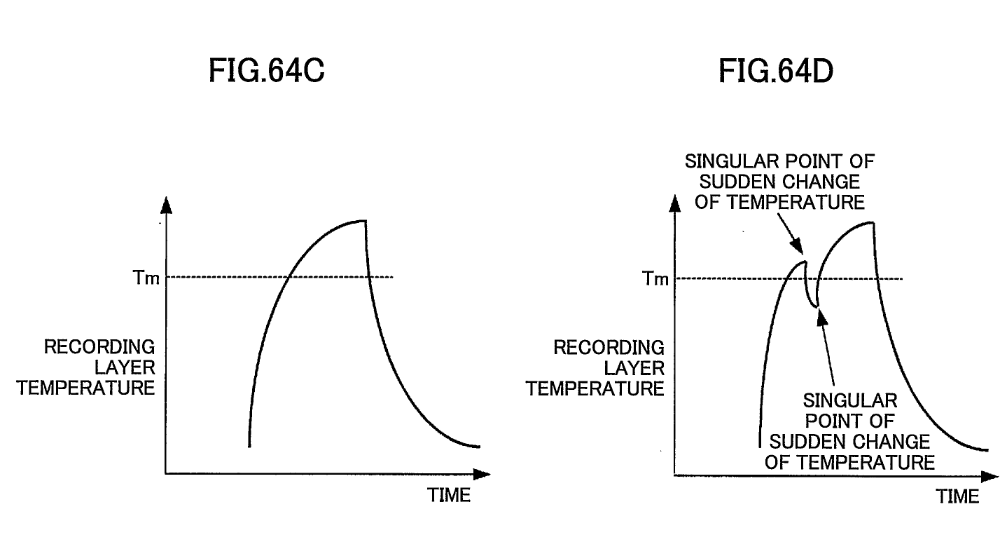

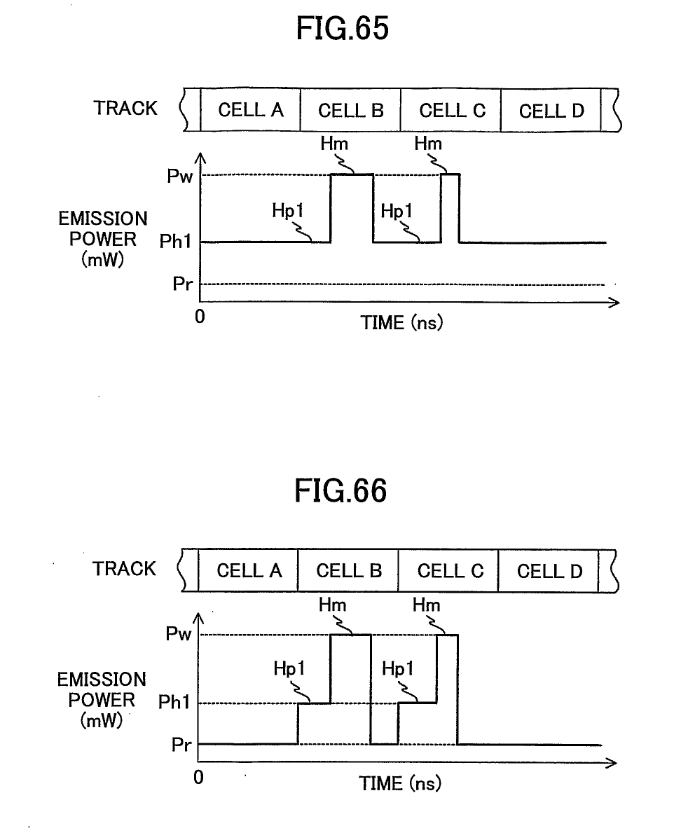

With reference to FIGS. 64A-64B showing the relation between the temperature of the recording layer (recording layer temperature) and elapsing of time from the initiation of the pulse irradiation, a singular point where the temperature of the recording layer suddenly changes is situated at an area where the temperature of the recording layer is lower than the initial mark forming temperature since the recording layer is heated to a temperature equal to or greater than the initial mark forming temperature with the main pulse after being preheated with the preheat pulse to a temperature less than the initial mark forming temperature. It is to be noted that FIG. 64C shows a relation of the recording layer temperature and the elapsing of time from the initiation of pulse irradiation in a case where no preheat pulse is irradiated. Furthermore, by preheating the recording layer with the preheat pulse to a temperature less than the initial mark forming temperature before heating the recording layer a temperature equal to or greater than the initial mark forming temperature with the main pulse, the singular point can be prevented from being provided at an area where the recording layer temperature is higher than the initial mark forming temperature. It is to be noted that FIG. 64D shows a case where the singular point is provided at an area where the recording layer temperature is higher than the initial mark forming temperature.

It is to be noted that, although the preheat pulse is described as including two pulses (first pulse and second pulse) in the above-described embodiment of the present invention, the preheat pulse of the present invention may alternatively be a preheat pulse including a single pulse, for example.

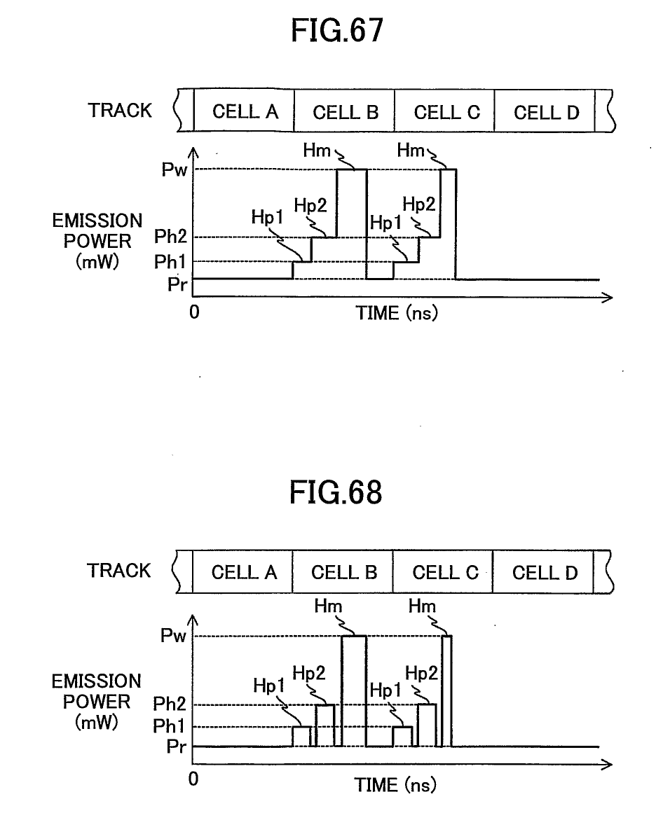

Furthermore, although the preheat pulse Hp1 is set with a power level Ph1 being greater than the power level Ph2 of the preheat pulse Hp2 as shown in the example of FIG. 61, the preheat pulse Hp2 may alternatively be set with a power level Ph2 being greater than the power level Ph1 of the preheat pulse Hp1 as shown in FIG. 67.

Furthermore, the power level of the preheat power may be reduced to the reproduction power level Pr at a build down period (fall period) of the preheat pulse, as shown in FIG. 68.

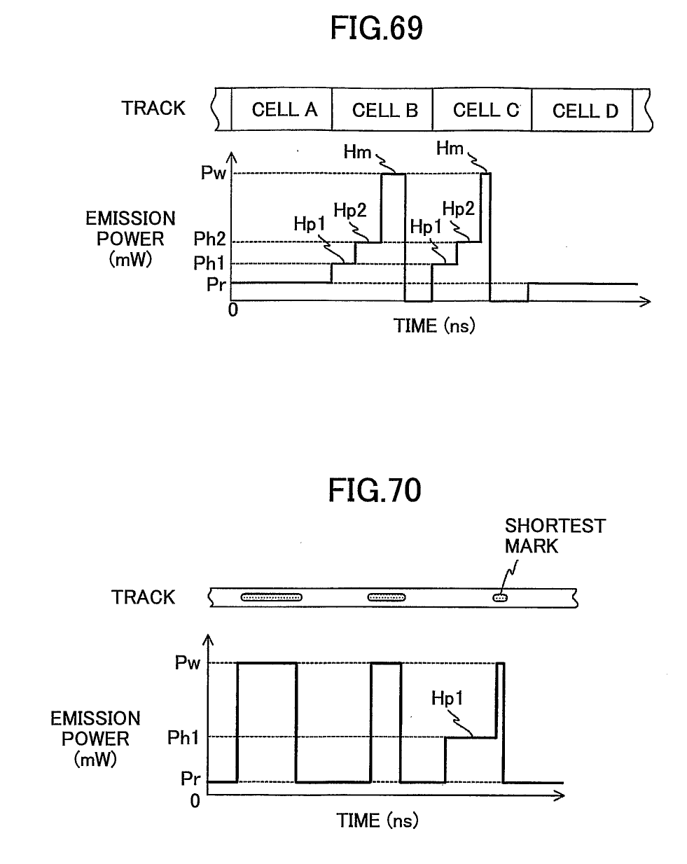

Furthermore, the power level of the main power may be reduced to 0 power level at a build down period (fall period) of the main pulse, as shown in FIG. 69.

Although the main pulse is described as including a single pulse in the above-described embodiment of the present invention, the main pulse of the present invention may alternatively be a main pulse including more than a single pulse, for example. That is, the main pulse may alternatively include multiple pulses.

Although the above-described embodiment of the present invention describes a case where information (data) is multileveled to 8 levels (0-7), the information (data) may alternatively be multileveled to other levels besides 8 levels.

The above-described embodiment of the present invention describes a case where no recording mark is formed when the value (level) of the multilevel data is 0. However, when the value (level) of the multilevel data is 0, the recording mark may alternatively be formed as a recording mark corresponding to a multilevel data of 1.

Although the above-described embodiment of the present invention describes a case where the area of the recording mark differs in correspondence with the multilevel data, the depth of the recording mark, for example, may alternatively differ in correspondence with the multilevel data. In this case, when the multilevel data is 0, the recording mark may alternatively be formed as a recording mark having a depth shallower than that of a recording mark corresponding to a multilevel data of 1. Furthermore, both the area and depth of the recording mark may differ in correspondence with the multilevel data. In this case, when the multilevel data is 0, both the area and depth of the recording mark are formed having less area and depth of the recording mark corresponding to 1.

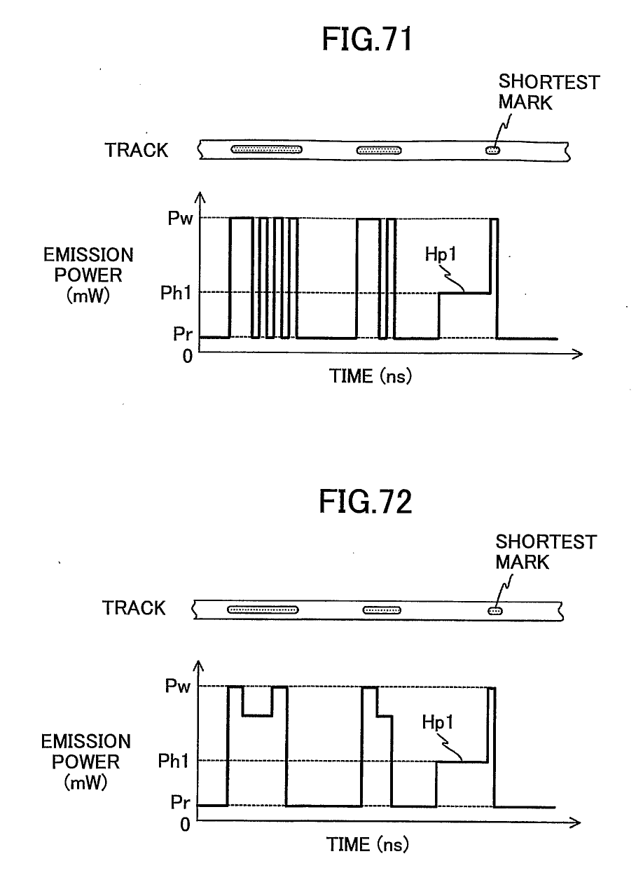

Furthermore, although the above-described embodiment of the present invention describes a case where multilevel data is employed, binarized data may also be employed. In this case where binarized data is employed, the preheat pulse may be irradiated only in correspondence with a recording mark that has a shortest length (shortest mark), as shown in FIGS. 70-72.

In the above-described embodiment of the present invention, the optical pickup apparatus is provided with a single semiconductor laser. However, the optical pickup apparatus may alternatively be provided with multiple semiconductor lasers that emit light beams with different wavelengths. For example, the optical pickup apparatus having multiple semiconductor lasers may include at least one semiconductor laser emitting a light beam with a wavelength of approximately 405 nm, a semiconductor laser emitting a light beam with a wavelength of approximately 660 nm, and a semiconductor laser emitting a light beam with a wavelength of approximately 700 nm. That is, the optical disk apparatus of the present invention may be an optical disk apparatus applicable to optical disks of various standards. In such a case, the various optical disks may be employed in any manner as long as one of the optical disks is applicable to the multilevel recording type.

Further, the present invention is not limited to these embodiments, but variations and modifications may be made without departing from the scope of the present invention.

The present application is based on Japanese Priority Application Nos. 2004-123492, 2004-157066, and 2004-157068 filed on Apr. 19, 2004, May 27, 2004, and May 27, 2004, respectively with the Japanese Patent Office, the entire contents of which are hereby incorporated by reference.

1. A recording/reproduction method for recording/reproducing data to/from an optical recording medium including a guiding groove and a recording layer, the recording/reproduction method comprising a step of:
irradiating a laser beam onto the optical recording medium by modulating at least one of a laser irradiation time and a laser irradiation intensity to two or more values;
wherein a Pbi/Pr ratio of a reproduction power (Pr) and a bias power (Pbi) is set to a value that is no less than 0.5;
wherein the data are recorded by constantly providing the laser beam with a power level including the reproduction power (Pr) added to the bias power (Pbi).

2. A recording/reproduction method for recording/reproducing multilevel data to/from an optical recording medium including a guiding groove and a recording layer, the recording/reproduction method comprising a step of:
irradiating a laser beam onto the optical recording medium for recording/reproducing the multilevel data;
wherein the multilevel data are recorded under a condition where a D/L ratio between a laser beam diameter of 1/e² of the central intensity of the laser beam (D) and a length of a recording unit of a multilevel recording mark (L) satisfies a relation of 1<D/L, the recording unit of the multilevel recording mark being a basic cell;
wherein a Pbi/Pr ratio of a reproduction power (Pr) and a bias power (Pbi) is set to a value that is no less than 0.5;
wherein the data are recorded by constantly providing the laser beam with a power level including the reproduction power (Pr) added to the bias power (Pbi).

3. The recording/reproduction method as claimed in claim 2, wherein the recording is executed by using a strategy in which a Wt/LT ratio between an entire pulse time width of a maximum level mark (Wt) and a time width of the basic cell length (Lt) satisfies a relation of 0.3≦Wt/Lt≦0.8.

4. The recording/reproduction method as claimed in claim 3, wherein the recording is executed on the optical recording medium under conditions where the guiding groove has a track pitch ranging from 0.25 to 0.5 μm, a depth (Dp) ranging from 15 to 150 nm, an average groove width (Wg) ranging from 0.15 to 0.35 μm, and a reflectivity of non-recorded area of the optical recording medium ranges from 2 to 50%, wherein the laser beam is a blue laser with a wavelength that is no more than 450 nm.

5. The recording/reproduction method as claimed in claim 4, wherein a Wg/L ratio of the average groove width of the guiding groove (Wg) and the length of the recording unit (L) satisfies a relation of 0.7≦Wg/L≦1.5.

6. The recording/reproduction method as claimed in claim 5, wherein an L/Dp ratio of the length of the recording unit (L) and the depth of the guiding groove (Dp) satisfies a relation of 3≦L/Dp≦8.

7. The recording/reproduction method as claimed in claim 6, wherein the recording is executed using a strategy including different recording powers of at least two levels.

8. The recording/reproduction method as claimed in claim 7, wherein the recording power includes two levels and the recording is executed with a strategy in which a Pf/Pb ratio of a recording power of a former half (Pf) and a recording power of a latter half (Pb) satisfies a relation of 0.3≦Pf/Pb≦1.

9. The recording/reproduction method as claimed in 8, wherein the recording power includes two levels and the recording is executed using a strategy which a Wb/Wt ratio of a pulse time width (Wb) and an entire pulse time width (Wt) of the recording power of the latter half of a maximum level mark satisfies a relation of 0.3≦Wb/Wt≦8.

10. The recording/reproduction method as claimed in claim 9, wherein the recording is executed by which a switching point of the recording power of the former half (Pf) and the recording power of the latter half (Pb) corresponds to a center of the basic cell.

11. The recording/reproduction method as claim 1, wherein the recording is executed on the optical recording medium having an RO layer including each element of R and O and a thin layer of organic material situated on the substrate, wherein R includes at least one of the elements selected from a group including Y, B, I, In, and a lantern series element, wherein O expresses oxygen.

12. The recording/reproduction method as claimed in claim 11, wherein the recording is executed on the optical recording medium in which the RO film includes at least one of the elements M chosen from a group including Al, Cr, Mn, Sc, In, Ru, Rh, Co, Fe, Cu, Ni, Zn, Li, Si, Ge, Zr, Ti, Hf, Sn, Pb, Mo, V and Nb.

13. The recording/reproduction method as claimed in claim 11, wherein the recording is executed on the optical recording medium having a composition that is layered at least with the RO film, the thin film of the organic material, and a reflective layer on the substrate in that order.

14. The recording/reproduction method as claimed in claim 11, wherein the recording is executed on the optical recording medium having a composition that is layered at least of the reflective layer, the thin film of the organic material, the RO layer, and a cover layer on the substrate in that order.

15. The recording/reproduction method as claimed in claim 1, wherein the recording is executed on the optical recording medium having an RO layer including each element of R and O and a dielectric layer which has ZnS as the main ingredient above the substrate, wherein R includes at least one of the elements selected from a group including Y, B, I, In, and a lantern series element, wherein O expresses oxygen.

16. The recording/reproduction method as claimed in claim 15, wherein the recording is executed on the optical recording medium in which the RO film includes at least one of the elements M chosen from the group including Al, Cr, Mn, Sc, In, Ru, Rh, Co, Fe, Cu, Ni, Zn, Li, Si, Ge, Zr, Ti, Hf, Sn, Pb, Mo, V and Nb.

17. The recording/reproduction method as claimed in claim 15, wherein the recording is executed on the optical recording medium having a composition that is at least layered of the RO film, the dielectric layer which has ZnS as the main ingredients, and the reflective layer on the substrate in that order.

18. The recording/reproduction method as claimed in claim 15, wherein the recording is executed on the optical recording medium having a composition that is at least layered of the reflective layer, the dielectric layer which has ZnS as the main ingredients, the RO layer, and the cover layer on the substrate in that order.

19. A recording condition determining method for determining recording conditions for recording multilevel data on a track of a recording surface of an optical disk, the recording condition determining method comprising the steps of:
a) writing plural of the multilevel data levels having a same value in a plurality of test areas, each of the test areas having a prescribed length in a direction of a line tangent to the track, the prescribed length being greater than a spot diameter of an optical spot formed on the track; and
b) obtaining a suitable recording power and recording strategy in accordance with the levels of reproduction signals generated from the test areas.

20. The recording condition determining method as claimed in claim 19, wherein the suitable recording power and the recording strategy are obtained when the difference between a greatest value and a least value of the levels of reproductions signals is no more than a reference value.

21. The recording condition determining method as claimed in claim 20, wherein the reference value is recorded in the optical disk.

22. The recording condition determining method as claimed in claim 20, further comprising a step of:
c) determining the type of the optical disk;
wherein the reference value is selected from predetermined values in accordance with the type of the optical disk.

23. The recording condition determining method as claimed in claim 20, wherein the reference value includes a value obtained by calculating a formula of {|DR|/{γ·(α−1)}}, wherein α is a value of the multilevel data which is no less than 3, DR is the difference between a reproduction signal level of an unrecorded area and a reproduction signal level of an area in which a largest mark is recorded, and γ is a value no less than 1.

24. The recording condition determining method as claimed in claim 23, wherein the multilevel data include multilevel data corresponding to the largest mark, wherein the reference value is obtained by referring to the reproduction signals generated from the test areas.

25. The recording condition determining method as claimed in claim 19, wherein the suitable recording power and the recording strategy are obtained when an average value of the levels of the reproduction signals falls within a predetermined range.

26. The recording condition determining method as claimed in claim 19, wherein the suitable recording power and the recording strategy are obtained when the difference between at least one of the greatest value of the levels of the reproduction signals and the least value of the levels of the reproduction signals, and an average value of the levels of the reproduction signals is no more than a predetermined reference value.

27. The recording condition determining method as claimed in claim 19, wherein the number of multilevel data levels recorded in the test areas is set to satisfy a formula of
β=A+2,
wherein β represents the number of multilevel data levels recorded in the test area, wherein A represents an integer when a calculation result of 2R÷S is rounded up, wherein 2R represents the spot diameter of the optical spot, wherein S represents the length of the test area.

28. The recording condition determining method as claimed in claim 27, wherein the levels of reproduction signals generated from the test areas are derived by omitting the multilevel values of a foremost test area and a rearmost test area obtained by rounding down a calculation result of R÷S, respectively.

29. A recording method for recording multileveled data on a track of a recording surface of an optical disk, the recording method comprising a step of:
recording the multilevel data on the track of the recording surface of the optical disk by using the suitable recording power and the recording strategy obtained in claim 1.

30. An optical disk apparatus for recording multilevel data on a track of a recording surface of an optical disk, the optical disk apparatus comprising:
a writing part for writing plural of the multilevel data levels having a same value in a plurality of test areas, each of the test areas having a prescribed length in a direction of a line tangent to the track, the prescribed length being greater than a spot diameter of an optical spot formed on the track;
an obtaining part for obtaining a suitable recording power and recording strategy in accordance with the levels of reproduction signals generated from the test areas; and
a recording part for recording the multilevel data on the track of the recording surface of the optical disk by using the obtained recording power and recording strategy.

31. The optical disk apparatus as claimed in claim 30, wherein the suitable recording power and the recording strategy are obtained when the difference between a greatest value and a least value of the levels of reproductions signals is no more than a reference value.

32. The optical disk apparatus as claimed in claim 31, wherein the reference value is recorded in the optical disk.

33. The optical disk apparatus as claimed in claim 31, further comprising:
a determining part for determining the type of the optical disk;
wherein the reference value is selected from predetermined values in accordance with the type of the optical disk.

34. The optical disk apparatus as claimed in claim 31, wherein the reference value includes a value obtained by calculating a formula of {|DR|/{γ·(α−1)}},
wherein α is a value of the multilevel data which is no less than 3, DR is the difference between a reproduction signal level of an unrecorded area and a reproduction signal level of an area in which a largest mark is recorded, and γ is a value no less than 1.

35. The optical disk apparatus as claimed in claim 34, wherein the multilevel data include multilevel data corresponding to the largest mark, wherein the reference value is obtained by referring to the reproduction signals generated from the test areas.

36. The optical disk apparatus as claimed in claim 35, wherein the recording part further records the obtained reference value in the optical disk.

37. The optical disk apparatus as claimed in claim 30, wherein the suitable recording power and the recording strategy are obtained when an average value of the levels of the reproduction signals falls within a predetermined range.

38. The optical disk apparatus as claimed in claim 30, wherein the suitable recording power and the recording strategy are obtained when the difference between at least one of the greatest value of the levels of the reproduction signals and the least value of the levels of the reproduction signals, and an average value of the levels of the reproduction signals is no more than a predetermined reference value.

39. The optical disk apparatus as claimed in claim 30, wherein the number of multilevel data levels recorded in the test areas is set to satisfy a formula of
β=A+2,
wherein β represents the number of multilevel data levels recorded in the test area, wherein A represents an integer when a calculation result of 2R÷S is rounded up, wherein 2R represents the spot diameter of the optical spot, wherein S represents the length of the test area.

40. The optical disk apparatus as claimed in claim 39, wherein the levels of reproduction signals generated from the test areas are derived by omitting the multilevel values of a foremost test area and a rearmost test area obtained by rounding down a calculation result of R÷S, respectively.

41. A program used for an optical disk apparatus operable to record multilevel data on a track of a recording surface of an optical disk, the program comprising:
a writing process for writing plural of the multilevel data levels having a same value in a plurality of test areas, each of the test areas having a prescribed length in a direction of a line tangent to the track, the prescribed length being greater than a spot diameter of an optical spot formed on the track;
an obtaining process for obtaining a suitable recording power and recording strategy in accordance with the levels of reproduction signals generated from the test areas; and
a recording process for recording the multilevel data on the track of the recording surface of the optical disk by using the obtained recording power and recording strategy.

42. A computer-readable recording medium comprising:
the program as claimed in claim 41.

43. A recording method for recording data on a recording layer of an optical disk, the recording method comprising the steps of:
a) preheating the recording layer to a temperature less than an initial mark forming temperature by irradiating at least a single preheat pulse onto the optical disk, the preheat pulse having a power level that is greater than a reproduction power for the optical disk and less than a recording power for the optical disk;
b) heating the recording layer to a temperature equal to or greater than the initial mark forming temperature by irradiating at least a single main pulse onto the optical disk; the main pulse having a power level the same as the recording power for the optical disk.

44. The recording method as claimed in claim 43, wherein the preheat pulse has a power level that is no more than 80% of the recording power.

45. The recording method as claimed in claim 43, wherein the preheat pulse includes a first pulse and a second pulse, wherein the first pulse has a power level that is different from a power level of the second pulse.

46. The recording method as claimed in claim 45, wherein one of the first pulse and the second pulse has a power level that is no more than 40% of the recording power.

47. The recording method as claimed in claim 43, wherein the data recorded in the optical disk includes at least one of binarized data and multilevel data having three or more values.

48. The recording method as claimed in claim 47, wherein when the data recorded to the optical disk are binarized data, step a) is executed when a mark among the marks formed on the recording layer is shortest.

49. The recording method as claimed in claim 43, wherein the main pulse includes at least a single pulse.

50. The recording method as claimed in claim 43, wherein the temperature of the recording layer has a point where temperature suddenly changes before reaching the initial mark forming temperature.

51. The recording method as claimed in claim 50, wherein the temperature of the recording layer has no point where temperature suddenly changes after the temperature of the recording layer is no less than the initial mark forming temperature.

52. An optical disk apparatus for recording data on a recording layer of an optical disk, the optical disk apparatus comprising:
an optical pickup apparatus for irradiating a laser light by employing pulse emission;
preheating part for preheating the recording layer to a temperature less than an initial mark forming temperature by irradiating at least a single preheat pulse onto the optical disk, the preheat pulse having a power level that is greater than a reproduction power for the optical disk and less than a recording power for the optical disk;
a heating part for heating the recording layer to a temperature equal to or greater than the initial mark forming temperature by irradiating at least a single main pulse onto the optical disk; the main pulse having a power level the same as the recording power for the optical disk.

53. The optical disk apparatus as claimed in claim 52, wherein the preheat pulse has a power level that is no more than 80% of the recording power.

54. The optical disk apparatus as claimed in claim 52, wherein the preheat pulse includes a first pulse and a second pulse, wherein the first pulse has a power level that is different from a power level of the second pulse.

55. The optical disk apparatus as claimed in claim 54, wherein one of the first pulse and the second pulse has a power level that is no more than 40% of the recording power.

56. The optical disk apparatus as claimed in claim 52, wherein the data recorded in the optical disk includes at least one of binarized data and multilevel data having three or more values.

57. The optical disk apparatus as claimed in claim 56, wherein when the data recorded to the optical disk are binarized data, the preheating is executed when a mark among the marks formed on the recording layer is shortest.

58. The optical disk apparatus as claimed in claim 52, wherein the main pulse includes at least a single pulse.

59. The optical disk apparatus as claimed in claim 52, wherein the temperature of the recording layer has a point where temperature suddenly changes before reaching the initial mark forming temperature.

60. The optical disk apparatus as claimed in claim 59, wherein the temperature of the recording layer has no point where temperature suddenly changes after the temperature of the recording layer is no less than the initial mark forming temperature.
